(19) United States
(12) Patent Application Publication
(10) Pub. No.: US 2007/0099132 A1
(43) Pub. Date: May 3, 2007

(54) Photothermographic material

(76) Inventors: Hajime Nakagawa, Kanagawa (JP); Yoshihisa Tsukada, Kanagawa (JP)

Correspondence Address: TAIYO CORPORATION, 401 HOLLAND LANE, #407, ALEXANDRIA, VA, 22314, US

(21) Appl. No.: 11/543,861

(22) Filed: Oct. 6, 2006

Related U.S. Application Data
(63) Continuation-in-part of application No. 10/722,553, filed on Nov. 28, 2003, now abandoned.
(63) Continuation-in-part of application No. 09/953,958, filed on Sep. 18, 2001, now Pat. No. 7,189,500.

(30) Foreign Application Priority Data
Dec. 3, 2002 (JP) 2002-351467
Dec. 3, 2002 (JP) 2002-351468
Sep. 18, 2000 (JP) 2000-281809

(51) Int. Cl. G03C 1/00

(52) U.S. Cl. 430/619

(57) ABSTRACT

The invention provides a photothermographic material including, on a same surface of a substrate, a photosensitive silver halide, a non-photosensitive organic silver salt, a reducing agent, a development accelerator and a binder, the material containing, as the binder, a polymer formed by copolymerizing a monomer represented by the following general formula (M) in an amount from 10 to 70 mass %:
CH₂═CR⁰¹—CR⁰²═CH₂ General formula (M)
wherein R⁰¹ represents a hydrogen atom, an alkyl group with 1 to 6 carbon atoms, a halogen atom, or a cyano group; and R⁰² represents an alkyl group with 1 to 6 carbon atoms, a halogen atom or a cyano group (both R⁰¹ and R⁰² are not hydrogen atoms at the same time).

### CROSS-REFERENCE TO RELATED APPLICATION

This application is a continuation-in-part application of, and claims priority to, U.S. patent application Ser. No. 10/722,553, which claims priority under 35 USC 119 from Japanese patent Application Nos. 2002-351467 and 2002-351468. This application is a continuation-in-part application of, and claims priority to, U.S. patent application Ser. No. 09/953,958, which claims priority under 35 USC 119 from Japanese Patent Application No. 2000-281809; the entire disclosures of all the patent documents listed above are hereby expressly incorporated by reference herein.

### BACKGROUND OF THE INVENTION

1. Field of the Invention

The present invention relates to a photothermographic material.

2. Description of the Related Art

In recent years, it is strongly desired in the medical field to reduce the amount of used processing liquids in consideration of environmental protection and space saving. For this reason, there is desired a technology for a photothermographic material for medical diagnosis and for photographic applications, capable of efficient exposure with a laser image setter or a laser imager and of forming a sharp black image with a high resolution and a high sharpness. Such photothermographic material can eliminate use of processing solvent chemicals and can provide users with a thermal development system which is simpler and does not contaminate the environment.

Although similar requirements are present in ordinary image forming materials, an image for medical use requires particularly high image quality excellent in sharpness and graininess because a delicate image presentation is required. Also there is preferred an image of cold black tone in consideration of ease of diagnosis. Currently, various hard copy systems utilizing pigments or dyes, such as an ink jet printer system and an electrophotographic system, are available as ordinary image forming systems, but no such system yet is satisfactory as an output system for the image for medical use.

On the other hand, a thermal image forming system utilizing an organic silver salt is disclosed (for example “Thermally Processed Silver Systems”, B. Shely, Imaging Processes and Materials, Neblette 8th edition, edited by Sturge, V. Walworth and A. Shepp, (1996) p. 2). More specifically, a photothermographic material has a photosensitive layer in which a photocatalyst (for example silver halide) in a catalytic active amount, a reducing agent, a reducible silver salt (for example organic silver salt) and a toning agent for controlling the color of silver if necessary, are generally dispersed in matrix of a binder. The photothermographic material is heated, after an exposure to an image, to a high temperature (for example 80° C. or higher) whereby a black silver image is formed by a redox reaction between the silver halide or reducible silver salt (acting as an oxidizing agent) and the reducing agent. The redox reaction is accelerated by a catalytic effect of a silver halide latent image, formed by the exposure to light. Therefore, the black silver image is formed in an exposed area. As a medical image forming system based on a photothermographic material utilizing such principle, there has been commercialized Fuji Medical Dry Imager FM-DPL.

In manufacturing a thermal image forming system utilizing an organic silver salt, there are known a method utilizing solvent coating, and a method of coating and drying a coating solution containing an aqueous dispersion of fine polymer particles as a main binder (cf. for example JP-A No. 2002-229149 and WO No. 97/04355). The latter method is simpler in a manufacturing facility and more advantageous for a mass production since steps for recovery, etc. of the solvent are unnecessary.

For forming a photosensitive layer with such aqueous-based coating solution, there is already disclosed a photothermographic material employing a polymer latex with a content of halogen ions equal to or less than 500 ppm as a binder, in order to improve so-called image storability, such as a density increase in an unexposed area or a color change of silver after an image is formed (cf. for example JP-A No. 2002-229149). However, for the photothermographic materials, there is still a strong need for improvement of image storability. An organic polyhalogen compound is known to be effective as an antifoggant, but it cannot provide a sufficient effect since its use is restricted because of the drawback of reducing the sensitivity at a higher coating amount. For this reason, there is desired a technology for providing a photothermographic material that features both superior image storability and superior sensitivity.

### SUMMARY OF THE INVENTION

In consideration of the foregoing, an object of the present invention is to provide a photothermographic material having high sensitivity and satisfactory image storability. Another object is to improve a coated surface state of such photothermographic material during the manufacture.

Such objects can be attained by a photothermographic material described in the following.

A first object of the invention is a photothermographic material (Q) comprising, on a same surface of a substrate, a photosensitive silver halide, a non-photosensitive organic silver salt, a reducing agent, a development accelerator, and a binder, the material comprising, as said binder, a polymer formed by copolymerizing a monomer represented by the following general formula (M) in an amount from 10 to 70 mass %:
CH₂═CR⁰¹—CR⁰²═CH₂ General formula (M)

wherein in general formula (M), R⁰¹ represents a hydrogen atom, an alkyl group having 1 to 6 carbon atoms, a halogen atom, or a cyano group; and R⁰² represents an alkyl group having 1 to 6 carbon atoms, a halogen atom or a cyano group, R⁰¹ and R⁰² each being selected from the group consisting of a hydrogen atom, an alkyl group having 1 to 6 carbon atoms, a halogen atom, and a cyano group, provided that both R⁰¹ and R⁰² are not hydrogen atoms at the same time.

A second aspect of the invention is to provide the photothermographic material (Q), wherein said development accelerator is a compound selected from compounds represented by the following general formula (A-1):
Q₁-NHNH-Q₂ General formula (A-1):

wherein in general formula (A-1), Q₁ represents an aromatic group or a heterocyclic group bonded by a carbon atom thereof to —NHNH-Q₂; and Q₂ represents a carbamoyl group, an acyl group, an alkoxycarbonyl group, an aryloxycarbonyl group, a sulfonyl group or a sulfamoyl group.

A third aspect of the invention is to provide the photothermographic material (Q), wherein said development accelerator is a compound selected from compounds represented by the following general formula (A-2):

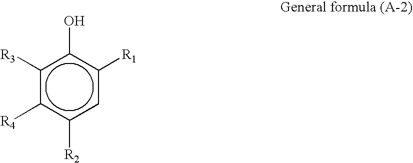

wherein in general formula (A-2), R₁ represents an alkyl group, an acyl group, an acylamino group, a sulfonamide group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group or a carbonate ester group; and R₃ and R₄ each independently represent a group that can substitute the benzene ring and may be mutually bonded to form a condensed ring.

A fourth aspect of the invention is to provide the photothermographic material (Q), wherein said non-photosensitive organic silver salt is an organic acid silver salt with a content of silver behenate equal to or higher than 90 mol. %.

A fifth aspect of the invention is to provide the photothermographic material (Q), wherein said non-photosensitive organic silver salt is an organic acid silver salt with a content of silver behenate equal to or higher than 95 mol. %.

A sixth aspect of the invention is to provide the photothermographic material (Q), wherein said polymer has a glass transition temperature within a range from −30° to 70° C.

A seventh aspect of the invention is to provide the photothermographic material (Q), wherein said polymer has a glass transition temperature within a range from −10° to 35° C.

A eighth aspect of the invention is to provide the photothermographic material (Q), wherein said reducing agent is a compound represented by the following general formula (R):

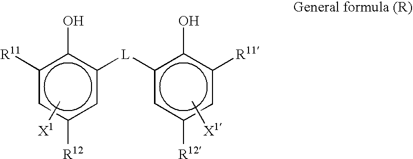

wherein in general formula (R), R¹¹ and R^{11′} each independently represent an alkyl group having 1 to 20 carbon atoms; R¹² and R^{12′} each independently represent a hydrogen atom or a substituent that can substitute the benzene ring; L represents an —S— group or a —CHR¹³— group; R¹³ represents a hydrogen atom or an alkyl group having 1 to 20 carbon atoms; and X¹ and X^{1′} each independently represent a hydrogen atom or a group that can substitute the benzene ring.

A ninth aspect of the invention is to provide the photothermographic material (Q), wherein said reducing agent is a compound represented by the following general formula (R) and in the reducing agent represented by general formula (R), R¹¹ and R^{11′} each independently represent a secondary or tertiary alkyl group having 3 to 15 carbon atoms.

A tenth aspect of the invention is to provide the photothermographic material (Q), further comprising a phthalocyanine dye.

A eleventh aspect of the invention is to provide the photothermographic material (Q), wherein in general formula (M), R⁰¹ is a hydrogen atom and R⁰² is a methyl group.

A twelfth aspect of the invention is to provide the photothermographic material (Q), wherein said polymer is formed by copolymerizing a monomer having an acid group in an amount from 1 to 20 mass %.

A thirteenth aspect of the invention is to provide a photothermographic material (S) comprising, on a same surface of a substrate, a photosensitive silver halide, a non-photosensitive organic silver salt, a reducing agent and a binder, the material comprising, as said binder, a polymer latex formed by copolymerizing a monomer represented by the general formula (M) in an amount from 10 to 70 mass % and having a number-averaged particle size (dn) from 30 to 500 nm.

A fourteenth aspect of the invention is to provide the photothermographic material (S), wherein the polymer latex has a ratio (dv/dn) of a volume-weighted average particle size (dv) to a number-averaged particle size (dn) within a range from 1.00 to 1.10.

A fifteenth aspect of the invention is to provide a photothermographic material (S), wherein the polymer latex contains halogen ions in an amount of 500 ppm or less with respect to the latex.

A sixteenth aspect of the invention is to provide a photothermographic material (T) comprising, on a same surface of a substrate, a photosensitive silver halide, a non-photosensitive organic silver salt, a reducing agent and a binder, the material comprising, as said binder, a polymer latex formed by copolymerizing a monomer represented by the general formula (M) in an amount from 10 to 70 mass %, and emulsion polymerized with a peroxide as a polymerization initiator in an amount of 0.3 to 2 mass % with respect to the monomer.

A seventeenth aspect of the invention is to provide the photothermographic material (T), wherein said polymer latex includes halogen ions in an amount of 500 ppm or less with respect to the latex.

A eighteenth aspect of the invention is to provide the photothermographic material (S), wherein said polymer latex has a glass transition temperature within a range from −30° to 70° C.

A nineteenth aspect of the invention is to provide the photothermographic material (S), wherein, in said general formula (M), R⁰¹ is a hydrogen atom and R⁰² is a methyl group.

A twentieth aspect of the invention is to provide the photothermographic material (S), wherein said polymer is formed by copolymerizing a monomer having an acid group in an amount from 1 to 20 mass %.

A twenty-first aspect of the invention is to provide the photothermographic material (S), comprising halogen ions in an amount of 1000 ppm or less with respect to the organic silver salt.

### DETAILED DESCRIPTION OF THE INVENTION

In the following, the present invention will be explained in detail.

A first photothermographic material of the present invention has, on a same surface of a substrate, an image forming layer including a photosensitive silver halide, a non-photosensitive organic silver salt, a reducing agent, a development accelerator and a binder. Also there may be provided, if necessary, a non-photosensitive layer such as a surface protective layer, or an intermediate layer between an image forming layer and a surface protective layer. The surface protective layer may be formed of a single layer, or of two or more layers. Also a back layer or a back protective layer may be provided on a surface of the substrate opposite to the image forming layer.

(Explanation of Binder)

The first photothermographic material of the invention employs, as a binder for the image forming layer, a polymer formed by copolymerizing a monomer represented by the following general formula (M) in an amount of 10 to 70 mass %:
CH₂═CR⁰¹—CR⁰²═CH₂ General formula (M)
wherein R⁰¹ and R⁰² each independently represent a group selected from the group consisting of hydrogen atom, an alkyl group with 1 to 6 carbon atoms, a halogen atom, and a cyano group, however R⁰¹ and R⁰² cannot be simultaneously hydrogen atoms.

The alkyl group preferred for R⁰¹ and R⁰² is an alkyl group with 1 to 4 carbon atoms, more preferably an alkyl group with 1 to 2 carbon atoms. As the halogen atom, a fluorine atom, a chlorine atom or a bromine atom is preferred, and a chlorine atom is more preferred.

Particularly preferably, one of R⁰¹ and R⁰² is a hydrogen atom and the other is a methyl group or a chlorine atom.

A second photothermographic material of the invention has, on a same surface of a substrate, an image forming layer including a photosensitive silver halide, a non-photosensitive organic silver salt, a reducing agent and a binder. Also there may be provided, if necessary, a non-photosensitive layer such as a surface protective layer, or an intermediate layer between an image forming layer and a surface protective layer. The surface protective layer may be formed of a single layer, or of plural layers. Also a back layer or a back protective layer may be provided on a surface of the substrate opposite to the image forming layer.

(Explanation of Binder)

The second photothermographic material of the invention employs, as a binder for the image forming layer, a polymer latex formed by copolymerizing a monomer represented by the aforementioned general formula (M) in an amount from 10 to 70 mass %, having a number-averaged particle size (dn) of 50 to 500 nm and also having a ratio (dv/dn) of a volume-weighted average particle size (dv) and a number-averaged particle size (dn) within a range from 1.00 to 1.10.

The polymer latex used in the second photothermographic material of the invention has a number-averaged particle size of 30 to 500 nm, preferably 50 to 300 nm, and more preferably 70 to 200 nm.

In the polymer latex employed in the second photothermographic material of the invention, a ratio (dv/dn) of a volume-weighted average particle size (dv) and a number-averaged particle size (dn) is within a range of 1.00 to 1.10, preferably 1.0 to 1.05 and more preferably 1.0 to 1.02.

The number-averaged particle size (dn) and the volume-averaged particle size (dv) were measured in the following manner.

A particle size of latex can be analyzed by a direct observation method utilizing a low-temperature transmission electron microscope. For direct observation of the particle size of latex with the transmission electron microscope, a latex dispersion, diluted 20 times with water, was placed on a mesh for electron microscope observation, then frozen by immersion in liquid nitrogen and observed with the electron microscope at a temperature of liquid nitrogen. An obtained photograph of the particles was processed with image processing software (trade name: WIN ROOF, manufactured by Mitani Shoji Co.) to obtain a number-averaged particle size and a volume-averaged particle size, and a ratio thereof was used as an index for the particle size distribution.

A number-averaged particle size (dn) exceeding 500 nm is undesirable because a coating solution becomes poor in stability and causes coagulation or sedimentation, thus becoming unable to obtain a uniform film, while, with a number-averaged particle size less than 30 nm, the coating solution shows a significant viscosity increase and becomes incapable of uniform coating. Also a ratio of the volume-weighted average particle size (dv) and the number-averaged particle size (dn) wider than the aforementioned range is undesirable because the stability in the latex synthesis cannot be secured whereby reproducibility in the manufacture of photosensitive material is deteriorated and a photosensitive material uniform in quality cannot be produced.

In the second photothermographic material of the invention, it is also preferable, for controlling physical properties of the coating solution, to use a mixture of plural latexes different in the number-averaged particle size (dn) or in the ratio of the volume-weighted average particle size (dv) and the number-averaged particle size (dn).

In the following there will be explained configurations common to both photothermographic materials of the invention, such as components thereof.

Specific examples of the monomer represented by the general formula (M) of the invention include 2-ethyl-1,3-butadiene, 2-n-propyl-1,3-butadiene, 2,3-dimethyl-1,3-butadiene, 2-methyl-1,3-butadiene, 2-chloro-1,3-butadiene, 1-bromo-1,3-butadiene, 2-fluoro-1,3-butadiene, 2,3-dichloro-1,3-butadiene, and 2-cyano-1,3-butadiene.

The binder of the invention is a polymer formed by copolymerizing the monomer represented by the general formula (M). In such polymer, the monomer represented by the general formula (M) has a copolymerization ratio of 10 to 70 mass %, preferably 15 to 65 mass % and more preferably 20 to 60 mass %. A copolymerization ratio of the monomer represented by the general formula (M) less than 10 mass % decreases a fusible component in the binder, thereby deteriorating working brittleness. Also, a copolymerization ratio of the monomer represented by the general formula (M) exceeding 70 mass % increases the fusible component in the binder to enhance the mobility of the binder, thereby deteriorating image storability.

In the invention, another monomer that can be copolymerized with the monomer represented by the general formula (M) is not particularly restricted, and there can be advantageously employed any monomer that can be polymerized by ordinary radical or ionic polymerization methods. The preferable monomer usable can be selected in an independent and arbitrary combination from the following monomer groups (a) to (j):

Monomer Groups (a)-(j)

(a) conjugate dienes: 1,3-butadiene, 1,3-pentadiene, 1-phenyl-1,3-butadiene, 1-α-naphthyl-1,3-butadiene, 1-β-naphthyl-1,3-butadiene, 1-bromo-1,3-butadiene, 1-chloro-1,3-butadiene, 1,1,2-trichloro-1,3-butadiene, cyclopentadiene, etc.;

(b) olefins: ethylene, propylene, vinyl chloride, vinylidene chloride, 6-hydroxy-1-hexene, 4-pentenic acid, methyl 8-noneate, vinylsulfonic acid, trimethylvinylsilane, trimethoxyvinylsilane, 1,4-divinylcyclohexane, 1,2,5-trivinylcyclohexane, etc.;

(c) α,β-unsaturated carboxylic acids and salts thereof: acrylic acid, methacrylic acid, itaconic acid, maleic acid, sodium acrylate, ammonium methacrylate, potassium itaconate, etc.;

(d) α,β-unsaturated carboxylic acid esters: alkyl acrylate (such as methyl acrylate, ethyl acrylate, butyl acrylate, cyclohexyl acrylate, 2-ethylhexyl acrylate, and dodecyl acrylate), substituted alkyl acrylate (such as 2-chloroethyl acrylate, benzyl acrylate, and 2-cyanoethyl acrylate), alkyl methacrylate (such as methyl methacrylate, butyl methacrylate, 2-ethylhexyl methacrylate, and dodecyl methacrylate), substituted alkyl methacrylate (such as 2-hydroxyethyl methacrylate, glycidyl methacrylate, glycerin monomethacrylate, 2-acetoxyethyl methacrylate, tetrahydro furfuryl methacrylate, 2-methoxyethyl methacrylate, polypropylene glycol monomethacrylate (with 2 to 100 addition moles of polyoxypropylene), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethyoxysilylpropyl methacrylate, allyl methacrylate, or 2-isocyanatethyl methacrylate), an unsaturated dicarboxylic acid derivative (such as monobutyl maleate, dimethyl maleate, monomethyl itaconate and dibutyl itaconate), polyfunctional ester (such as ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexacrylate and 1,2,4-cyclohexane tetramethacrylate);

(e) amides of β-unsaturated carboxylic acids: such as acrylamide, methacrylamide, N-methylmethacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetacetoxyethyl)acrylamide, N-acryloylmorpholine, diacetone acrylamide, itaconic diamide, N-methylmaleimide, 2-acrylamide-methylpropane sulfonic acid, methylenebisacrylamide, dimethacryloyl piperazine, etc.;

(f) unsaturated nitriles: acrylonitrile, methacrylonitrile, etc.;

(g) styrene and derivatives thereof: styrene, vinyltoluene, p-tert-butylstyrene, vinylbenzoic acid, methyl vinylbenzoate, α-methylstyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, etc.;

(h) vinyl ethers: methyl vinyl ether, butyl vinyl ether, methoxyethyl vinyl ether, etc.;

(i) vinyl esters: vinyl acetate, vinyl propionate, vinyl benzoate, vinyl salicylate, vinyl chloroacetate, etc.;

(j) other polymerizable monomers: N-vinylimidazole, 4-vinylpyridine, N-vinylpyrrolidone, 2-vinyloxazoline, 2-isopropenyloxazoline, divinylsulfon, etc.

Preferred examples of the polymer formed by copolymerizing the monomer represented by the general formula (M) of the invention include a copolymer with styrene (such as a random copolymer or a block copolymer), a copolymer with styrene and butadiene (such as a random copolymer, a butadiene-isoprene-styrene block copolymer, or a styrene-butadiene-isoprene-styrene block copolymer), a copolymer with ethylene-propylene, a copolymer with acrylonitrile, a copolymer with isobutylene, a copolymer with an acrylate ester (acrylate ester can be for example ethyl acrylate or butyl acrylate), and a copolymer with an acrylate ester and acrylonitrile (acrtylate ester can be similar to those shown in the foregoing), and, among these, a copolymer with styrene is most preferable.

Also the polymer of the invention can preferably comprises, in addition to the above-described composition, a monomer having an acid group as a copolymerization component. The acid group can be preferably carboxylic acid, sulfonic acid or phosphoric acid. The acid group has a copolymerization ratio of preferably 1 to 20 mass %, more preferably 1 to 10 mass %.

Specific examples of the monomer having the acid group include acrylic acid, methacrylic acid, itaconic acid, sodium p-styrenesulfonate, isoprenesulfonic acid, and phosphorylethyl methacrylate.

In the binder of the invention, any polymer may be employed in combination with the copolymer comprising the monomer represented by the aforementioned general formula (M). The polymer usable in combination can be preferably transparent or semi-transparent and colorless, and can be a natural resin, a natural polymer, a natural copolymer, a synthetic resin, a synthetic polymer, a synthetic copolymer, or another film-forming material, such as a gelatin, a poly(vinyl alcohol), a hydroxyethyl cellulose, a cellulose acetate, a cellulose acetate butyrate, a poly(vinylpyrrolidone), casein, starch, a poly(acrylic acid), a poly(methylmethacrylic acid), a poly(vinyl chloride), a poly(methacrylic acid), a styrene-maleic anhydride copolymer, a styrene-acrylonitrile copolymer, a styrene-butadiene copolymer, a poly(vinylacetal) (such as poly(vinylformal) or poly(vinylbutyral)), a poly(ester), a poly(urethane), a phenoxy resin, a poly(vinylidene chloride), a poly(epoxide), a poly(carbonate), a poly(vinyl acetate), a poly(olefin), or a poly(amide). The binder may be applied by using water, an organic solvent or an emulsion.

The binder of the invention, in consideration of a brittleness in working and image storability, has a glass transition temperature (Tg) preferably within a range from −30 to 70° C., more preferably −10 to 50° C. and further preferably 0 to 40° C. It is also possible to blend two or more polymers as the binder, and, in such case, the average Tg weighted in consideration of the composition is preferably included in the aforementioned range. Also in the case of the binder showing a phase separation or a core-shell structure, a weighted average Tg is preferably included in the aforementioned range.

The glass transition temperature (Tg) can be calculated from the following equation:
1/Tg=Σ(Xi/Tgi)
in which it is assumed that the polymer is formed by a copolymerization of n monomer components (i=1 to n); Xi represents a weight fraction of i-th monomer (ΣXi=1), and Tgi represents a glass transition temperature (absolute temperature) of a homopolymer of the i-th monomer. Σ indicates a summation from i=1 to n. The glass transition temperature (Tgi) of a homopolymer of each monomer was obtained from Polymer Handbook (3rd edition) (J. Brandrup, E. H. Immergut (Wiley-Interscience, 1989)).

The polymer to be employed in the binder of the invention can be easily obtained by solution polymerization, suspension polymerization, emulsion polymerization, dispersion polymerization, anionic polymerization, cationic polymerization, etc. but the emulsion polymerization capable of providing a latex is most preferable. The emulsion polymerization is executed by employing water or a mixed solvent of water and an organic solvent miscible with water (such as methanol, ethanol or acetone) as a dispersion medium, utilizing a monomer mixture in an amount of 5 to 150 mass % with respect to the dispersion medium, an emulsifier, and a polymerization initiator and executing polymerization under agitation for 3 to 24 hours at a temperature of about 30 to 100° C., preferably 60 to 90° C. Conditions such as a dispersion medium, a monomer concentration, an amount of the initiator, an amount of the emulsifier, an amount of the dispersant, a reaction temperature, a method of monomer addition, etc. are suitably selected in consideration of the kinds of the monomers to be employed. It is also preferable to employ a dispersant if necessary.

The emulsion polymerization can be executed generally according to the following references: “Gosei Jushi Emulsion (synthetic resin emulsion) (edited by Taira Okuda and Hirochi Inagaki, published by Kobunshi Kankokai (1978))”, “Gosei Latex no Ouyo (application of synthetic latex) (edited by Takaaki Sugimura, Yasuo Kataoka, Soichi Suzuki and Keiji Kasahara, published by Kobunshi Kankokai (1993))”, and “Gosei Latex no Kagaku (chemistry of synthetic latex) (Soichi Muroi, published by Kobunshi Kankokai (1970))”. In the emulsion polymerization method for synthesizing the polymer latex of the invention, there can be selected a collective polymerization method, a monomer addition (continuous or divided) method, an emulsion addition method, a seed polymerization method, etc., and, in consideration of the productivity of the latex, there is preferred a collective polymerization method, a monomer addition (continuous or divided) method or an emulsion addition method.

Particularly in the second photothermographic material of the invention, the latex polymer of the invention is desired to have a low halogen ion content, preferably 500 ppm or less with respect to the latex dispersion. The halogen ion content is preferably 200 ppm or less, and further preferably 100 ppm or less. The halogen ion content with respect to a polymer solid is preferably 1200 ppm or less, more preferably 500 ppm or less and further preferably 250 ppm or less.

The halogen ion content can be reduced to the above-mentioned range, after the synthesis of polymer latex, by a desalination method such as an ion exchange resin method, a dialysis membrane method or an ultrafiltration method. However, the latex purified by such desalination method is undesirable for use in the photothermographic material of the invention since it tends to cause a coagulation or a pseudo coagulation in a coating solution, thereby deteriorating a state of the coated surface.

A method of reducing the halogen ion content preferable for the invention is a method by latex synthesizing conditions. The latex synthesis employs various additives for example a monomer emulsifier, a dispersant, a polymerization initiator, a chain transfer agent, and a chelating agent, and the halogen ion content in the obtained latex can be controlled within the aforementioned range by a selection of these additives and a limitation on amounts thereof. Otherwise, it is also preferable to treat these additives with an ion exchange membrane in advance thereby eliminating halogen ions.

Also the water to be employed as a solvent has preferably a low halogen ion concentration.

In the following, there will be explained again components common to both photothermographic materials of the invention.

The polymerization initiator mentioned above can be any compound having the ability of generating radicals, and can be an inorganic peroxide such as a persulfate salt or hydrogen peroxide, a peroxide described for example in an organic peroxide catalog of NOF Corporation, or an azo compound described for example in an azo polymerization initiator catalog of Wako Pure Chemical Industries, Ltd. Among these, a water-soluble peroxide such as a persulfate salt or a water-soluble azo compound described for example in an azo polymerization initiator catalog of Wako Pure Chemical Industries, Ltd. is preferred, and more preferred are ammonium persulfate, sodium persulfate, potassium persulfate, hydrochloric acid salt of azobis(2-methylpropionamidine), azobis(2-methyl-N-(2-hydroxyethyl)propionamide), or azobiscyanovaleric acid. In particular, a peroxide such as ammonium persulfate, sodium persulfate or potassium persulfate is preferable in consideration of image storability, solubility and cost.

An amount of addition of the polymerization initiator is preferably 0.3 to 2.0 mass % with respect to the total amount of the monomers, more preferably 0.4 to 1.75 mass % and particularly preferably 0.5 to 1.5 mass %. An amount of the polymerization initiator less than 0.3 mass % deteriorates image storability, while an amount exceeding 2.0% tends to cause coagulation of the latex thereby deteriorating the coating property.

The polymerization emulsifier mentioned above can be any of an anionic surfactant, a nonionic surfactant, a cationic surfactant and an amphoteric surfactant. However an anionic surfactant is preferred in consideration of dispersiblity and image storability. An anionic surfactant of sulfonic acid type is more preferred because it can secure a stability of polymerization with a small amount and it is resistant to hydrolysis. A long-chain alkyl diphenylether disulfonate salt represented by PEREX SS-H (trade name, manufactured by Kao Corporation) is further preferred, and a low electrolyte type such as PIONIN A-43-S (trade name, manufactured by Takemoto Yushi Co.) is particularly preferred.

It is preferable to employ, as the polymerization emulsifier, an anionic surfactant of sulfonic acid type in an amount of 0.1 to 10.0 mass % with respect to the total amount of the monomers, more preferably 0.2 to 7.5 mass % and particularly preferably 0.3 to 5.0 mass %. An amount of the polymerization emulsifier less than 0.1 mass % cannot secure the stability at the emulsion polymerization, and an amount exceeding 10.0% deteriorates the image storability.

For synthesizing the polymer latex to be employed in the invention, it is preferable to employ a chelating agent. The chelating agent is a compound capable of chelating polyvalent ions. Examples of the polyvalent ions include metal ions such as iron ions or alkali earth metal ions such as calcium ions. There can be employed compounds described for example in JP-B No. 6-8956, U.S. Pat. No. 5,053,322, JP-A Nos. 4-73645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433, 7-306504, 9-43792, 8-314090, 10-182571, 10-182570 and 11-190892.

Preferred examples of the chelating agent include an inorganic chelating agent (such as sodium tripolyphosphate, sodium hexametaphosphate or sodium tetrapolyphosphate), an aminopolycarboxylic acid chelating agent (such as nitrilotriacetic acid or ethylenediamine tetraacetic acid), an organic phosphonic acid chelating agent (such as compounds described in Research Disclosure No. 18170, JP-ANos. 52-102726, 53-42730, 56-97347, 54-121127, 55-4024, 55-4025, 55-29883, 55-126241, 55-65955, 55-65956, 57-179843, 54-61125, and German Patent No. 1,045,373), a polyphenol chelating agent and a polyamine chelating agent, and an aminopolycarboxylic acid derivative is particularly preferable.

Preferred examples of the aminopolycarboxylic acid derivative include compounds described in “EDTA (chemistry of complexan)” (Nankodo, 1977), Appendix. Some of carboxyl groups in such compounds may be converted to salt-form with an alkali metal such as sodium or potassium or with an ammonium ion. Particularly preferable examples of the aminocarboxylic acid derivative include iminodiacetic acid, N-methyliminodiacetic acid, N-(2-aminoethyl)iminodiacetic acid, N-(carbamoylmethyl)-iminodiacetic acid, nitrilotriacetic acid, ethylenediamine-N,N′-diacetic acid, ethylenediamine-N,N′-di-α-propionic acid, ethylenediamine-N,N′-di-β-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic acid-N,N′-diacetonehydroxamic acid, N-hydroxyethyl-ethylenediamine-N,N′,N′-triacetic acid, ethylenediamine-N,N,N′,N′-tetraacetic acid, 1,2-propylenediamine-N,N,N′,N′-tetraacetic acid, d,l-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,l-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraacetic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-α-propionic acid, ethylenediamine-N,N′-diacetic acid-N,N′-di-p-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid, and 1,2,3-triaminopropane-N,N,N′,N″,N′″, N′″-hexaacetic acid, and there can also be included compounds obtained by converting some of carboxyl groups in the respective compounds listed above to salt-form with an alkali metal such as sodium or potassium or with an ammonium ion.

An amount of such chelating agent to be added is preferably 0.01 to 0.4 mass % with respect to the total monomer amount, more preferably 0.02 to 0.3 mass % and particularly preferably 0.03 to 0.15 mass %. An amount of the chelating agent less than 0.01 mass % results in an insufficient trapping of metal ions migrating in the step of producing polymer latex, thus reducing the stability of latex against coagulation and deteriorating the coating property. Also an amount exceeding 0.4% elevates the viscosity of the latex, thereby deteriorating the coating property.

In the synthesis of polymer latex to be employed in the invention, a chain transfer agent can be preferably employed. As the chain transfer agent, there are preferred ones described in Polymer Handbook, 3rd edition (Wiley-Interscience, 1989). A sulfur compound is more preferable as it has a high chain transfer ability and can be used in a smaller amount. A hydrophobic mercaptane chain transfer agent such as tert-dodecylmercaptane or n-dodecylmercaptane is particularly preferable.

An amount of the chain transfer agent is preferably 0.2 to 2.0 mass % with respect to the total monomer amount, more preferably 0.3 to 1.8 mass % and particularly preferably 0.4 to 1.6 mass %. An amount of the chain transfer agent less than 0.2 mass % deteriorates the working brittleness, and an amount exceeding 2.0 mass % deteriorates the image storability.

In the emulsion polymerization, it is possible to add, in addition to the aforementioned compounds, other additives as described for example in Synthetic Rubber Handbook, such as an electrolyte, a stabilizer, a viscosifier, a defoamer, an antioxidant, a vulcanizer, an antifreeze, a gelling agent, a vulcanization accelerator, etc.

(Specific Examples of Polymer)

Example compounds (P-1) to (P-29) are shown as specific examples of the polymer to be employed in the invention, but the invention is not limited to such examples. In the chemical formulas, x, y, z and z′ indicate mass ratios of the polymer composition, and a sum of x, y, z and z′ is 100%. Tg indicates a glass transition temperature of a dry film obtained from a polymer.

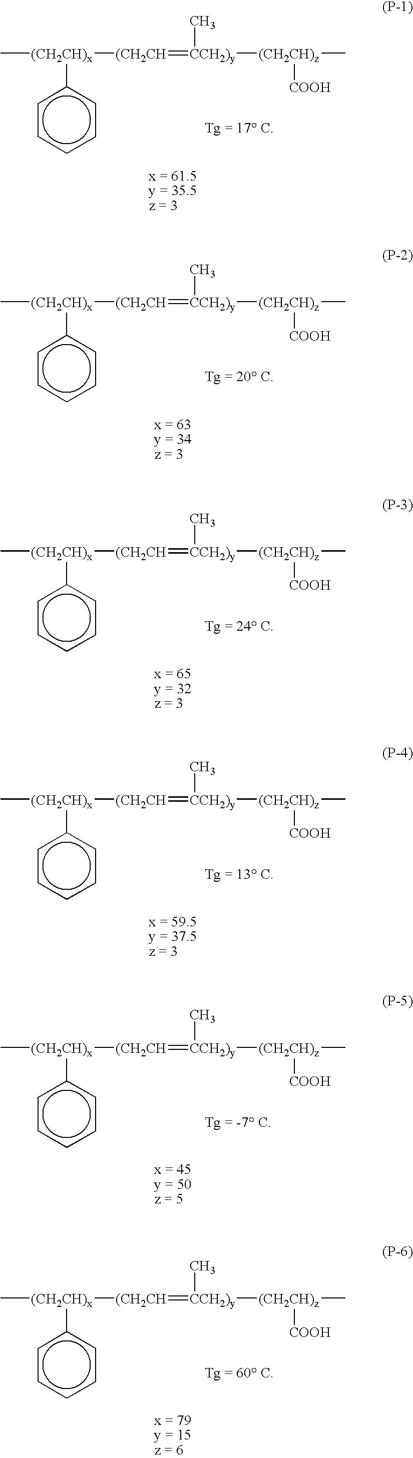

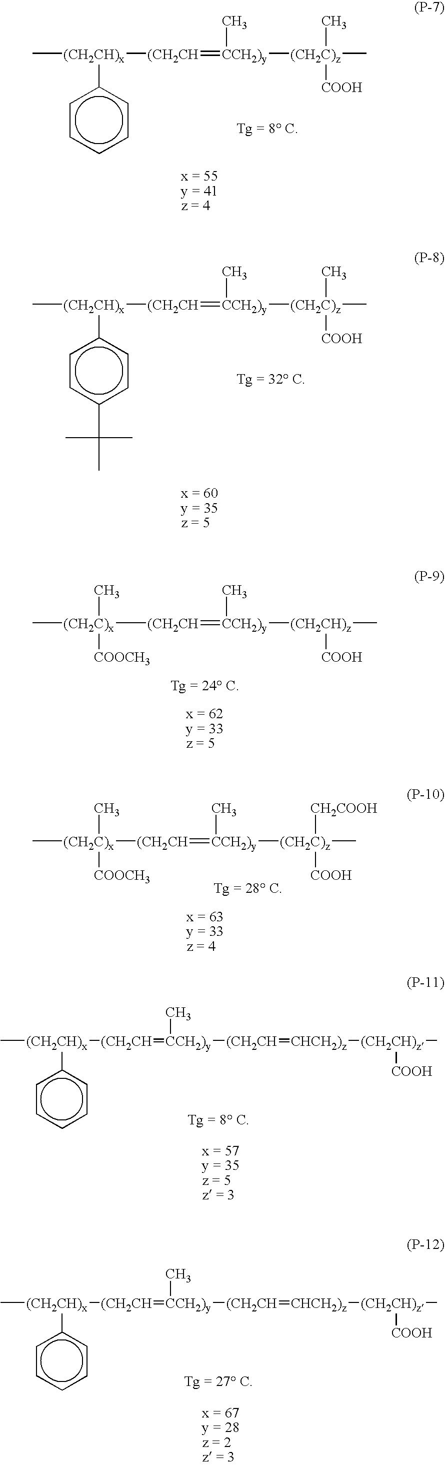

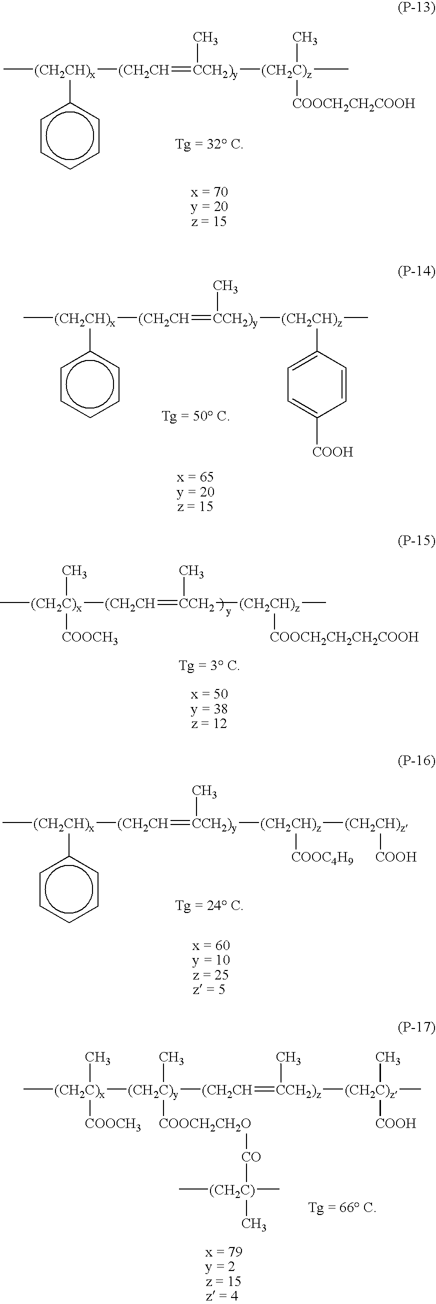

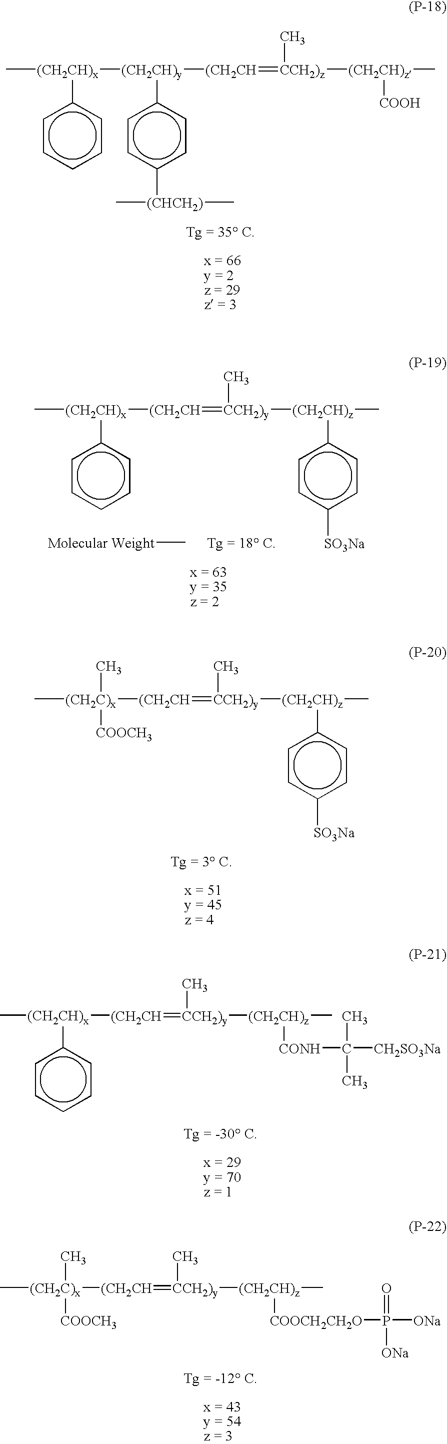

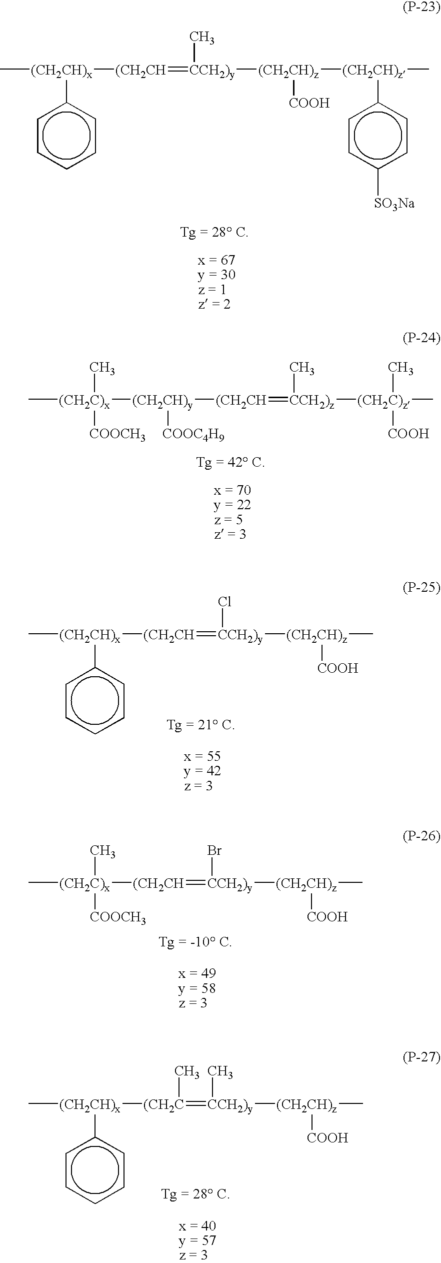

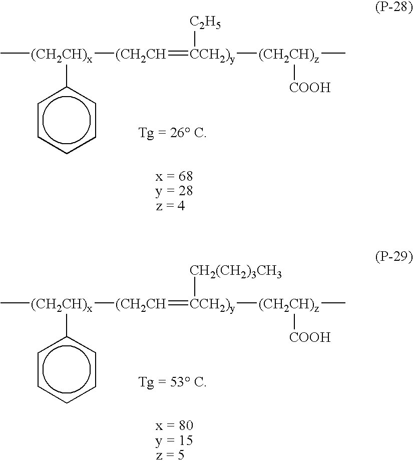

In the following, examples of synthesis of the polymer to be employed in the invention will be shown, but such synthetic methods are not restrictive. Also other example compounds can be synthesized by similar methods of synthesis.

### SYNTHESIS EXAMPLE 1

### Synthesis of Example Compound P-1

To a polymerization vessel of a gas monomer reaction apparatus (model TAS-2J, manufactured by Taiatsu Glass Kogyo Co.), 1500 g of distilled water was added and heated for 3 hours at 90° C. to form an inert film on a stainless steel surface of the polymerization vessel and on members of a stainless steel agitating apparatus. To thus treated polymerization vessel, there were added 584.86 g of distilled water subjected to a bubbling with nitrogen gas for 1 hour, 9.45 g of a surfactant (PIONIN A-43-S (manufactured by Takemono Yushi Co.)), 20.25 g of 1 mol/l NaOH, 0.216 g of tetrasodium ethylenediamine-tetraacetate, 332.1 g of styrene, 191.7 g of isoprene, 16.2 g of acrylic acid and 4.32 g of tert-dodecylmercaptane, then the reaction vessel was tightly closed, and the internal temperature was raised to 60° C. under agitation at an agitating speed of 225 rpm. Then a solution of 2.7 g of ammonium persulfate in 50 ml of water was added, and the agitation was continued for 7 hours. Then the temperature was further raised to 90° C. and the agitation was continued for 3 hours, and, after the completion of reaction, the internal temperature was lowered to the room temperature and obtained polymer was filtered with a filtering cloth (mesh: 225) to obtain 1145 g of the example compound P-1 (solid 45 mass %, particle size 112 nm).

### SYNTHESIS EXAMPLE 2

### Synthesis of Example Compound P-2

In a polymerization vessel of a gas monomer reaction apparatus (model TAS-2J, manufactured by Taiatsu Glass Kogyo Co.), an inert film was formed in the same manner as in the synthesis example 1, and there were charged 350.92 g of distilled water subjected to a bubbling with nitrogen gas for 1 hour, 3.78 g of a surfactant (PIONIN A-43-S (manufactured by Takemono Yushi Co.)), 20.25 g of 1 mol/l NaOH, 0.216 g of tetrasodium ethylenediamine-tetraacetate, 34.02 g of styrene, 18.36 g of isoprene, 1.62 g of acrylic acid and 2.16 g of tert-dodecylmercaptane. Then the reaction vessel was tightly closed, and the internal temperature was raised to 65° C. under agitation at an agitating speed of 225 rpm. Then a solution of 1.35 g of ammonium persulfate in 50 ml of water was added thereto, and the agitation was continued for 2 hours. Separately 233.94 g of distilled water, 5.67 g of a surfactant (PIONIN A-43-S (manufactured by Takemono Yushi Co.)), 306.18 g of styrene, 165.24 g of isoprene, 14.58 g of acrylic acid, 2.16 g of tert-dodecylmercaptane and 1.35 g of ammonium persulfate were added and agitated to prepare an emulsion, and this emulsion was added over 8 hours to the reaction vessel. After the addition, agitation was continued for 2 hours. Then the temperature was further raised to 90° C. and the agitation was continued for 3 hours, and, after the completion of reaction, the internal temperature was lowered to the room temperature and obtained polymer was filtered with a filtering cloth (mesh: 225) to obtain 1147 g of the example compound P-2 (solid 45 mass %, particle size 121 nm, monodispersion degree: 1.05, halogen ion concentration: 9 ppm).

### SYNTHESIS EXAMPLE 3

### Synthesis of Example Compound P-4

In a polymerization vessel of a gas monomer reaction apparatus (model TAS-2J, manufactured by Taiatsu Glass Kogyo Co.), an inert film was formed in the same manner as in the synthesis example 1, and there were charged 578.11 g of distilled water subjected to a bubbling with nitrogen gas for 1 hour, 16.2 g of a surfactant (PEREX SS-H (manufactured by Kao Corp.)), 20.25 g of 1 mol/l NaOH, 0.216 g of tetrasodium ethylenediamine-tetraacetate, 321.3 g of styrene, 202.5 g of isoprene, 16.2 g of acrylic acid and 4.32 g of tert-dodecylmercaptane. Then the reaction vessel was tightly closed, and the internal temperature was raised to 60° C. under agitation at an agitating speed of 225 rpm. Then a solution of 2.7 g of ammonium persulfate in 25 ml of water was added, and the agitation was continued for 5 hours. Then a solution of 1.35 g of sodium persulfate in 25 ml of water was added, then the temperature was further raised to 90° C. and the agitation was continued for 3 hours. After the completion of reaction, the internal temperature was lowered to the room temperature and obtained polymer was filtered with a filtering cloth (mesh: 225) to obtain 1139 g of the example compound P-4 (solid: 45 mass %, particle size: 105 nm, monodispersion degree: 1.05, halogen ion concentration: 15 ppm).

### SYNTHESIS EXAMPLE 4

### Synthesis of Example Compound P-1

In a polymerization vessel of a gas monomer reaction apparatus (model TAS-2J, manufactured by Taiatsu Glass Kogyo Co.), 1500 g of distilled water was added and heated for 3 hours at 90° C. to form an inert film on a stainless steel surface of the polymerization vessel and on members of a stainless steel agitating apparatus. In thus treated polymerization vessel, there were charged 584.86 g of distilled water subjected to a bubbling with nitrogen gas for 1 hour, 9.45 g of a surfactant (PIONIN A-43-S (manufactured by Takemono Yushi Co.)), 20.25 g of 1 mol/L NaOH, 0.216 g of tetrasodium ethylenediamine-tetraacetate, 332.1 g of styrene, 191.7 g of isoprene, 16.2 g of acrylic acid and 4.32 g of tert-dodecylmercaptane, then the reaction vessel was tightly closed, and the internal temperature was raised to 60° C. under agitation at an agitating speed of 225 rpm. Then a solution of 4.1 g of ammonium persulfate in 50 ml of water was added, and the agitation was continued for 7 hours. Then the temperature was further raised to 90° C. and the agitation was continued for 3 hours, and, after the completion of reaction, the internal temperature was lowered to the room temperature and obtained polymer was filtered with a filtering cloth (mesh: 225) to obtain 1145 g of the example compound P-1 (solid: 45 mass %, particle size: 112 nm, monodispersion degree: 1.04, halogen ion concentration: 20 ppm).

The polymer latex to be employed in the invention can employ an aqueous solvent as the solvent for the coating solution, but a water-miscible organic solvent may also be used in combination.

Examples of the water-miscible organic solvent include an alcohol such as methyl alcohol, ethyl alcohol or propyl alcohol, a cellosolve such as methyl cellosolve, ethyl cellosolve or butyl cellosolve, ethyl acetate and dimethylformamide. An amount of such organic solvent to be added is preferably 50% or less of the solvents, more preferably 30% or less.

Also the polymer latex of the invention has a polymer concentration of preferably 10 to 70 mass % with respect to the latex liquid, more preferably 20 to 60 mass % and particularly preferably 30 to 55 mass %.

The binder polymer of the invention has an equilibrium moisture content of preferably 2 mass % or less in an environment of 25° C. and 60% RH, more preferably 0.01 to 1.5 mass %, and further preferably 0.02 to 1 mass %.

The “equilibrium moisture content in an environment of 25° C. and 60% RH” can be represented, with a polymer weight W1 in a moisture equilibrium state in an environment of 25° C. and 60% RH and a polymer weight W0 in an absolute dry state at 25° C., as follows:
equilibrium moisture content in an environment of 25° C., 60% RH=[(W1−W0)/W0]×100 (mass %)

For the definition of the water content and the measuring method therefor, reference can be made for example to Kobunshi Kogaku Koza 14, Kobunshi Zairyo Shikenho (edited by Society of Polymer Science, published by Chijinshokan).

In the first photothermographic material of the invention, there is particularly preferred a polymer dispersible in an aqueous solvent. Such dispersion state can be a latex in which a water-insoluble hydrophobic polymer is dispersed in fine particles or a dispersion in which polymer molecules are dispersed in a molecular state or dispersed by forming micelles, however particles dispersed as a latex are more preferable. The dispersed particles have an average particle size of 1 to 50,000 nm, preferably 5 to 1,000 nm, more preferably 10 to 500 nm and further preferably 50 to 200 nm. A particle size distribution of the dispersed particles is not particularly limited, and can be a wide particle size distribution or a mono-dispersed particle size distribution. For controlling physical properties of the coating solution, it is also preferable to use two or more dispersions, each having a mono-dispersed particle size distribution, as a mixture.

In the following, there will be explained again components common to both photothermographic materials of the invention.

In the image forming layer of the invention, there may be added, if necessary, a hydrophilic polymer such as gelatin, polyvinyl alcohol, methyl cellulose, hydroxypropyl cellulose, or carboxymethyl cellulose. An amount of such hydrophilic polymer to be added is preferably 30 mass % or less with respect to the total amount of the binder in the image forming layer, more preferably 20 mass % or less.

The image forming layer of the invention is formed preferably by employing a polymer latex. A weight ratio of total binder/organic silver salt is preferably within a range from 1/10 to 10/1, more preferably 1/3 to 5/1, and further preferably 1/1 to 3/1.

Also the image forming layer has a weight ratio of total binder/photosensitive silver halide preferably within a range of 400 to 5, more preferably 200 to 10.

In the image forming layer of the invention, an amount of total binder is preferably 0.2 to 30 g/m², more preferably 1 to 15 g/m² and further preferably 2 to 10 g/m². In the image forming layer of the invention, there may be added a crosslinking agent for crosslinking, or a surfactant for improving the coating property.

(Explanation of Organic Silver Salt)

1) Composition

The organic silver salt employable in the invention is any silver salt that is relatively stable to light but functions as a silver ion supplying substance when heated to 80° C. or higher in the presence of an exposed photosensitive silver halide and a reducing agent, thereby forming a silver image. The organic silver salt can be an arbitrary organic substance that can supply silver ions that can be reduced by the reducing agent. Such non-photosensitive organic solver salt is described for example in JP-A No. 10-62899, paragraphs 0048-0049, EP-A No. 0803764A1, page 18, line 24 to page 19, line 37, EP-A No. 0962812A1, and JP-ANos. 11-349591, 2000-7683 and 2000-72711. There is preferred a silver salt of an organic acid, particularly a silver salt of a long-chain aliphatic carboxylic acid (with 10 to 30 carbon atoms, preferably 15 to 28 carbon atoms). Preferred examples of the fatty acid silver salt include silver lignoserate, silver behenate, silver arachidate, silver stearate, silver oleate, silver laurate, silver caproate, silver myristate, silver palmitate, silver erucate and a mixture thereof. In the invention it is preferred, among these fatty acid silver salts, to use a fatty acid silver salt having a silver behenate content of 50 to 100 mol. %, more preferably 90 to 100 mol. % and further preferably 95 to 100 mol. %. It is also preferable to use a fatty acid silver salt having a silver erucate content of 2 mol. % or less, more preferably 1 mol. % or less and further preferably 0.1 mol. % or less.

It is also preferable that a silver stearate content is 1 mol. % or less. A silver stearate content of 1 mol. % or less allows to obtain an organic acid silver salt having a low Dmin, a high sensitivity and an excellent image storability. The silver stearate content is more preferably 0.5 mol. % or less and it is particularly preferable that silver stearate is substantially absent.

Also in the case the silver salt of organic acid includes silver arachidate, it is preferable to have a silver arachidate content of 6 mol. % or less for obtaining an organic acid silver salt providing a low Dmin and an excellent image storability, more preferably 3 mol. % or less.

2) Shape

The shape of the organic silver salt employable in the invention is not particularly restricted, and may have an acicular shape, a rod shape, a flat shape or a scale shape.

In the invention, an organic silver salt of scale shape is preferable. There is also advantageously employed a grain of a short acicular shape with a ratio of a longer axis to a shorter axis not exceeding 5, a rectangular parallelepiped shape, a cubic shape or a potato-like amorphous shape. These organic silver grains have an advantage of a lower fog level at thermal development in comparison with a grain of a long acicular shape having a ratio of a longer axis to a shorter axis equal to or larger than 5. In particular, a grain with a ratio of a longer axis and a shorter axis equal to or less than 3 is preferable because of an improved mechanical stability of the coated film. In the present specification, an organic silver salt of a scale shape is defined in the following manner. The organic silver salt grain is observed under an electron microscope, and the grain shape is approximated by a rectangular parallelepiped with sides a, b and c in the increasing order (c may be equal to b), and the following value x is determined with the smaller values a and b in the following manner:
x=b/a

The value x is determined for about 200 grains to determine an average value x(average), and a scale shape is defined by a relation x(average)≧1.5. There is preferred a relation 30≧x(average)≧1.5, more preferably 15≧x(average)≧1.5. For reference, an acicular shape is defined by 1≦x(average)≦1.5.

In a scale-shaped grain, the value a can be regarded as a thickness of a flat grain having a principal plane defined by sides b and c. An average of the value a is preferably within a range of 0.01 to 0.3 μm, more preferably 0.1 to 0.23 μm. Also an average of c/b is preferably within a range of 1 to 9, more preferably 1 to 6, further preferably 1 to 4, and most preferably 1 to 3.

A sphere-corresponding diameter within a range of 0.05 to 1 μm hinders coagulation in the photosensitive material and provides a satisfactory image storability. The sphere-corresponding diameter is preferably 0.1 to 1 μm. In the present invention, the sphere-corresponding diameter can be determined by taking a photograph of a sample by an electron microscope and then executing an image processing on a negative.

In the aforementioned scale-shaped grains, a ratio of sphere-corresponding diameter/a of the grain is defined as an aspect ratio. The aspect ratio of the scale-shaped grain is preferably within a range of 1.1 to 30 in view of hindering coagulation in the photosensitive material and improving the image storability, more preferably within a range of 1.1 to 15.

A grain size distribution of the organic silver salt is preferably a monodispersion. Monodispersion means that percentages of the values obtained by dividing standard deviations of respective lengths of the shorter axis and longer axis respectively by the shorter axis and the longer axis, is preferably 100% or less, more preferably 80% or less and further preferably 50% or less. The shape of the organic silver salt can be measured from a transmission electron microscope image of an organic silver salt dispersion. The single dispersion property can also be measured by determining a standard deviation of a volume-weighted average diameter of the organic silver salt, and a percentage (variation factor) of a value obtained by dividing the standard deviation of the volume-weighted average diameter by the volume-weighted average diameter is preferably 100% or less, more preferably 80% or less and further preferably 50% or less. It can be determined from a particle size (volume-weighted average diameter) obtained by irradiating the organic silver salt, for examples dispersed in a liquid, with a laser light and determining a self-correlation function of a fluctuation of the scattered light with respect to time.

3) Preparation

For manufacturing and dispersing the organic silver salt to be employed in the invention, a known method can be employed. For example, reference may be made to JP-A No. 10-62899, EP-ANos. 0803763A1 and 0962812A1, JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870 and 2002-107868.

Since the presence of a photosensitive silver salt at the dispersion of the organic silver salt increases the fog level and significantly decreases the sensitivity, it is preferable that the photosensitive silver salt is substantially absent at the dispersion. In the invention, the amount of the photosensitive silver salt in an aqueous dispersion in which dispersion is executed is preferably 1 mol. % or less per 1 mole of organic silver salt in such dispersion, more preferably 0.1 mol. % or less, and further preferably no positive addition of photosensitive silver salt is executed.

In the invention, the photosensitive material can be prepared by mixing an aqueous dispersion of the organic silver salt and an aqueous dispersion of the photosensitive silver salt, and the mixing ratio of the organic silver salt and the photosensitive silver salt can be selected according to the purpose, however a proportion of the photosensitive silver salt to the organic silver salt is preferably within a range of 1 to 30 mol. %, more preferably 2 to 20 mol. %, and particularly preferably 3 to 15 mol. %. At the mixing, there can be preferably employed a method of mixing two or more aqueous dispersions of the organic silver salt and two or more aqueous dispersions of the photosensitive silver salt, in order to regulate the photographic characteristics.

4) Amount of Addition

The organic silver salt of the invention may be employed in a desired amount, however a total coated silver amount including silver halide is preferably within a range of 0.1 to 5.0 g/m², more preferably 0.3 to 3.0 g/m², and further preferably 0.5 to 2.0 g/m². Particularly for improving the image storability, there is preferred a total coated silver amount of 1.8 g/m² or less, more preferably 1.6 g/m² or less. A reducing agent preferred in the present invention allows to obtain a sufficient image density even with such low silver amount.

(Explanation of Reducing Agent)

The photothermographic material of the invention preferably includes a thermal developing agent which is a reducing agent for the organic silver salt. The reducing agent for the organic silver salt can be an arbitrary substance (preferably organic substance) capable of reducing a silver ion into metallic silver. Examples of such reducing agent are described in JP-A No. 11-65021, paragraphs 0043-0045 and EP-A No. 0803764A1, page 7, line 34 to page 18, line 12.

A reducing agent employed in the invention is preferably so-called hindered phenol reducing agent or a bisphenol reducing agent having a substituent in an ortho-position of a phenolic hydroxyl group, and more preferably a compound represented by the following general formula (R):

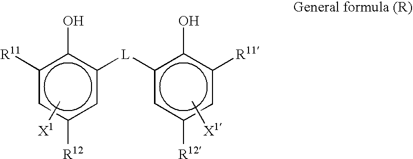

In the general formula (R), R¹¹ and R^{11′} each independently represent an alkyl group with 1 to 20 carbon atoms; R¹² and R^{12′} each independently represent a hydrogen atom or a substituent that can substitute the benzene ring; L represents —S— or —CHR¹³—; R¹³ represents a hydrogen atom or an alkyl group with 1 to 20 carbon atoms; and X¹ and X^{1′} each independently represent a hydrogen atom or a group that can substitute the benzene ring.

In the following, there will be given a detailed explanation of the general formula (R).

1) R¹¹ and R^{11′}

R¹¹ and R^{11′} each independently represent a substituted or non-substituted alkyl group with 1 to 20 carbon atoms. A substituent on the alkyl group is not particularly limited, but is preferably an aryl group, a hydroxyl group, an alkoxy group, an aryloxy group, an alkylthio group, an arylthio group, an acylamino group, a sulfonamide group, a sulfonyl group, a phosphoryl group, an acyl group, a carbamoyl group, an ester group, an ureido group, an urethane group or a halogen atom.

2) R¹² and R^{12′}, X¹ and X^{1′}

R¹² and R^{12′} each independently represent a hydrogen atom or a group that can substitute the benzene ring, and X¹ and X^{1′} each independently represent a hydrogen atom or a group that can substitute the benzene ring. Each group that can substitute the benzene ring can preferably be an alkyl group, an aryl group, a halogen atom, an alkoxy group or an acylamino group.

3) L

L represents an —S— group or a —CHR¹³— group. R¹³ represents a hydrogen atom or an alkyl group with 1 to 20 carbon atoms, and the alkyl group may have a substituent. Specific examples of the non-substituted alkyl group of R¹³ include a methyl group, an ethyl group, a propyl group, a butyl group, a heptyl group, an undecyl group, an isopropyl group, a 1-ethylpentyl group and 2,4,4-trimethylpentyl group. Examples of the substituent on the alkyl group are similar to the substituents on R¹¹, and include a halogen atom, an alkoxy group, an alkylthio group, an aryloxy group, an arylthio group, an acylamino group, a sulfonamide group, a sulfonyl group, a phosphoryl group, an oxycarbonyl group, a carbamoyl group and a sulfamoyl group.

4) Preferred Substituent

Each of R¹¹ and R^{11′} is preferably a secondary or tertiary alkyl group with 3 to 15 carbon atoms, and can specifically be an isopropyl group, an isobutyl group, a t-butyl group, a t-amyl group, a t-octyl group, a cyclohexyl group, a cyclopentyl group, a 1-methylcyclohexyl group or a 1-methylcyclopropyl group. Each of R¹¹ and R^{11′} is more preferably a tertiary alkyl group with 4 to 12 carbon atoms, among which more preferred is a t-butyl group, a t-amyl group or a 1-methylcyclohexyl group and most preferred is a t-butyl group.

Each of R¹² and R^{12′} is preferably an alkyl group with 1 to 20 carbon atoms, and can specifically be a methyl group, an ethyl group, a propyl group, a butyl group, an isopropyl group, a t-butyl group, a t-amyl group, a cyclohexyl group, a 1-methylcyclohexyl group, a benzyl group, a methoxymethyl group, or a methoxyethyl group. More preferably, each of R¹² and R^{12′} can be a methyl group, an ethyl group, a propyl group, an isopropyl group or a t-butyl group.

Each of X¹ and X^{1′} is preferably a hydrogen atom, a halogen atom, or an alkyl group, more preferably a hydrogen atom.

L is preferably a —CHR¹³— group.

R¹³ preferably represents a hydrogen atom or an alkyl group with 1 to 15 carbon atoms, and, as the alkyl group, there is preferred a methyl group, an ethyl group, a propyl group, an isopropyl group or a 2,4,4-trimethylpentyl group. As R¹³, there is particularly preferred a hydrogen atom, a methyl group, an ethyl group, a propyl group or an isopropyl group.

In the case where R¹³ is a hydrogen atom, each of R¹² and R^{12′} is preferably an alkyl group with 2 to 5 carbon atoms, more preferably an ethyl group or a propyl group and most preferably an ethyl group.

In the case where R¹³ is a primary or secondary alkyl group with 1 to 8 carbon atoms, each of R¹² and R^{12′} is preferably a methyl group. As the primary or secondary alkyl group with 1 to 8 carbon atoms represented by R¹³, there is more preferred a methyl group, an ethyl group, a propyl group or an isopropyl group, and further preferred is a methyl group, an ethyl group or a propyl group.

In the case where R¹¹, R^{11′}, R¹² and R^{12′} are all methyl groups, R¹³ is preferably a secondary alkyl group. As the secondary alkyl group represented by R³, an isopropyl group, an isobutyl group or a 1-ethylpentyl group is preferable, and an isopropyl group is more preferable.

The combination of R¹¹, R^{11′}, R¹², R^{12′} and R¹³ in the reducing agent affects thermal development property and the color of developed silver. These properties can be regulated by employing two or more reducing agents in various mixing ratios, and it is preferable to employ two or more kinds of reducing agents in combination according to the purpose.

In the following, specific examples of the reducing agent of the invention, including the compound represented by the general formula (R) are given, but the present invention is not limited to such examples.

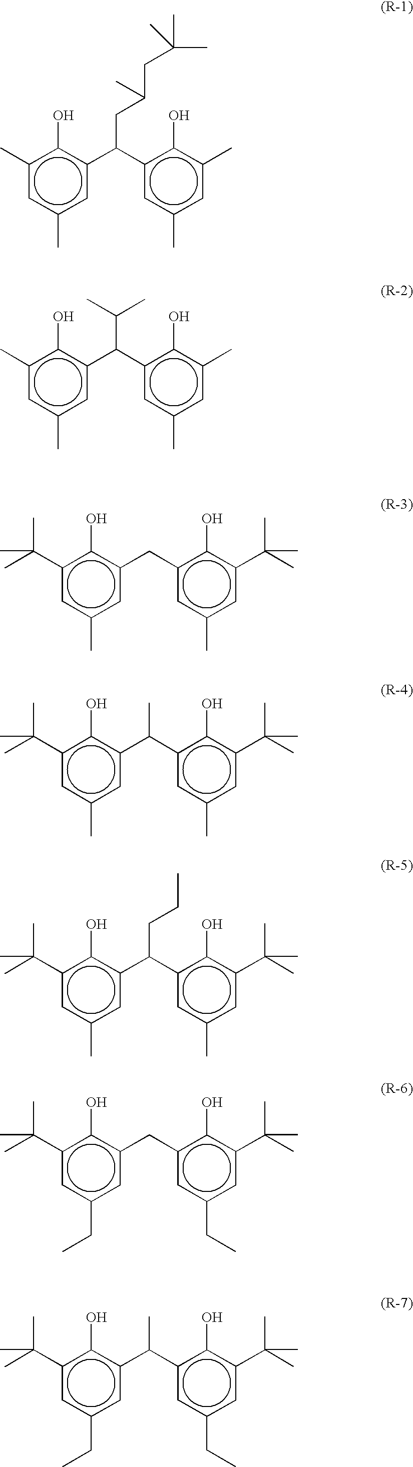

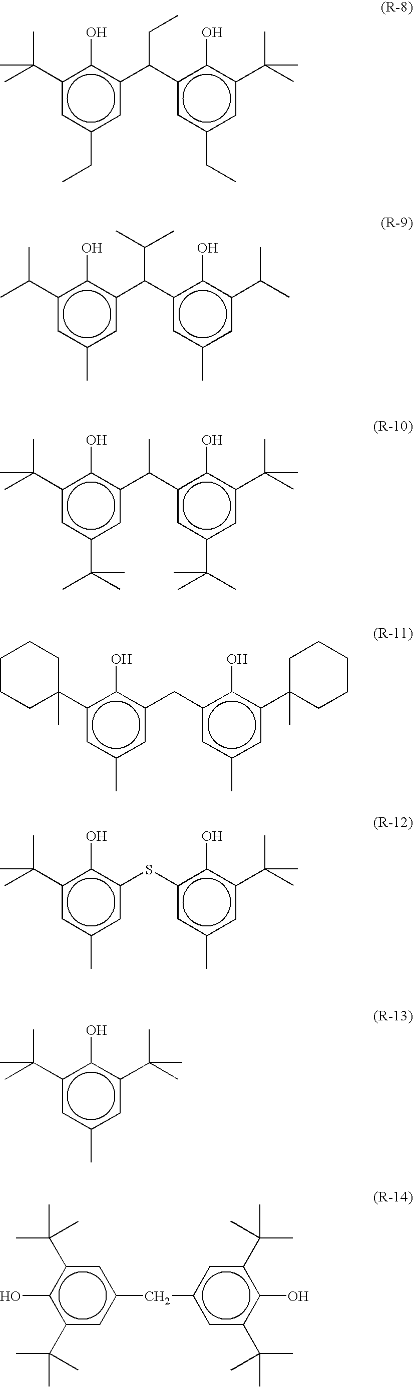

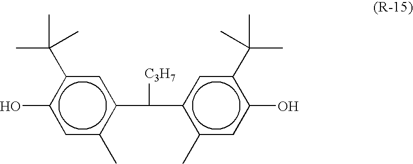

Other preferred examples of the reducing agent of the invention are described in JP-A Nos. 2001-188314, 2001-209145, 2001-350235 and 2002-156727.

In the invention, the reducing agent is preferably added in an amount of 0.1 to 3.0 g/m², more preferably 0.2 to 1.5 g/m², further preferably 0.3 to 1.0 g/m². The reducing agent is preferably included in an amount of 5 to 50 mol. % per 1 mole of silver on the surface having the image forming layer, more preferably 8 to 30 mol. %, and further preferably 10 to 20 mol. %. The reducing agent is preferably included in the image forming layer.

The reducing agent of the invention may be contained in the coating solution and in the photosensitive material by any method, for example in a state of a solution, an emulsified dispersion or a dispersion of fine solid particles.

A well known method for preparing an emulsified dispersion is executed by dissolution with an oil such as dibutyl phthalate, tricresyl phosphate, glyceryl triacetate or diethyl phthalate, or an auxiliary solvent such as ethyl acetate or cyclohexanone, followed by a mechanical preparation of an emulsified dispersion.

For dispersing solid particles, there can be employed a method of dispersing powder of a reducing agent in a suitable solvent such as water with a ball mill, a colloid mill, a vibrating ball mill, a sand mill, a jet mill, a roller mill or ultrasonic wave thereby obtaining a solid dispersion. In such method, there may be employed a protective colloid (such as polyvinyl alcohol) or a surfactant (for example an anionic surfactant such as sodium triisopropylnaphthalenesulfonate (a mixture of compounds with different substitution positions of three isopropyl groups). In the above-mentioned mills, beads such as of zirconia are usually employed as a dispersion medium, and the dispersion may be contaminated with zirconium, etc. dissolved out from such beads. Its content, though dependent on the dispersing conditions, is usually within a range of 1 to 1000 ppm. Such Zr can be tolerated practically as long as its content in the photosensitive material is 0.5 mg or less per 1 g of silver.

An aqueous dispersion of the reducing agent preferably includes an antiseptic (such as sodium benzothiazolinone).

A particularly preferred method is a method of dispersing fine solid particles of the reducing agent, and it is added in a state of fine particles having an average particle size of 0.01 to 10 μm, preferably 0.05 to 5 μm, more preferably 0.1 to 2 μm. In the invention, it is preferable that particles in other solid dispersions also have particle sizes within such range.

(Explanation of Development Accelerator)

In the following, a development accelerator to be employed in the invention will be explained.

As the development accelerator to be employed in the invention, there is preferred a hydrazine compound represented by the general formula (D) of JP-A No. 2002-156727, or a phenol or naphthol compound represented by the general formula (2) in JP-A No. 2001-264929.

In the invention, a particularly preferred development accelerator is compounds represented by the following general formulas (A-1) and (A-2).
Q₁-NHNH-Q₂ General formula (A-1)

In the formula, Q₁ represents an aromatic group or a heterocyclic group, wherein a carbon atom in Q₁ is bonded to —NHNH-Q₂; and Q₂ represents a carbamoyl group, an acyl group, an alkoxycarbonyl group, an aryloxycarbonyl group, a sulfonyl group or a sulfamoyl group.

In the general formula (A-1), the aromatic group or the heterocyclic group represented by Q₁ is preferably a 5- to 7-membered unsaturated ring. Preferred examples include a benzene ring, a pyridine ring, a pyrazine ring, a pyrimidine ring, a pyridazine ring, a 1,2,4-triazine ring, a 1,3,5-triazine ring, a pyrrole ring, an imidazole ring, a pyrazole ring, a 1,2,3-triazole ring, a 1,2,4-triazole ring, a tetrazole ring, a 1,3,4-thiadiazole ring, a 1,2,4-thiadiazole ring, a 1,2,5-thiadiazole ring, a 1,3,4-oxadiazole ring, a 1,2,4-oxadiazole ring, a 1,2,5-oxadiazole ring, a thiazole ring, an oxazole ring, an isothiazole ring, an isooxazole ring and a thiophene ring, and there is also preferred a condensed ring formed by mutual condensation of these rings.

These rings may have a substituent, and, in the case two or more substituents are present, such substituents may be mutually the same or different. Examples of the substituent include a halogen atom, an alkyl group, an aryl group, a carbonamide group, an alkylsulfonamide group, an arylsulfonamide group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group and an acyl group. In the case where such substituent can be substituted, the substituent may further have a substituent, and examples of preferred such substituent include a halogen atom, an alkyl group, an aryl group, a carbonamide group, an alkylsulfonamide group, an arylsulfonamide group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group and an acyloxy group.

A carbamoyl group represented by Q₂ preferably has 1 to 50 carbon atoms, more preferably 6 to 40 carbon atoms, and can be, for example, non-substituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl)carbamoyl, N-(2-chloro-5-dodecyloxylcarbonylphenyl)carbamoyl, N-naphthylcarbamoyl, N-3-pyridylcarbamoyl, or N-benzylcarbamoyl.

An acyl group represented by Q₂ preferably has 1 to 50 carbon atoms, more preferably 6 to 40 carbon atoms, and can be, for example, formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, or 2-hydroxymethylbenzoyl. An alkoxycarbonyl group represented by Q₂ preferably has 2 to 50 carbon atoms, more preferably 6 to 40 carbon atoms, and can be, for example, methoxycarbonyl, ethoxycarbonyl, isobutyloxycarbonyl, cyclohexyloxycarbonyl, dodecyloxycarbonyl or benzyloxycarbonyl.

An aryloxycarbonyl group represented by Q₂ preferably has 7 to 50 carbon atoms, more preferably 7 to 40 carbon atoms, and can be, for example, phenoxycarbonyl, 4-octyloxyphenoxycarbonyl, 2-hydroxymethylphenoxycarbonyl, or 4-dodecyloxyphenoxycarbonyl. A sulfonyl group represented by Q₂ preferably has 1 to 50 carbon atoms, more preferably 6 to 40 carbon atoms, and can be, for example, methylsulfonyl, butylsulfonyl, octylsulfonyl, 2-hexadecylsulfonyl, 3-dodecyloxypropylsulfonyl, 2-octyloxy-5-tert-octylphenylsulfonyl or 4-dodecyloxyphenylsulfonyl.

A sulfamoyl group represented by Q₂ preferably has 0 to 50 carbon atoms, more preferably 6 to 40 carbon atoms, and can be, for example, non-substituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, or N-(2-tetradecyloxyphenyl)sulfamoyl. A group represented by Q₂ may further have, on a substitutable position, a group cited before as a substituent group for a 5- to 7-membered unsaturated ring represented by Q₁, and, in the case where two or more substituents are present, they may be mutually the same or different.

In the following there will be explained a preferred range of the compound represented by the formula (A-1). For Q₁, there is preferred a 5- or 6-membered unsaturated ring, and more preferred is a benzene ring, a pyrimidine ring, a 1,2,3-triazole ring, a 1,2,4-triazole ring, a tetrazole ring, a 1,3,4-thiadiazole ring, a 1,2,4-thiadiazole ring, a 1,3,4-oxadiazole ring, a 1,2,4-oxadiazole ring, a thiazole ring, an oxazole ring, an isothiazole ring, an isooxazole ring or a ring formed by a condensation of the foregoing ring with a benzene ring or an unsaturated hetero ring. Also for Q₂, there is preferred a carbamoyl group, more preferably a carbamoyl group having a hydrogen atom on a nitrogen atom.

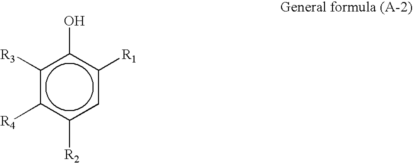

In the general formula (A-2), R₁ represents an alkyl group, an acyl group, an acylamino group, a sulfonamide group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group or a carbonate ester group. R₃ and R₄ each independently represent a group that is cited, in the explanation of the general formula (A-1), as an example of the group that can substitute the benzen ring. R₃ and R₄ may be mutually bonded to form a condensed ring.

R₁ is preferably an alkyl group with 1 to 20 carbon atoms (such as a methyl group, an ethyl group, an isopropyl group, a butyl group, a tert-octyl group, or a cyclohexyl group), an acylamino group (such as an acetylamino group, a benzoylamino group, a methylureide group or a 4-cyanophenylureide group), or a carbamoyl group (such as an n-butylcarbamoyl group, an N,N-diethylcarbamoyl group, a phenylcarbamoyl group, 2-chlorophenylcarbamoyl group, or a 2,4-dichlorophenylcarbamoyl group), and more preferably an acylamino group (including an ureide group and an urethane group). R₂ is preferably a halogen atom (more preferably a chlorine atom or a bromine atom), an alkoxy group (such as a methoxy group, a butoxy group, an n-hexyloxy group, an n-decyloxy group, a cyclohexyloxy group, or a benzyloxy group), or an aryloxy group (such as a phenoxy group or a naphthoxy group).

R₃ is preferably a hydrogen atom, a halogen atom or an alkyl group with 1 to 20 carbon atoms, and a halogen atom is most preferred. R₄ is preferably a hydrogen atom, an alkyl group, or an acylamino group, and an alkyl group or an acylamino group is more preferred. Preferred examples of such substituent are similar to those for R₁. In the case R₄ is an acylamino group, it is also preferred that R₄ is bonded to R₃ to form a carbostyryl ring.

In the general formula (A-2), in the case R₃ and R₄ are mutually bonded to form a condensed ring, a naphthalene ring is particularly preferred as such condensed ring. The naphthalene ring may have a substituent which is cited as an example of the substituent in the explanation of the general formula (A-1). In the case the general formula (A-2) represents a naphthol compound, R₁ is preferably a carbamoyl group, and particularly preferably a benzoyl group. R₂ is preferably an alkoxy group or an aryloxy group, particularly preferably an alkoxy group.

In the following, specific preferred examples of the development accelerator of the invention are shown, but the invention is not limited to such examples.

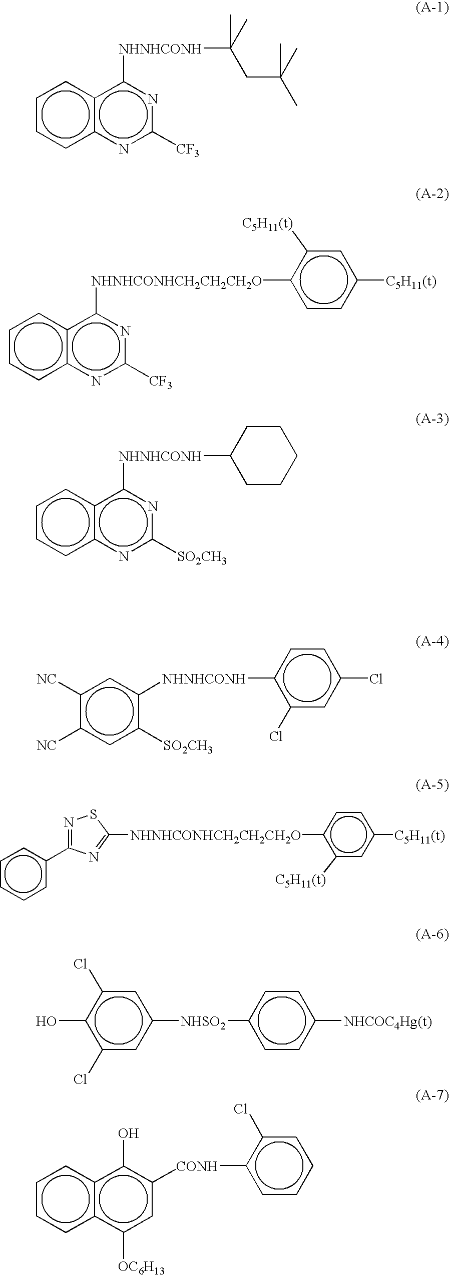

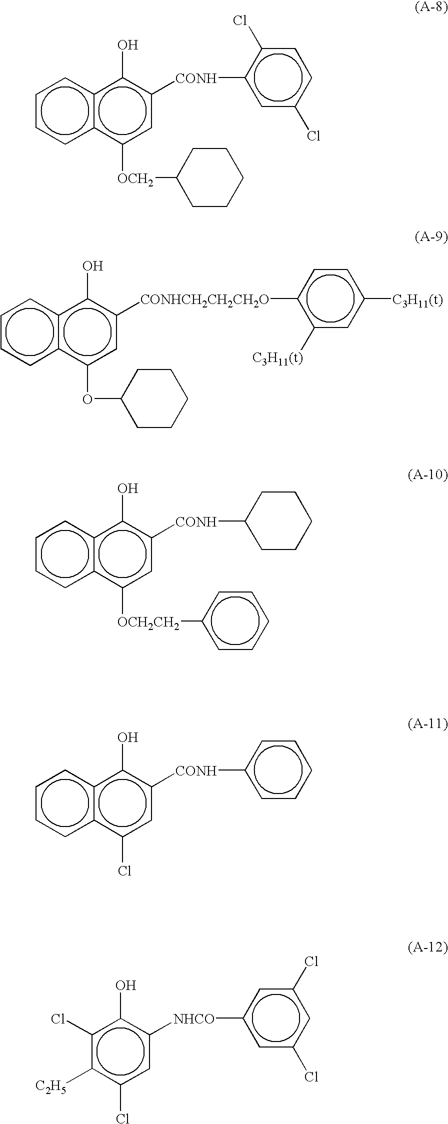

Such development accelerator is used within a range of 0.1 to 20 mol. % with respect to the reducing agent, preferably 0.5 to 10 mol. % and more preferably 1 to 5 mol. %. The development accelerator can be introduced into the photosensitive material by a method similar to that employed for introducing the reducing agent, and it is particularly preferably added as a solid dispersion or an emulsified dispersion. In the case of addition as an emulsified dispersion, the development accelerator is preferably added in a form of an emulsified dispersion prepared with a high-boiling solvent which is solid at normal temperature and a low-boiling auxiliary solvent, or in a form of so-called oilless emulsified dispersion without utilizing the high-boiling solvent.

In the invention, there can be preferably employed, as a development accelerator, a sulfonamidephenol compound represented by the general formula (A) in JP-A Nos. 2000-267222 and 2000-330234, a hindered phenol compound represented by the general formula (II) in JP-A No. 2001-92075, a hydrazine compound represented by the general formula (I) in JP-A Nos. 10-62895 and 11-15116, a hydrazine compound represented by the general formula (D) in JP-A No. 2002-156727, a hydrazine compound represented by the general formula (1) in JP-A No. 2002-278017, or a phenol or naphthol compound represented by the general formula (2) in JP-A No. 2001-264929.

(Explanation of Hydrogen Bonding Compound)

In the invention, in the case where the reducing agent has an aromatic hydroxyl group (—OH) or an amino group (—NHR in which R is a hydrogen atom or an alkyl group), particularly in the case where the reducing agent is an aforementioned bisphenol, it is preferred to also use a non-reducible compound having a group capable of forming a hydrogen bond with such group.

A group capable of forming a hydrogen bond with a hydroxyl group or an amino group can be, for example, a phosphoryl group, a sulfoxide group, a sulfonyl group, a carbonyl group, an amide group, an ester group, an urethane group, an ureide group, a tertiary amino group or a nitrogen-containing aromatic group. Among these preferred is a compound having a phosphoryl group, a sulfoxide group, an amide group (however not including >N—H but blocked as in >N—Ra (Ra being a substituent other than H)), an urethane group (however not including >N—H but blocked as in >N—Ra (Ra being a substituent other than H)), or an ureide group (however not including >N—H but blocked as in >N—Ra (Ra being a substituent other than H)).

In the invention, a particularly preferred hydrogen bonding compound is represented by the following general formula (D):

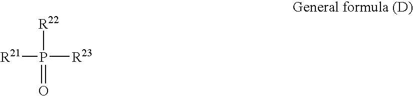

In the general formula (D), R²¹ to R²³ each independently represent an alkyl group, an aryl group, an alkoxy group, an aryloxy group, an amino group or a heterocyclic group, which may be non-substituted or may have a substituent.

In the case where any of R²¹ to R²³ has a substituent, such substituent can be a halogen atom, an alkyl group, an aryl group, an alkoxy group, an amino group, an acyl group, an acylamino group, an alkylthio group, an arylthio group, a sulfonamide group, an acyloxy group, an oxycarbonyl group, a carbamoyl group, a sulfamoyl group, a sulfonyl group or a phosphoryl group, among which preferred is an alkyl group or an aryl group such as a methyl group, an ethyl group, an isopropyl group, a t-butyl group, a t-octyl group, a phenyl group, a 4-alkoxyphenyl group or a 4-acyloxylphenyl group.

Specific examples of an alkyl group represented by any of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenetyl group, and a 2-phenoxypropyl group.

Specific examples of the aryl group represented by any of R²¹ to R²³ include a phenyl group, a cresyl group, a xylyl group, a naphthyl group, a 4-t-butylphenyl group, a 4-t-octylphenyl group, a 4-anisidyl group and a 3,5-dichlorophenyl group.

Specific examples of the alkoxy group represented by any of R²¹ to R²³ include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group and a benzyloxy group.

Specific examples of the aryloxy group represented by any of R²¹ to R²³ include a phenoxy group, a cresyloxy group, an isopropylphenoxy group, a 4-t-butylphenoxy group, a naphthoxy group and a biphenyloxy group.

Specific examples of the amino group represented by any of R²¹ to R²³ include a dimethylamino group, a diethylamino group, a dibutylamino group, a dioctylamino group, an N-methyl-N-hexylamino group, a dicyclohexylamino group, a diphenylamino group and an N-methyl-N-phenylamino group.

Each of R²¹ to R²³ is preferably an alkyl group, an aryl group, an alkoxy group, or an aryloxy group. For the effect of the invention, it is preferred that at least one of R²¹ to R²³ is an alkyl group or an aryl group, and more preferred that at least two of R²¹ to R²³ are each independently an alkyl group or an aryl group. It is also preferred that R²¹ to R²³ represent the same group, in consideration of inexpensive availability.

In the following, specific examples of the hydrogen bonding compound of the invention, including the compound of the general formula (D), are shown, but the invention is not limited to such examples.

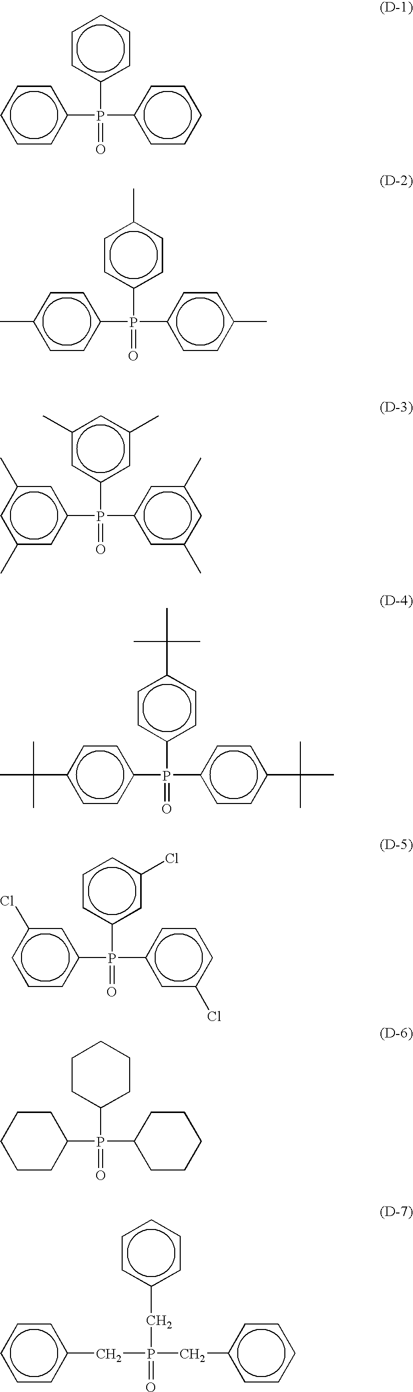

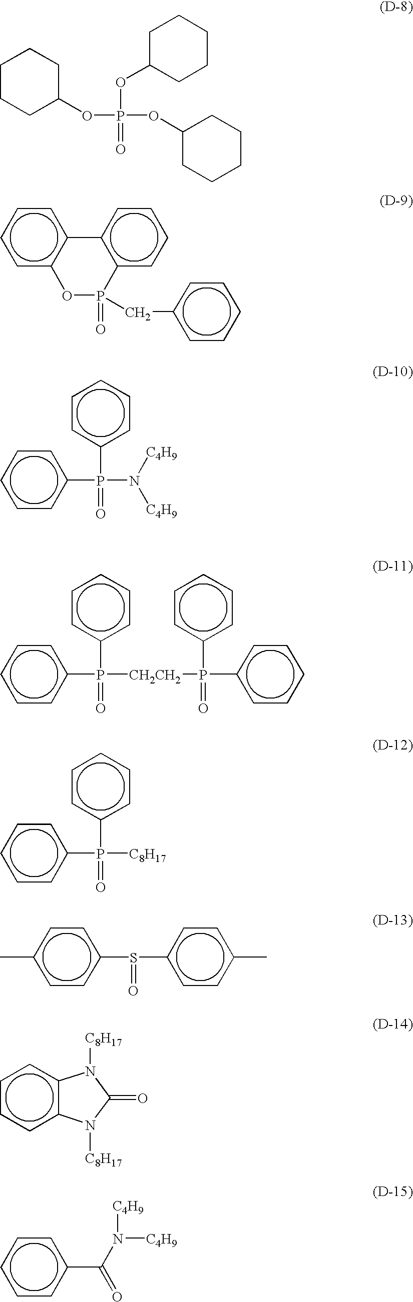

Specific examples of the hydrogen bonding compound, other than the above compounds, are described in European Patent No. 1096310, JP-A Nos. 2002-156727 and 2002-318431.

The compound of the general formula (D) of the invention, like the reducing agent, may be contained in the coating solution and used in the photosensitive material for example in a form of a solution, an emulsified dispersion or a dispersion of fine solid particles, however is preferably used as a solid dispersion. The compound of the invention forms, in a solution state, a complex, by hydrogen bonding, with a compound having a phenolic hydroxyl group or an amino group, and the complex may be isolated in a crystalline state depending on a combination of the reducing agent and the compound of the general formula (D).

It is particularly preferable, for obtaining a stable performance, to use thus isolated crystalline powder in a form of dispersion of fine solid particles. There is also preferably employed a method of mixing the reducing agent and the compound of the general formula (D) of the invention in a powder state, and forming a complex at the dispersion by using a sand grinder mill or the like with a suitable dispersant.

The compound of the general formula (D) of the invention can be employed preferably within a range 1 to 200 mol. % with respect to the reducing agent, more preferably within a range of 10 to 150 mol. % and further preferably 20 to 100 mol. %.

(Explanation of Silver Halide)

1) Halogen Composition

A photosensitive silver halide to be employed in the present invention is not particularly limited in a halogen composition, and can be silver chloride, silver chlorobromide, silver bromide, silver iodobromide, silver iodochlorobromide or silver iodide, among which preferred are silver bromide, silver iodobromide and silver iodide. A halogen composition within a grain may be uniform, or show a stepwise change or a continuous change. There may also be preferably employed a silver halide grain having a core/shell structure. There is preferred a core/shell grain with a 2- to 5-layered structure, more preferably 2- to 4-layered structure. There can also be advantageously employed a method of localizing silver bromide or silver iodide on a surface of grains of silver chloride, silver bromide or silver chlorobromide.

2) Grain Forming Method

A method for forming photosensitive silver halide grains is well known in the art, and there can be utilized, for example, methods described in Research Disclosure 17029, June 1978 and U.S. Pat. No. 3,700,458. More specifically, there is employed a method of adding a silver supplying compound and a halogen supplying compound to a solution of gelatin or other polymer thereby preparing a photosensitive silver halide, and thereafter mixing the solution with an organic silver salt. There are also preferably employed a method described in JP-A No. 11-119374, paragraphs 0217 to 0224, and methods described in JP-A Nos. 11-352627 and 2000-347335.

3) Grain Size

A grain size of the photosensitive silver halide is preferably made smaller in order to suppress a turbidity after image formation, and is specifically 0.20 μm or less, more preferably from 0.01 to 0.15 μm and further preferably 0.02 to 0.12 μm. In the invention, the grain size means a diameter of a circle, when a projected area of the silver halide grain (a projected area of a principal plane in the case of a flat plate-shaped grain) is converted into a circle having the same area.

4) Grain Shape

Silver halide grains can assume a cubic shape, an octahedral shape, a flat plate shape, a spherical shape, a rod shape, a potato-like shape, etc., but cubic grains are particularly preferred in the invention. There can also be advantageously employed grains whose corners are rounded. The photosensitive silver halide grains are not particularly restricted in plane index (Miller's index) of an external surface, but it is preferred that a [100] plane, showing a high spectral sensitization efficiency upon an adsorption of a spectral sensitizing dye, has a high proportion. Such proportion is preferably 50% or higher, more preferably 65% or higher and further preferably 80% or higher. The proporiton of the plane having Miller's index of [100] can be determined by a method described in T. Tani; J. Imaging Sci., 29, 165 (1985), utilizing adsorption dependences of [111] and [100] planes in the adsorption of sensitizing dye.

5) Heavy Metal

The photosensitive silver halide grains of the invention may include a metal or a metal complex of groups 8 to 10 of the periodic table (having groups 1 to 18). A metal or a central metal of a metal complex belonging to the groups 8 to 10 of the periodic table is preferably rhodium, ruthenium or iridium. Such metal complex may be used singly, or in a combination of two or more complexes of a same metal or different metals. A preferred content is within a range of 1×10⁻⁹ to 1×10⁻³ moles per 1 mole of silver. Such heavy metals, complexes thereof and method of addition thereof are described in JP-A Nos. 7-225449, 11-65021, paragraphs 0018 to 0024, and 11-119374, paragraphs 0227 to 0240.

In the invention, there are preferred silver halide grains in which a hexacyano metal complex is present at the outermost surface of the grains. Examples of the hexacyano metal complex include [Fe(CN)₆]⁴⁻, [Fe(CN)₆]³⁻, [Ru(CN)₆]⁴⁻, [Os(CN)₆]⁻, [Co(CN)₆]³⁻, [Rh(CN)₆]³⁻, [Ir(CN)₆]³⁻, [Cr(CN)₆]³⁻, and [Re(CN)₆]³⁻. In the invention, a hexacyano Fe complex is preferred.

A counter cation is not important since the hexacyano metal complex is present in a state of an ion in an aqueous solution, but it is preferable to employ an ion that is easily miscible with water and is adapted to a precipitating operation of silver halide emulsion. For example, the counter cation can be an alkali metal ion such as sodium ion, potassium ion, rubidium ion, cesium ion or lithium ion, an ammonium ion or an alkylammonium ion (such as tetramethylammonium ion, tetraethylammonium ion, tetrapropylammonium ion or tetra(n-butyl)ammonium ion).

The hexacyano metal complex can be added after mixed with water, or with a mixed solvent of water and a suitable water-miscible organic solvent (for example an alcohol, an ether, a glycol, a ketone, an ester or an amide), or with gelatin.

An amount of hexacyano metal complex to be added is preferably 1×10⁻⁵ to 1×10⁻² moles per 1 mole of silver, more preferably 1×10⁻⁴ to 1×10⁻³ moles.

In order to cause the hexacyano metal complex to be present on the outermost surface of silver halide grains, the hexacyano metal complex is directly added within a period from the end of an addition of aqueous silver nitrate solution for grain formation to the starting of a chemical sensitization step for a sulfur sensitization, a chalcogen sensitization such as selenium sensitization or tellurium sensitization, or a precious metal sensitization such as gold sensitization, namely before the end of a charging step, during a rinsing step or a dispersing step, or before a chemical sensitization step. In order not to cause a growth of the silver halide fine grains, it is preferred to add the hexacyano metal complex promptly after the grain formation, thus to execute the addition before the end of the charging step.

The addition of the hexacyano metal complex may be started after 96 mass % of the total silver nitrate for grain formation is added, preferably after 98 mass % and particularly preferably after 99 mass %.

Such hexacyano metal complex, in the case of addition after the addition of aqueous silver nitrate solution but immediately before the completion of grain formation, can be adsorbed on the outermost surface of silver halide grains, and mostly forms a slightly-soluble salt with silver ions on the surface of the grains. Such silver salt of hexacyano ferrate (II), being less soluble than AgI, can avoid re-dissolution of fine grains, thereby enabling to produce fine silver halide grains of a smaller grain size.

Also metal atoms (for example [Fe(CN)₆]⁴⁻) that can be included in the silver halide grains to be employed in the invention, a desalting method and a chemical sensitizing method of the silver halide emulsion are described in JP-A Nos. 11-84574, paragraphs 0046-0050, 11-65021, paragraphs 0025-0031, and 11-119374, paragraphs 0242-0250.

6) Gelatin

Various gelatins can be used as gelatin contained in the photosensitive silver halide emulsion to be employed in the invention. It is necessary to maintain a satisfactory dispersion state of the photosensitive silver halide emulsion in a coating solution containing an organic silver salt, and it is preferable to use gelatin having a molecular weight of 10,000 to 1,000,000. It is also preferred to subject substituents of gelatin to phthalating processing. Such gelatin may be used at grain formation or at dispersion after desalting process, however it is preferably used at the grain formation.

7) Sensitizing Dye

For use in the invention, there can be advantageously selected a sensitizing dye that can spectrally sensitize the silver halide grains in a desired wavelength region upon adsorption on the silver halide grains and has a spectral sensitivity matching the spectral characteristics of an exposure light source. Examples of sensitizing dye and a method of addition thereof are described, for example, in JP-A No. 11-65021, paragraphs 0103-0109, a compound represented by the general formula (II) in JP-A No. 10-186572, a dye represented by the general formula (I) and a description of a paragraph 0106 in JP-A No. 11-119374, a description in U.S. Pat. No. 5,510,236, a dye described in the example 5 of U.S. Pat. No. 3,871,887, dyes disclosed in JP-A Nos. 2-96131 and 59-48753, and descriptions in EP-A No. 0803764A1, page 19, line 38 to page 20, line 35, and JP-A Nos. 2001-272747, 2001-290238 and 2002-23306. These sensitizing dyes may be used singly or in combination of two or more kinds. In the invention, the sensitizing dye is added to the silver halide emulsion preferably in a period from the end of a desalting process to a coating, and more preferably in a period from the end of the desalting process to the end of a chemical ripening process.

An amount of the sensitizing dye to be added in the invention can be selected according to the desired sensitivity or the desired fog level, however it is preferably within a range of 10⁻⁶ to 1 mole per 1 mole of photosensitive silver halide in the photosensitive layer, preferably 10⁻⁴ to 10⁻¹ moles.

In the invention, in order to improve the spectral sensitizing efficiency, there may be employed a super-sensitizer. Examples of the super-sensitizer employable in the invention include compounds described in EP-A No. 587,338, U.S. Pat. Nos. 3,877,943 and 4,873,184 and JP-A Nos. 5-341432, 11-109547 and 10-111543.

8) Chemical Sensitization

The photosensitive silver halide grains to be employed in the invention are preferably chemically sensitized by a sulfur sensitizing method, a selenium sensitizing method or a tellurium sensitizing method. For the sulfur sensitization, the selenium sensitization and the tellurium sensitization, a known compound can be advantageously employed such as one described in JP-A No. 7-128768. In the invention, the tellurium sensitization is preferable, and a compound described in JP-A No. 11-65021, paragraph 0030 and compounds represented by general formulas (II), (III) and (IV) in JP-A No. 5-313284 are more preferable.

The photosensitive silver halide grains of the invention are preferably chemically sensitized by a gold sensitization method either in combination with the aforementioned chalcogen sensitization or singly. A gold sensitizer with monovalent or trivalent gold is preferable, and is preferably an ordinarily employed gold sensitizer. Representative examples include chloroauric acid, bromoauric acid, potassium chloroaurate, potassium bromoaurate, auric trichloride, potassium auricthiocyanate, potassium iodoaurate, tetracyanoauric acid, ammonium aurothiocyanate, and pyridyl trichlorogold. In addition, there may also be advantageously employed gold sensitizers described in U.S. Pat. No. 5,858,637 and JP-A No. 2002-278016.

In the invention, the chemical sensitization may be executed any time after grain formation and before coating, and can be executed after desalting, and (1) before spectral sensitization, (2) simultaneous with spectral sensitization, (3) after spectral sensitization, or (4) immediately before coating.

An amount of the sulfur, selenium or tellurium sensitizer employed in the invention varies depending on the silver halide grains to be used and chemical ripening conditions, but is within a range of 10⁻⁸ to 10⁻² moles per 1 mole of silver halide, preferably 10⁻⁷ to 10⁻³ moles.

An amount of the gold sensitizer varies depending on various conditions, however it is generally within a range of 10⁻⁷ to 10⁻³ moles per 1 mole of silver halide, preferably 10⁻⁶ to 5×10⁻⁴ moles.

The chemical sensitization in the invention is not particularly restricted in conditions, but there are generally selected a pH of 5 to 8, a pAg value of 6 to 11 and a temperature of 40 to 95° C.

In the silver halide emulsion to be employed in the invention, a thiosulfonic acid compound may be added by a method described in EP-A No. 293,917.

In the photosensitive silver halide grains of the invention, a reducing agent can be preferably employed. As a specific compound for the reduction sensitization, there is preferred ascorbic acid or thiourea dioxide, and there may also be advantageously employed stannous chloride, aminoiminomethane sulfinic acid, a hydrazine derivative, a borane compound, a silane compound, or a polyamine compound. The reduction sensitizer may be added in any step in the photosensitive emulsion preparing process from a grain growing step to a preparation step immediate before coating. It is also preferred to execute the reduction sensitization by ripening the emulsion at a pH value of 7 or higher or at a pAg value of 8.3 or lower, or by introducing a single addition part of silver ions in the course of grain formation.

9) Compound Whose a 1-Electron Oxidized Form, Formed by a 1-Electron Oxidation, is Capable of Releasing 1 or More Electrons.

The photothermographic material of the invention preferably includes a compound whose a 1-electron oxidized form, formed by a 1-electron oxidation, is capable of releasing 1 or more electrons.

Such compound is employed either singly or in combination with various aforementioned chemical sensitizers and can provide an increase in the sensitivity of silver halide.

The compound whose a 1-electron oxidized form, formed by a 1-electron oxidation, is capable of releasing 1 or more electrons, to be included in the photothermographic material of the invention is a compound selected from the following types 1 to 5.

(Type 1)

A compound whose a 1-electron oxidized form, formed by a 1-electron oxidation, is capable of causing an ensuing bond cleaving reaction thereby further releasing two or more electrons.

(Type 2)

A compound whose a 1-electron oxidized form, formed by a 1-electron oxidation, is capable of causing an ensuing bond cleaving reaction thereby further releasing an electron, and which has, within a same molecule, two or more groups adsorbable to the silver halide.

(Type 3)

A compound whose a 1-electron oxidized form, formed by a 1-electron oxidation, is capable, after an ensuing bond forming process, of further releasing one or more electrons.

(Type 4)

A compound whose a 1-electron oxidized form, formed by a 1-electron oxidation, is capable, after an ensuing intramolecular ring-opening reaction, of further releasing one or more electrons.

(Type 5)

A compound represented by X-Y in which X represents a reducing group while Y is a releasable group, and a 1-electron oxidized form, formed by a 1-electron oxidation of the reducing group represented by X, causes an ensuing X-Y bond cleaving reaction to release Y and to form an X radical, thereby further releasing therefrom one electron.

Among the aforementioned compounds of types 1 and 3 to 5, either “a compound having, in the molecule, a group adsorbable to silver halide” or “a compound having, in the molecule, a partial structure of a spectral sensitizing dye” is preferable, and “a compound having, in the molecule, a group adsorbable to silver halide” is more preferable. The compounds of the types 1 to 4 are more preferably “a compound having, as an adsorbable group, a nitrogen-containing heterocyclic group substituted by two or more mercapto groups”.

In the following, a detailed explanation will be given on the compounds of the types 1 to 5.

In the compound of the type 1, “a bond-cleaving reaction” specifically means a cleaving of a carbon-carbon, carbon-silicon, carbon-hydrogen, carbon-boron, carbon-tin or carbon-germanium bond, and a cleaving of a carbon-hydrogen bond may further be involved. The compound of the type 1 can undergo a bond cleaving reaction thereby further releasing two or more (preferably three or more) electrons, only after the compound of the type 1 is subjected to a 1-electron oxidation thereby forming a 1-electron oxidized form.

Among the compounds of the type 1, preferred compounds are represented by the general formula (A), (B), (1), (2) and (3).

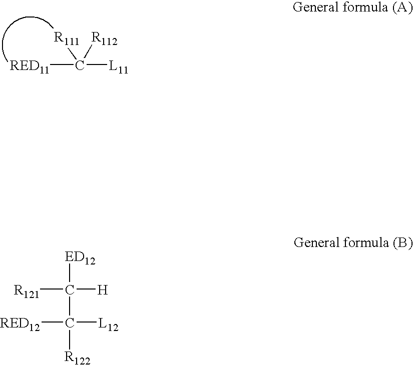

In the general formula (A), RED₁₁ represents a reducing group that can be subjected to a 1-electron oxidation; L₁₁ represents a leaving group; R₁₁₂ represents a hydrogen atom or a substituent; and R₁₁₁, represents a non-metal atomic group capable of forming, together with a carbon atom (C) and RED₁₁, a ring structure corresponding to a tetrahydro form, a hexahydro form or an octahydro form of a 5- or 6-membered aromatic ring (including an aromatic hetero ring).

In the general formula (B), RED₁₂ represents a reducing group that can be subjected to a 1-electron oxidation; L₁₂ represents a leaving group; R₁₂₁ and R₁₂₂ each independently represent a hydrogen atom or a substituent; and ED₁₂ represents an electron donating group. In the general formula (B), R₁₂₁ and RED₁₂, R₁₂₁ and R₁₂₂, or ED₁₂ and RED₁₂ may be mutually bonded to form a ring structure.

The compound represented by the general formula (A) or the general formula (B) is capable, after the reducing group represented by RED₁₁ or RED₁₂ is subjected to a 1-electron oxidation, of spontaneously releasing L₁₁ or L₁₂ by a bond cleaving reaction, thereby releasing further two or more, preferably three or more, electrons.

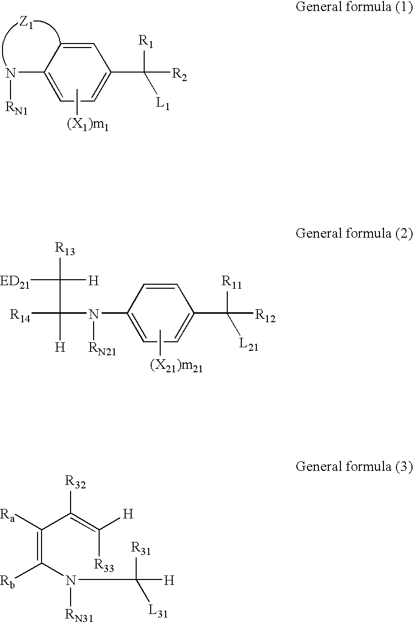

In the general formula (1), Z₁ represents an atomic group capable of forming a 6-membered ring together with a nitrogen atom and two carbon atoms of the benzene ring; R₁, R₂ and R_{N1} each independently represent a hydrogen atom or a substituent; X₁ represents a substituent that can substitute the benzene ring; m₁ represents an integer from 0 to 3; and L₁ represents a leaving group. In the general formula (2), ED₂₁, represents an electron donating group; R₁₁, R₁₂, R_{N21}, R₁₃ and R₁₄ each independently represent a hydrogen atom or a substituent; X₂₁ represents a substituent that can substitute the benzene ring; m₂₁ represents an integer from 0 to 3; and L₂, represents a leaving group. R_{N21}, R₁₃, R₁₄, X₂₁ and ED₂₁ may be mutually bonded to form a ring structure. In the general formula (3), R₃₂, R₃₃, R₃₁, R_{N31}, Rₐ and R_{b} each independently represent a hydrogen atom or a substituent; and L₃, represents a leaving group. However, in the case where R_{N31} represents a group other than an aryl group, Rₐ and R_{b} are mutually bonded to form an aromatic ring.

These compounds are capable, after being subjected to a 1-electron oxidation, of spontaneously releasing L₁, L₂₁ or L₃₁ by a bond cleaving reaction, thereby releasing further two or more, preferably three or more, electrons.

In the following, the compound represented by the general formula (A) will be explained in detail.

In the general formula (A), the reducing group represented by RED₁₁ that can be subjected to a 1-electron oxidation is a group capable of forming a specific ring by bonding to R₁₁₁ to be explained later, and can more specifically be a divalent group formed by eliminating a hydrogen atom, at a position suitable for ring formation, from a following monovalent group: an alkylamino group, an arylamino group (such as an anilino group and a naphthylamino group), a heterocyclic amino group (such as a benzothiazolylamino group and a pyrolylamino group), an alkylthio group, an arylthio group (such as a phenylthio group), a heterocyclic thio group, an alkoxy group, an arylxoy group (such as a phenoxy group), a heterocyclic oxy group, an aryl group (such as a phenyl group, a naphthyl group and an anthranyl group), or an aromatic or non-aromatic heterocyclic group (a 5- to 7-membered single-ringed or condensed-ringed heterocyclic group containing at least one hetero atom selected from the group consisting of a nitrogen atom, a sulfur atom, an oxygen atom and a selenium atom, such as a tetrahydroquinoline ring, a tetrahydroisoquinoline ring, tetrahydroquinoxaline ring, a tetrahydroquinazoline ring, an indoline ring, an indole ring, an indazole ring, a carbazole ring, a phenoxadine ring, a phenothiazine ring, a benzothiazoline ring, a pyrrole ring, an imidazole ring, a thiazoline ring, a piperidine ring, a pyrrolidine ring, a morpholine ring, a benzoimidazole ring, a benzoimidazoline ring, a benzoxazoline ring and a methylenedioxyphenyl ring) (hereinafter RED₁₁ being represented by a name of a monovalent group for the purpose of convenience). The RED₁₁ may also have a substituent.

In the invention, a substituent means one selected from the following groups, unless otherwise specified: a halogen atom, an alkyl group (including an araylkyl group, a cycloalkyl group, an active methine group, etc.), an alkenyl group, an alkinyl group, an aryl group, a heterocyclic group (substituting position is arbitrary), a heterocyclic group containing a quaternary nitrogen atom (such as pyridinio group, imidazolio group, quinolinio group or isoquinolinio group), an acyl group, an alkoxycarbonyl group, an aryloxycarbonyl group, carbamoyl group, carboxyl group or a salt thereof, sulfonylcarbamoyl group, an acylcarbamoyl group, sulfamoylcarbamoyl group, carbazoyl group, oxalyl group, oxamoyl group, cyano group, a carbonimidoyl group, thiocarbamoyl group, hydroxy group, an alkoxy group (including a group containing repeating ethyleneoxy units or repeating propyleneoxy units), an aryloxy group, a heterocyclic oxy group, an acyloxy group, an (alkoxy or aryloxy)carbonyloxy group, a carbamoyloxy group, a sulfonyloxy group, amino group, an (alkyl, aryl or heterocyclic)amino group, an acylamino group, a sulfonamide group, ureido group, thioureido group, an imide group, an (alkoxy or aryloxy)carbonylamino group, sulfamoylamino group, semicarbazide group, thiosemicarbazide group, hydrazino group, ammonio group, oxamoylamino group, an (alkyl or aryl)sulfonylureido group, an acylureido group, an acylsulfamoylamino group, nitro group, mercapto group, an (alkyl, aryl or heterocyclic)thio group, an (alkyl or aryl)sulfonyl group, an (alkyl or aryl)sulfinyl group, sulfo group or a salt thereof, sulfamoyl group, an acylsulfamoyl group, sulfonylsulfamoyl group or a salt thereof, and a group including a phosphoric acid amide or a phosphoric acid ester structure. Such substituent may be further substituted by (a) substituent(s) selected from these substituents.

RED₁₁ is preferably an alkylamino group, an arylamino group, a heterocyclic amino group, an aryl group, or an aromatic or non-aromatic heterocyclic group, and more preferably an arylamino group (particularly anilino group) or an aryl group (particularly phenyl group). In the case such group has a substituent, the substituent is preferably a halogen atom, an alkyl group, an alkoxy group, carbamoyl group, sulfamoyl group, an acylamino group or a sulfonamide group.

However, in the case RED₁₁ represents an aryl group, the aryl group preferably includes at least an “electron donating group”. The “electron donating group” means a hydroxyl group, an alkoxy group, a mercapto group, a sulfonamide group, an acylamino group, an alkylamino group, an arylamino group, a heterocyclic amino group, an active methine group, a 5-membered single-ringed or condensed-ringed electron-excessive aromatic heterocyclic group containing at least one nitrogen atom in the ring (such as indolyl group, pyrrolyl group, imidazolyl group, benzimidazolyl group, thiazolyl group, benzothiazolyl group, or indazolyl group), or non-aromatic nitrogen-containing heterocyclic group substituted at a nitrogen atom (such as pyrrolidinyl group, indolinyl group, piperidinyl group, piperadinyl group or morpholino group which may also be called a cyclic amino group). An active methine group means a methine group substituted by two “electron attracting groups”, wherein “electron attracting group” used here means an acyl group, an alkoxycarbonyl group, an aryloxycarbonyl group, carbamoyl group, an alkylsulfonyl group, an arylsulfonyl group, sulfamoyl group, trifluoromethyl group, cyano group, nitro group or a carbonimidoyl group. The two electron attracting groups may be mutually bonded to form a ring structure.

In the general formula (A), L₁₁ specifically represents carboxy group or a salt thereof, a silyl group, a hydrogen atom, a triarylboron anion, a trialkylstannyl group, a trialkylgermyl group or —CR_{C1}R_{C2}R_{C3}. The silyl group specifically represents a trialkylsilyl group, an aryldialkylsilyl group, a triarylsilyl group, etc. and may have an arbitrary substituent.

In the case where L₁₁ represents a salt of carboxy group, the counter ion constituting the salt can be, for example, an alkali metal ion, an alkali earth metal ion, a heavy metal ion, ammonium ion, or phosphonium ion, preferably is an alkali metal ion or ammonium ion and most preferably an alkali metal ion (particularly Li⁺, Na⁺ or K⁺ ion).

In the case where L₁₁ represents —CR_{C1}R_{C2}R_{C3}, R_{C1}, R_{C2} and R_{C3} each independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or hydroxyl group, which may be mutually bonded to form a ring structure and may have an arbitrary substituent. However, in the case where one of R_{C1}, R_{C2} and R_{C3} represents a hydrogen atom or an alkyl group, the remaining two neither represent a hydrogen atom nor an alkyl group. Preferably, R_{C1}, R_{C2} and R_{C3} each independently represent an alkyl group, an aryl group (particularly phenyl group), an alkylthio group, an arylthio group, an alkylamino group, an arylamino group, a heterocyclic group, an alkoxy group, or a hydroxy group. Specific examples of R_{C1}, R_{C2} and R_{C3} include phenyl group, p-dimethylaminophenyl group, p-methoxyphenyl group, 2,4-dimethoxyphenyl group, p-hydroxyphenyl group, methylthio group, phenylthio group, phenoxy group, methoxy group, ethoxy group, dimethylamino group, N-methylanilino group, diphenylamino group, morpholino group, thiomorpholino group and hydroxy group. Also examples of a ring structure formed by mutual bonding of these groups include 1,3-dithiolan-2-yl group, 1,3-dithian-2-yl group, N-methyl-1,3-thiazolidin-2-yl group and N-benzyl-benzothiazolidin-2-yl group.

There is also preferred a case where, as a result of selection of R_{C1}, R_{C2} and R_{C3} within the aforementioned ranges, —CR_{C1}R_{C2}R_{C3} represents the same group as a residue obtained by eliminating L₁₁ from the general formula (A).

In the general formula (A), L₁₁ preferably represents a carboxy group or a salt thereof, or a hydrogen atom, more preferably a carboxy group or a salt thereof.

In the case L₁₁ represents a hydrogen atom, the compound represented by the general formula (A) preferably has a base portion within the molecule. An action of such base portion causes, after an oxidation of the compound represented by the general formula (A), a deprotonation of the hydrogen atom represented by L₁₁ thereby releasing an electron therefrom.

The base mentioned above is more specifically a conjugate base of an acid having a pKa of about 1 to about 10. It can be, for example, a nitrogen-containing heterocyclic compound (such as a pyridine, an imidazole, a benzimidazole or a thiazole), an aniline, a trialkylamine, amino group, a carbonic acid (such as an active methylene anion), thioacetate anion, a carboxylate (—COO⁻), a sulfate (—SO₃⁻) or an aminoxide (>N⁺(O⁻)—). It is preferably a conjugate base of an acid having a pKa of about 1 to about 8, more preferably a carboxylate, a sulfate or an aminoxide, and particularly preferably a carboxylate. In the case where such base has an anion, a counter cation may be present, which can be, for example, an alkali metal ion, an alkali earth metal ion, a heavy metal ion, ammonium ion or phosphonium ion. Such base is bonded at an arbitrary position to the compound represented by the general formula (A). As for the bonding position, such base portion may be bonded to any of RED₁₁, R₁₁₁ and R₁₁₂ of the general formula (A), or may be bonded to a substituent on such groups.

In the general formula (A), R₁₁₂ represents a hydrogen atom or a substituent that can be substituted for a substituent on a carbon atom. However, R₁₁₂ does not represent the same group as L₁₁.

R₁₁₂ preferably represents a hydrogen atom, an alkyl group, an aryl group (such as phenyl group), an alkoxy group (such as methoxy group, ethoxy group, or benzyloxy group), hydroxy group, an alkylthio group (such as methylthio group or butylthio group), amino group, an alkylamino group, an arylamino group, or a heterocyclic amino group, and more preferably a hydrogen atom, an alkyl group, an alkoxy group, hydroxy group, phenyl group or an alkylamino group.

In the general formula (A), a ring structure formed by R₁₁₁ is a ring structure corresponding to a tetrahydro form, a hexahydro form or an octahydro form of a 5- or 6-membered aromatic ring (including an aromatic hetero ring), wherein a hydro form means a ring structure in which carbon-carbon (a) double bond(s) (or (a) carbon-nitrogen double bond(s)) present in the aromatic ring (including an aromatic hetero ring) is/are partially halogenated, and a tetrahydro form, a hexahydro form, or an octahydro form respectively means a structure in which two, three or four carbon-carbon double bonds (or carbon-nitrogen double bonds) are hydrogenated, respectively. By such hydrogenation, the aromatic ring becomes a partially hydrogenated non-aromatic ring structure.

Specific examples of the ring structure include a pyrrolidine ring, an imidazolidine ring, a thiazolidine ring, a pyrazolidine ring, an oxazolidine ring, a piperidine ring, a tetrahydropyridine ring, a tetrahydropyrimidine ring, a piperazine ring, a tetraline ring, a tetrahydroquinoline ring, a tetrahydroisoquinoline ring, a tetrahydroquinazoline ring, a tetrahydroquinoxaline ring, a tetrahydrocarbazole ring, or an octahydrophenanthridine ring. Such ring structures may have an arbitrary substituent.

A ring structure formed by R₁₁₁ is more preferably a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring, or a tetrahydrocarbazole ring, and particularly preferably a pyrrolidine ring, a piperidine ring, a piperazine ring, a tetrahydropyridine ring, a tetrahydroquinoline ring, a tetrahydroisoquinoline ring, a tetrahydroquinazoline ring, or a tetrahydroquinoxaline ring, and most preferably a pyrrolidine ring, a piperidine ring, a tetrahydropyridine ring, a tetrahydroquinoline ring, or a tetrahydroisoquinoline ring.

In the general formula (B), RED₁₂ represents a group having the same difinition as that of RED₁₁ in the general formula (A), and has the same range of preferable examples as that of RED₁₁. In the general formula (B), L₁₂ represents a group having the same difinition as that of L₁₁ in the general formula (A), and has the same range of preferable examples as that of L₁₁. However RED₁₂ is a monovalent group except for a case of forming the following ring structure, and more specifically can be a monovalent group cited as an example of RED₁₁. R₁₂₁ and R₁₂₂ represent groups having the same difinition as in R₁₁₂ in the general formula (A), and have the same preferable range as that of R₁₁₂. ED₁₂ represents an electron donating group. R₁₂₁ and RED₁₂, R₁₂₁ and R₁₂₂, or ED₁₂ and RED₁₂ may be mutually bonded to form a ring structure.

In the general formula (B), an electron donating group represented by ED₁₂ has the same definition as the electron donating group explained as a substituent on RED₁₁ in the case RED₁₁ represents an aryl group. ED₁₂ is preferably hydroxy group, an alkoxy group, mercapto group, a sulfonamide group, an alkylamino group, an arylamino group, an active methine group, a 5-membered single- or condensed-ringed electron-excessive aromatic heterocyclic group containing at least one nitrogen atom in the ring, a non-aromatic nitrogen-containing heterocyclic group that has the unpaired electron on a nitrogen atom, or a phenyl group substituted by such electron donating group, and more preferably a hydroxy group, a mercapto group, a sulfonamide group, an alkylamino group, an arylamino group, an active methine group, a non-aromatic nitrogen-containing heterocyclic group that has the unpaired electron on a nitrogen atom, or a phenyl group substituted by such electron donating group (for example p-hydroxyphenyl group, a p-dialkylaminophenyl group, an o,p-dialkoxyphenyl group, etc.).

In the general formula (B), R₁₂₁ and RED₁₂, R₁₂₂ and R₁₂₁, or ED₁₂ and RED₁₂ may be mutually bonded to form a ring structure. The ring structure thus formed is a substituted or non-substituted, 5- to 7-membered, single-ringed or condensed-ringed, non-aromatic, carbocycle or heterocycle. In the case where R₁₂₁ and RED₁₂ form a ring structure, examples thereof include, in addition to the examples of the ring structure formed by R₁₁₁ in the general formula (A), a pyroline ring, an imidazoline ring, a thiazoline ring, a pyrrazoline ring, an oxazoline ring, an indane ring, a morpholine ring, an indoline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, and a 2,3-dihydrobenzothiophene ring. In the case where ED₁₂ and RED₁₂ form a ring structure, ED₁₂ preferably represents an amino group, an alkylamino group, or an arylamino group, and specific examples of the formed ring structure include a tetrahydropyradine ring, a piperazine ring, a tetrahydroquinoxaline ring, and a tetrahydroisoquinoline ring. In the case where R₁₂₂ and R₁₂₁ form a ring structure, specific examples thereof include a cyclohexane ring and a cyclopentane ring.

In the following an explanation of the general formulas (1) to (3) will be given.

In the general formulas (1) to (3), R₁, R₂, R₁₁, R₁₂ and R₃₁, have the same difinition as that of R₁₁₂ in the general formula (A) and have the same range of preferable examples as that of R₁₁₂. L₁, L₂₁ and L₃₁ each independently represent any of leaving groups that are cited as specific examples of L₁₁ in the general formula (A), and has the same range of preferable examples as that of L₁₁. X₁ or X₂₁ each independently represent any of substituents that are cited as examples of the substituent on RED₁₁ in the general formula (A) in the case where RED₁₁ in the general formula (A) has a substituent, and has the same range of preferable examples as that of such substituents in the case where RED₁₁ in the general formula (A) has a substituent. Each of m₁ and m₂₁ is preferably an integer of 0 to 2, more preferably 0 or 1.

In the case where any of R_{N1}, R_{N21} and R_{N31} represents a substituent, such substituent is preferably an alkyl group, an aryl group or a heterocyclic group, which may further have an arbitrary substituent. Each of R_{N1}, R_{N2}, and R_{N31} is preferably a hydrogen atom, an alkyl group or an aryl group, more preferably a hydrogen atom or an alkyl group.

In the case where any of R₁₃, R₁₄, R₃₃, Rₐ and R_{b} represents a substituent, such substituent is preferably an alkyl group, an aryl group, an acyl group, an alkoxycarbonyl group, a carbamoyl group, a cyano group, an alkoxy group, an acylamino group, a sulfonamide group, an ureido group, a thioureido group, an alkylthio group, an arylthio group, an alkylsulfonyl group, an arylsulfonyl group or a sulfamoyl group.

In the general formula (1), a 6-membered ring formed by Z₁ is a non-aromatic hetero ring condensed with the benzene ring of the general formula (1), and is more specifically, as a ring structure including the condensed benzene ring, a tetrahydroquinoline ring, a tetrahydroquinoxaline ring, or a tetrahydroquinazoline ring, and preferably a tetrahydroquinoline ring, or a tetrahydrdoquinoxaline ring. Such rings may have a substituent.

In the general formula (2), ED₂₁ has the same definition as that of ED₁₂ in the general formula (B), and has the same preferable range as that of ED₁₂.

In the general formula (2), any two of R_{N21}, R₁₃, R₁₄, X₂₁ and ED₂₁ may be mutually bonded to each other to form a ring structure. A ring structure formed by a bonding of R_{N21} and X₂₁ is preferably a 5- to 7-membered non-aromatic, carbocycle or heterocycle condensed with a benzene ring, and specific examples include a tetrahydroquinoline ring, a tetrahydroquinoxaline ring, an indoline ring, or a 2,3-dihydro-5,6-benzo-1,4-thiazine ring, preferably a tetrahydrdoquinoline ring, a tetrahydroquinoxaline ring or an indoline ring.

In the general formula (3), in the case R_{N31} represents a group other than an aryl group, Rₐ and R_{b} are mutually bonded to each other to form an aromatic ring. The aromatic ring can be an aryl group (for example phenyl group or naphthyl group), or an aromatic heterocyclic group (for example a pyridine ring group, a pyrrole ring group, a quinoline ring group or an indol ring group), and is preferably an aryl group. Such aromatic ring group may have an arbitrary substituent.

In the general formula (3), Rₐ and R_{b} are preferably mutually bonded to each other to form an aromatic ring (particularly phenyl group).

In the general formula (3), R₃₂ is preferably a hydrogen atom, an alkyl group, an aryl group, a hydroxy group, an alkoxy group, a mercapto group, or an amino group, and, in the case where R₃₂ represents a hydroxy group, it is preferable that R₃₃ simultaneously represents an “electron attracting group”. The “electron attracting group” has the same definition as that explained in the foregoing and is preferably an acyl group, an alkoxycarbonyl group, a carbamoyl group or a cyano group.

In the following, the compound of the type 2 will be explained.

In the compound of the type 2, “a bond-cleaving reaction” means a cleaving of a carbon-carbon, carbon-silicon, carbon-hydrogen, carbon-boron, carbon-tin or carbon-germanium bond, and a cleaving of a carbon-hydrogen bond may further be involved.

The compound of the type 2 is a compound having, in the molecule thereof, two or more (preferably two to six and more preferably two to four) groups adsorbable to silver halide. More preferably it is a compound having, as an adsorbable group, a nitrogen-containing heterocyclic group substituted by two or more mercapto groups. The number of the adsorbable groups is preferably 2 to 6, more preferably 2 to 4. The adsorbable group will be explained later.

Among the compounds of the type 2, a preferred compound is represented by the general formula (C).

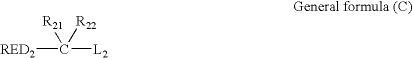

A compound represented by the general formula (C) is a compound capable, after a 1-electron oxidation of a reducing group represented by RED₂, of spontaneously releasing L₂ by a bond cleaving reaction, thereby further releasing an electron.

In the general formula (C), RED₂ has the same definition as that of RED₁₂ in the general formula (B), and has the same range of preferable examples as that of RED₁₂ in the general formula (B). L₂ has the same definition as that of L₁₁ in the general formula (A), and has the same range of preferable examples as that of L₁₁ in the general formula (A). In the case L₂ represents a silyl group, the compound represented by the general formula (C) has, within the molecule thereof, a nitrogen-containing heterocyclic group substituted by two or more mercapto groups as an adsorbable group. R₂₁ and R₂₂ each independently represent a hydrogen atom or a substituent, have the same definition as that of R₁₁₂ in the general formula (A), and have the same range of preferable examples as that of R₁₁₂ in the general formula (A). RED₂ and R₂₁ may be mutually bonded to form a ring structure.

The above-mentioned ring structure is a 5- to 7-membered, single-ringed or condensed-ringed, non-aromatic, carbocycle or heterocycle, which may have a substituent. However, such ring structure cannot be a ring structure corresponding to a tetrahydro, hexahydro, or octahydro form of an aromatic ring or an aromatic hetero ring. Such ring structure preferably corresponds to a dihydro form of an aromatic ring or a dihydro form of an aromatic hetero ring, and specific examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzoxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, and a 1,2-dihydroquinoxaline ring. It is preferably a 2-imidazoline ring, a 2-thiazoline ring, an indoline ring, a benzoimidazoline ring, a benzothiazoline ring, a benzoxazoline ring, a 1,2-dihydropyridine ring, a 1,2-dihydroquinoline ring, a 1,2-dihydroquinazoline ring or a 1,2-dihydroquinoxaline ring, and more preferably an indoline ring, a benzoimidazoline ring, a benzothiazoline ring, or a 1,2-dihydroquinoline ring, and particularly preferably an indoline ring.

In the following, the compound of the type 3 will be explained.

In the compound of the type 3, a “bond forming process” means formation of an interatomic bond such as carbon-carbon, carbon-nitrogen, carbon-sulfur or carbon-oxygen bond.

The compound of the type 3 is preferably a compound characterized in that a 1-electron oxidized form, formed by a 1-electron oxidation, is capable of further releasing one or more electrons, after forming a bond by reacting with a reactive group portion (a carbon-carbon double bond portion, a carbon-carbon triple bond portion, an aromatic group portion or a non-aromatic heterocyclic group portion of a benzo condensed ring) existing in the molecule.

More specifically, the compound of the type 3 is characterized in that a 1-electron oxidized form thereof (cation radical species, or neutral radical species generated therefrom by a proton release), formed by a 1-electron oxidation, reacts with the above-mentioned reactive group present in the same molecule to form a bond, thereby generating new radical species having a ring structure within the molecule, and that a second electron is released from such radical species, either directly or with a proton release.

In a certain compound of the type 3, a 2-electron oxidized form thus generated is subjected to a hydrolysis reaction or directly cause a tautomeric reaction involving a proton transfer, thereby further releasing one or more electrons, usually two or more electrons. Examples of compounds of the type 3 also include a compound capable, without going through such tautomeric reaction, of releasing one or more electrons, usually two or more electrons directly from the 2-electron oxidized form.

The compound of the type 3 is preferably represented by the general formula (D′):
RED₃-L₃-Y₃ General formula (D′)

In the general formula (D′), RED₃ represents a reducing group that can be subjected to a 1-electron oxidation; Y₃ represents a reactive group portion which reacts after RED₃ is 1-electron oxidized, and specifically represents an organic group including a carbon-carbon double bond portion, a carbon-carbon triple bond portion, an aromatic group portion or a non-aromatic heterocyclic group portion of a benzo condensed ring; and L₃ represents a connecting group which connects RED₃ and Y₃.

RED₃ has the same definition as that of RED₁₂ in the general formula (B), and is preferably an arylamino group, a heterocyclic amino group, an aryloxy group, an arylthio group, an aryl group, an aromatic or non-aromatic heterocyclic group (particularly preferably a nitrogen-containing heterocyclic group), and is further preferably an arylamino group, a heterocyclic amino group, an aryl group or an aromatic or non-aromatic heterocyclic group. Among these, the heterocyclic group is preferably a tetrahydroquinoline ring group, a tetrahydroquinoxaline ring group, a tetrahydroquinazoline ring group, an indoline ring group, an indole ring group, a carbazole ring group, a phenoxadine ring group, a phenothiazine ring group, a benzothiazoline ring group, a pyrrol ring group, an imidazole ring group, a thizaole ring group, a benzoimidazole ring group, a benzoimidazoline ring group, a benzothiazoline ring group, or a 3,4-methylenedioxyphenyl-1-yl group.

RED₃ is particularly preferably an arylamino group (particularly anilino group), an aryl group (particularly phenyl group), or an aromatic or non-aromatic heterocyclic group.

In the case where RED₃ represents an aryl group, the aryl group preferably includes at least one “electron donating group”. The meaning of “electron donating group” is the same as that explained in the foregoing.

In the case where RED₃ represents an aryl group, a substituent of the aryl group is more preferably an alkylamino group, a hydroxy group, an alkoxy group, a mercapto group, a sulfonamide group, an active methine group, or a non-aromatic nitrogen-containing heterocyclic group that has the unpaired electron on a nitrogen atom, further preferably an alkylamino group, a hydroxy group, an active methine group, or a non-aromatic nitrogen-containing heterocyclic group that has the unpaired electron on a nitrogen atom, and most preferably an alkylamino group or a non-aromatic nitrogen-containing heterocyclic group that has the unpaired electron on a nitrogen atom.

In the case where the organic group including a carbon-carbon double bond portion (for example vinyl group) represented by Y₃ has a substituent, such substituent is preferably an alkyl group, a phenyl group, an acyl group, a cyano group, an alkoxycarbonyl group, a carbamoyl group, or an electron donating group, and such electron donating group is preferably an alkoxy group, a hydroxy group (which may be protected with a silyl group and can for example be a trimethylsilyloxy group, a t-butyldimethylsilyloxy group, a triphenylsilyloxy group, a triethylsilyloxy group, or a phenyldimethylsilyloxy group), an amino group, an alkylamino group, an arylamino group, a sulfonamide group, an active methine group, a mercapto group, an alkylthio group or a phenyl group having such electron donating group as a substituent.

In the case where the organic group including a carbon-carbon double bond portion has a hydroxy group as a substituent, Y₃ includes a partial structure: >C₁═C₂(—OH)—, which may be converted, by a tautomerism, to a partial structure: >C₁H—C₂(═O)—. Also in such a case, it is also preferable that a substituent on the carbon C₁ is an electron attracting group, thus Y₃ has a partial structure of “an active methylene group” or “an active methine group”. The definition of such an electron attracting group capable of providing such partial structure of an active methylene group or an active methine group, is the same as that explained in the foregoing description of the “active methine group”.

In the case where the organic group including a carbon-carbon triple bond portion (for example ethynyl group) represented by Y₃ has a substituent, such substituent is preferably an alkyl group, a phenyl group, an alkoxycarbonyl group, a carbamoyl group, or an electron donating group.

In the case Y₃ represents an organic group including an aromatic group portion, such aromatic group is preferably an aryl group (particularly preferably phenyl group) having an electron donating group as a substituent, or an indole ring group, and such electron donating group is preferably a hydroxy group (which may be protected with a silyl group), an alkoxy group, an amino group, an alkylamino group, an active methine group, a sulfonamide group or a mercapto group.

In the case Y₃ represents an organic group including a non-aromatic heterocyclic group portion of a benzo condensed ring, the non-aromatic heterocyclic group of a benzo condensed ring is preferably a group comprising an aniline structure as a partial structure, such as an indoline ring group, a 1,2,3,4-tetrahydroquinoline ring group, a 1,2,3,4-tetrahydroquinoxaline ring group or a 4-quinolone ring group.

The reactive group represented by Y₃ is more preferably an organic group including a carbon-carbon double bond portion, an aromatic group portion or a non-aromatic heterocyclic group portion of a benzo condensed ring. It is further preferably a carbon-carbon double bond portion, a phenyl group having an electron donating group as a substituent, an indole ring group, or a non-aromatic heterocyclic group of a benzo condensed ring comprising an aniline structure as a partial structure. It is further preferred that the carbon-carbon double bond portion has at least one electron donating group as a substituent.

A case where the reactive group represented by Y₃, as a result of selection within the aforementioned range, has the same partial structure which is the same as the reducing group represented by RED₃ is also a preferred example of the compound represented by the general formula (D′).

L₃ represents a connecting group which connects RED₃ and Y₃, and more specifically represents a single bond, an alkylene group, an arylene group, a heterocyclic group, —O—, —S—, —NRN—, —C(═O)—, —SO₂—, —SO—, —P(═O)—, or a group obtained by combining these groups. R_{N} represents a hydrogen atom, an alkyl group, an aryl group, or a heterocyclic group. The connecting group represented by L₃ may have an arbitrary substituent. The connecting group represented by L₃ may be connected to an arbitrary position of the groups represented by RED₃ and Y₃, by substituting an arbitrary hydrogen atom in each of RED₃ and Y₃.

Preferred examples of L₃ include a single bond, an alkylene group (particularly a methylene group, an ethylene group or a propylene group), an arylene group (particularly a phenylene group), —C(═O)—, —O—, —NH—, an —N(alkyl)-group, and a divalent connecting group formed by a combination of these groups.

The connecting group represented by L₃ is preferably selected such that, when a cation radical species (X⁺.) generated by an oxidation of RED₃ or a radical species (X.) generated by proton liberation therefrom reacts with the reactive group represented by Y₃ to form a bond, the atomic groups involved in the reaction can form a 3- to 7-membered ring including L₃. For this purpose, it is preferred that the radical species (X⁺. or X.), the reactive group represented by Y, and L are connected by a group of 3 to 7 atoms.

In the following, the compound of the type 4 will be explained.

The compound of the type 4 is a compound having a ring structure which is substituted by a reducing group, wherein after a 1-electron oxidation of such reducing group, the compound can release one or more electrons accompanied by a ring-opening reaction. The ring-opening reaction of the ring structure means a reaction indicated in the following:

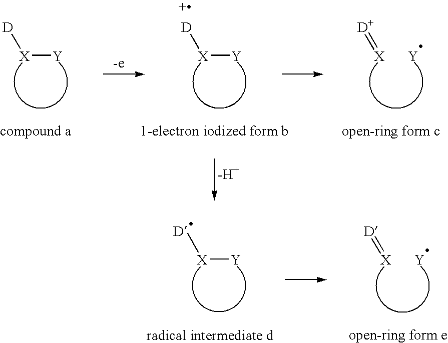

In the formula, a compound a represents the compound of the type 4. In the compound a, D represents a reducing group, and X and Y represent atoms constituting a bond in the ring structure, to be opened after the 1-electron oxidation. At first the compound a is subjected to a 1-electron oxidation to generate a 1-electron oxidized form b. Then a single bond D-X becomes a double bond and a bond X—Y is simultaneously opened to generate an open-ring form c. A process in which the 1-electron oxidized form b causes a proton release to generate a radical intermediate d, from which an open-ring form e is generated in a similar manner, is also possible. The compound of the invention is characterized in that thus generated open-ring form c or e further releases one or more electrons.

The ring structure of the compound of the type 4 is a 3- to 7-membered, single-ringed or condensed-ringed, saturated or unsaturated, non-aromatic, carbocycle or heterocycle. It is preferably a saturated ring structure, and more preferably a 3-membered ring or a 4-membered ring. Preferred examples of the ring structure include a cyclopropane ring, a cyclobutane ring, an oxylane ring, a oxetane ring, an aziridine ring, azetidine ring, an episulfide ring and a thietane ring. It is more preferably a cyclopropane ring, a cyclobutane ring, an oxylane ring, a oxetane ring, or an azetidine ring, and particularly preferably a cyclopropane ring, a cyclobutane ring, or an azetidine ring. The ring structure may have an arbitrary substituent.

The compound of the type 4 is preferably represented by the general formula (E) or (F).

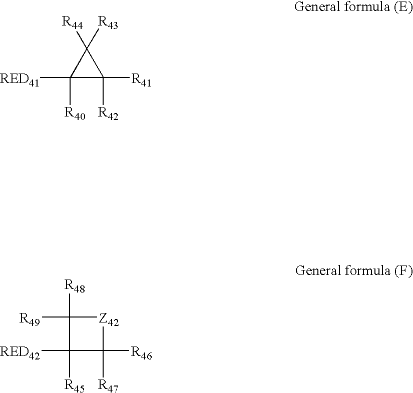

In the general formulas (E) and (F), RED₄₁ and RED₄₂ have the same definition as that of RED₁₂ in the general formula (B), and have the same range of preferable examples as that of RED₁₂ in the general formula (B). R₄₀ to R₄₄ and R₄₅ to R₄₉ each independently represent a hydrogen atom or a substituent. In the general formula (F), Z₄₂ represents —CR₄₂₀R₄₂₁—, —NR₄₂₃—, or —O—. R₄₂₀ and R₄₂₁ each independently represent a hydrogen atom or a substituent, and R₄₂₃ represents a hydrogen atom, an alkyl group, an aryl group or a heterocyclic group.

In the general formulas (E) and (F), R₄₀ and R₄₅ each preferably represents a hydrogen atom, an alkyl group, an aryl group, or a heterocyclic group, more preferably a hydrogen atom, an alkyl group, or an aryl group. R₄₁ to R₄₄ and R₄₆ to R₄₉ each preferably represents a hydrogen atom, an alkyl group, an alkenyl group, an aryl group, a heterocyclic group, an arylthio group, an alkylthio group, an acylamino group, or a sulfonamide group, more preferably a hydrogen atom, an alkyl group, an aryl group or a heterocyclic group.

There are preferred a case where at least one of R₄₁ to R₄₄ is a donor group and a case where both R₄₁ and R₄₂, or both R₄₃ and R₄₄ are electron attracting groups. There is more preferred a case where at least one of R₄₁ to R₄₄ is a donor group. There is further preferred a case where at least one of R₄₁ to R₄₄ is a donor group and the other non-donor group(s) in R₄₁ to R₄₄ is a hydrogen atom or an alkyl group.

The aforementioned donor group means an “electron donating group”, or an aryl group substituted by at least one “electron donating group”. The donor group is preferably an alkylamino group, an arylamino group, a heterocyclic amino group, a 5-membered, single-ringed or condensed-ringed, electron-excessive aromatic heterocyclic group containing at least a nitrogen atom in the ring, a non-aromatic, nitrogen-containing heterocyclic group which has the unpaired electron at a nitrogen atom, or a phenyl group substituted by at least an electron donating group. The doner group is more preferably an alkylamino group, an arylamino group, a 5-membered, single-ringed or condensed-ringed, electron-excessive aromatic heterocyclic group containing at least one nitrogen atom in the ring (such as an indole ring, a pyrrole ring or a carbazole ring), or a phenyl group substituted by an electron donating group (such as a phenyl group substituted by three or more alkoxy groups, or a phenyl group substituted by a hydroxy group, an alkylamino group or an arylamino group). Particularly preferably, the doner group is an arylamino group, a 5-membered, single-ringed or condensed-ringed, electron-excessive aromatic heterocyclic group containing at least a nitrogen atom in the ring (particularly 3-indolyl group), or a phenyl group substituted by an electron donating group (particularly a phenyl group substituted by a trialkoxyphenyl group, an alkylamino group or an arylamino group).

Z₄₂ is preferably —CR₄₂₀R₄₂₁— or —NR₄₂₃—, and more preferably —NR₄₂₃—. Each of R₄₂₀ and R₄₂₁ is preferably a hydrogen atom, an alkyl group, an aryl group, a heterocyclic group, an acylamino group, or a sulfonamino group, and more preferably a hydrogen atom, an alkyl group, an aryl group, or a heterocyclic group. R₄₂₃ preferably represents a hydrogen atom, an alkyl group, an aryl group or an aromatic heterocyclic group, more preferably a hydrogen atom, an alkyl group or an aryl group.

In the case each of R₄₀ to R₄₉, R₄₂₀, R₄₂₁ and R₄₂₃ represents a substituent, it preferably has a total carbon number of 40 or less, more preferably 30 or less, and particularly preferably 15 or less. Also these substituents may be bonded mutually, or bonded with another portion (RED₄₁, RED₄₂ or Z₄₂) in the molecule, to form a ring.

In the compounds of the types 1 to 4 of the invention, an adsorbable group to silver halide means a group that can be directly adsorbed by silver halide or a group capable of accelerating an adsorption on silver halide, and is specifically a mercapto group (or a salt thereof), a thion group (—C(═S)—), a heterocyclic group containing at least an atom selected from the group consisting of a nitrogen atom, a sulfur atom, a selenium atom and a tellurium atom, a sulfide group, a cationic group, or an ethynyl group. However, in the case of a compound of the type 2 of the invention, the adsorbable group cannot be a sulfide group.

A mercapto group (or a salt thereof) as the adsorbable group means not only a mercapto group (or a salt thereof) itself but also, more preferably, a heterocyclic group substituted by at least one mercapto group (or a salt thereof), an aryl group substituted by at least one mercapto group (or a salt thereof), or an alkyl group substituted by at least one mercapto group (or a salt thereof). The heterocyclic group is a 5- to 7-membered, single-ringed or condensed-ringed, aromatic or non-aromatic heterocyclic group such as an imidazole ring group, a thiazole ring group, an oxazole ring group, a benzimidazole ring group, a benzothiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline group, a pyrimidine ring group or a triazine ring group. It can also be a heterocyclic group including a quaternary nitrogen atom, and, in such case, a mercapto group as a substituent may be dissociated to form a meso ion. Examples of such heterocyclic group include an imidazolium ring group, a pyrazolium ring group, a thiazolium ring group, a triazolium ring group, a tetrazolium ring group, a thiadiazolium ring group, a pyridinium ring group, a pyrimidinium ring group, and a triazinium ring group, among which a triazolium ring group (such as 1,2,4-triazolium-3-thiolate ring group) is preferable. The aryl group can be a phenyl group or a naphthyl group. Also the alkyl group can be a linear, branched or cyclic alkyl group with 1 to 30 carbon atoms. In the case where the mercapto group forms a salt, a counter ion can be a cation such as: an alkali metal, an alkali earth metal, and a heavy metal (Li⁺, Na⁺, K⁺, Mg²⁺, Ag⁺, Zn²⁺ etc.); an ammonium ion; a heterocyclic group containing a quaternary nitrogen atom; or a phosphonium ion.

The mercapto group as the adsorbable group may become a thion group by tautomerism, and can specifically be a thioamide group (—C(═S)—NH— in this case) or a group including a partial structure of such thioamide group, such as a linear or cyclic thioamide group, a linear or cyclic thioureido group, a linear or cyclic thiourethane group, or a dithiocarbamate ester group. Examples of the cyclic group include a thiazolidine-2-thion group, an oxazolidine-2-thion group, a 2-thiohidantoin group, a rhodanin group, an isorhodanin group, a thiobarbituric acid group, and 2-thioxo-oxazolidin-4-on group.

Examples of the thion group as the adsorbable group includes not only the aforementioned thion group formed by tautomerism from a mercapto group, but also a linear or cyclic thioamide group, a linear or cyclic thioureido group, a linear or cyclic thiourethane group and a dithiocarbamate ester group, each of which cannot be converted to a mercapto group by tautomerism (not having a hydrogen atom in α-position of thion group).

The heterocyclic group containing at least one atom selected from a nitrogen atom, a sulfur atom, a selenium atom and a tellurium atom, as the adsorbable group, is a nitrogen-containing heterocyclic group having, as a partial structure of the hetero ring, an —NH— group capable of forming an imino silver (>NAg), or a heterocyclic group having, as a partial structure of the hetero ring, —S—, -Se-, —Te— or ═N— capable of coordinating to a silver ion by a coordinate bond. Examples of the former include a benzotriazole group, a triazole group, an indazole group, a pyrrazole group, a tetrazole group, a benzimidazole group, an imidazole group and a purine group, while examples of the latter include a thiophene group, a thiazole group, an oxazole group, a benzothiazole group, a benzoxazole group, thiadiazole group, an oxadiazole group, a triazine group, a selenoazole group, a benzselenoazole group, a tellurazole group and a benztellurazole group. The former is preferable.

A sulfide group as the adsorbable group can be any group having an —S— partial structure, and is preferably a group having a partial structure of alkyl(or alkylene)-S-alkyl(or alkylene), aryl(or arylene)-S-alkyl(or alkylene) or aryl(or arylene)-S-aryl(or arylene). Also such sulfide group may form a ring structure or may form a —S—S— group. Specific examples in the case of forming a ring structure include a group containing a thiolan ring, a 1,3-dithiolan ring, a 1,2-dithiolan ring, a thian ring, a dithian ring, or a tetrahydro-1,4-thiazine ring (a thiomorpholine ring). A sulfide group is particularly preferably a group having a partial structure of alkyl(or alkylene)-S-alkyl(or alkylene).

A cationic group as the adsorbable group means a group containing a quaternary nitrogen atom, and is specifically a group including an ammonio group or a group including a nitrogen-containing heterocyclic group containing a quaternary nitrogen atom. However, such cationic group does not become a part of an atomic group constituting a dye structure (for example, a cyanine chromophore). The ammonio group is, for example, a trialkylammonio group, a dialkylarylammonio group or an alkyldiarylammonio group, and can be, for example, benzyldimethylammonio group, trihexylammonio group or phenyldiethylammonio group. A nitrogen-containing heterocyclic group including a quaternary nitrogen atom can be, for example, a pyridinio group, a quinolinio group, an isoquinolinio group or an imiazolio group. It is preferably a pyridinio group or an imidazolio group, and particularly preferably a pyridinio group. Such nitrogen-containing heterocyclic group including a quaternary nitrogen atom may have an arbitrary substituent, however, in the case of pyridinio group or imidazolio group, the substituent is preferably an alkyl group, an aryl group, an acylamino group, a chlorine atom, an alkoxycarbonyl group or a carbamoyl group, and, in the case of a pyridinio group, the substituent is particularly preferably a phenyl group.

An ethynyl group as the adsorbable group means —C≡CH, in which the hydrogen atom may be substituted.

Such adsorbable group may have an arbitrary substituent.

Specific examples of the adsorbable group also include the adsorbable groups described in JP-A No. 11-95355, pages 4 to 7.

In the invention, the adsorbable group is preferably a mercapto-substituted nitrogen-containing heterocyclic group (such as a 2-mercaptothiadiazole group, 3-mercapto-1,2,4-triazole group, 5-mercaptotetrazole group, 2-mercapto-1,3,4-oxadiazole group, 2-mercaptobenzoxazole group, 2-mercaptobenzothiazole group, or 1,5-dimethyl-1,2,4-triazolium-3-thiolate group), or a nitrogen-containing heterocyclic group having an —NH— group capable of forming imino silver (>NAg) as a partial structure of the hetero ring (such as a benzotriazole group, a benzimidazole group, or an indazole group). It is particularly preferably a 5-mercaptotetrazole group, 3-mercapto-1,2,4-triazole group, or a benzotriazole group, and most preferably a 3-mercapto-1,2,4-triazole group or a 5-mercaptotetrazole group.

Among the compounds of the invention, there is also preferred a compound having two or more mercapto groups as a partial structure within the molecule. The mercapto group (—SH) may become a thion group in the case tautomerism is possible. Such compound may be a compound having, within the molecule, two or more adsorbable groups which have the aforementioned mercapto or thion group as a partial structure (such as a ring-forming thioamide group, an alkylmercapto group, an arylmercapto group or a heterocyclic mercapto group), or a compound having at least an adsorbable group which includes two or more mercapto or thion groups as a partial structure (for example a dimercapto-substituted nitrogen-containing heterocyclic group).

Examples of the adsorbable group having two or more mercapto groups as a partial structure (such as a dimercapto-substituted nitrogen-containing heterocyclic group) include a 2,4-dimercaptopyrimidine group, a 2,4,-dimercaptotriazine group, a 3,5-dimercapto-1,2,4-triazole group, a 2,5-dimercapto-1,3-thiazole group, a 2,5-dimercapto-1,3-oxazole group, 2,7-dimercapto-5-methyl-s-triazolo(1,5-A)-pyrimidine, 2,6,8-trimercaptopurine, 6,8-dimercaptopurine, 3,5,7-trimercapto-s-triazolotriazine, 4,6-dimercaptopyrazolopyrimidine, and 2,5-dimercaptoimidazole, and particularly preferably a 2,4-dimercaptopyrimidine group, a 2,4-dimercaptotriazine group or a 3,5-dimercapto-1,2,4-triazole group.

The adsorbable group may be bonded to any position in the general formulas (A) to (F) and the general formulas (1) to (3), but it is preferably substituted on RED₁₁, RED₁₂, RED₂ or RED₃ in the general formulas (A) to (D), on RED₄₁, R₄, RED₄₂ or R₄₆ to R₄₈ in the general formula (E) or (F), or on an arbitrary position excluding R₁, R₂, R₁₁, R₁₂, R₃₁, L₁, L₂₁ and L₃₁ in the general formulas (1) to (3), and is more preferably substituted, in all the general formulas (A) to (F), on RED₁₁ to RED₄₂.

A partial structure of a spectral sensitizing dye is a group including a chromophore of the spectral sensitizing dye, and is a residue obtained by eliminating a hydrogen atom or a substituent in an arbitrary position from the spectral sensitizing dye compound. The partial structure of the spectral sensitizing dye may be substituted in any position in the general formulas (A) to (F) and the general formulas (1) to (3), but is preferably substituted on RED₁₁, RED₁₂, RED₂ or RED₃ in the general formulas (A) to (D), on RED₄₁, R₄₁, RED₄₂ or R₄₆ to R₄₈ in the general formula (E) or (F), or on an arbitrary position excluding R₁, R₂, R₁₁, R₁₂, R₃₁, L₁, L₂₁ and L₃₁ in the general formulas (1) to (3), and is more preferably substituted, in all the general formulas (A) to (F), on RED₁₁ to RED₄₂. A preferred spectral sensitizing dye is a spectral sensitizing dye typically employed in the color sensitizing technology, and examples thereof includes, for example, a cyanine dye, a complex cyanine dye, a melocyanine dye, a complex melocyanine dye, a homopolar cyanine dye, a styryl dye and a hemicyanine dye. Representative spectral sensitizing dyes are described in Research Disclosure, item 36544, September 1994. These dyes can be synthesized by those skilled in the art according to procedures described in such Research Disclosure and in F. M. Hamer, The Cyanine dyes and Related Compounds (Interscience Publishers, New York, 1964). Also all the dyes described in JP-A No. 11-95355 (U.S. Pat. No. 6,054,260), pages 7 to 14, can be applied.

The compound of the types 1 to 4 of the invention preferably has a total number of carbon atoms within a range of 10 to 60, more preferably 15 to 50, further preferably 18 to 40 and particularly preferably 18 to 30.

The compound of the types 1 to 4 of the invention is subjected to a 1-electron oxidation which is triggered by an exposure of a silver halide photosensitive material comprising such compound to radiation, and, after an ensuing reaction, is oxidized by releasing an electron or two or more electrons based on the type of the compound, and an oxidation potential for such first electron is preferably about 1.4 V or less, and more preferably 1.0 V or less. Such oxidation potential is preferably higher than 0 V and more preferably higher than 0.3 V. Therefore, the oxidation potential is preferably within a range of about 0 to about 1.4 V, more preferably about 0.3 to about 1.0 V.

The oxidation potential can be measured by a cyclic voltammetry method, more specifically by dissolving a sample in a solution of acetonitrile:water (containing 0.1 M lithium perhydrochlorate)=80%:20% (vol. %), aerate the solution with nitrogen gas for 10 minutes, and executing a measurement with a potential scanning rate of 0.1 V/sec at 25° C., utilizing a glass-like carbon disk as an operating electrode, a platinum wire as a counter electrode and a calomel electrode (SCE) as a reference electrode. An oxidation potential relative to SCE is measured at a peak potential of a cyclic voltammetry wave.

In the case the compound of the types 1 to 4 of the invention is a compound which, after a 1-electron oxidation and an ensuing reaction, further releases one electron, an oxidation potential of such latter oxidation is preferably from −0.5 to −2 V, more preferably from −0.7 to −2 V and further preferably from −0.9 to −1.6 V.

In the case where the compound of the types 1 to 4 of the invention is a compound which, after a 1-electron oxidation and an ensuing reaction, is oxidized by further releasing two or more electrons, an oxidation potential of such latter oxidation is not particularly restricted. This is because the oxidation potential for the second electron and the oxidation potential for the third or later electron cannot be clearly distinguished and it is often difficult to exactly measure and distinguish these values.

In the following, the compound of the type 5 will be explained.

The compound of the type 5 is represented by X-Y, in which X represents a reducing group and Y represents a leaving group, wherein a 1-electron oxidized form, generated by a 1-electron oxidation of the reducing group represented by X, causes a cleaving reaction of X-Y bond thereby releasing Y and generating an X radical, thus further releasing an electron therefrom. The oxidation of such compound of the type 5 can be represented by the following formula:

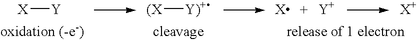

The compound of the type 5 preferably has an oxidation potential from 0 to 1.4 V, more preferably 0.3 to 1.0 V. Also the radical X. generated in the foregoing reaction formula preferably has an oxidation potential from 0.7 to −2.0 V, more preferably from −0.9 to −1.6 V.

The compound of the type 5 is preferably represented by the general formula (G).

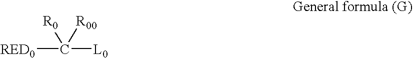

In the general formula (G), RED₀ represents a reducing group; L₀ represents a leaving group; R₀ and R₀₀ each independently represent a hydrogen atom or a substituent. RED₀ and R₀, or R₀ and R₀₀ may be mutually bonded to form a ring structure. RED₀ has the same definition as RED₂ in the general formula (C), and has the same range of preferable examples as RED₂ in the general formula (C). R₀ and R₀₀ have the same definition as R₂₁ and R₂₂ in the general formula (C), and have the same range of preferable examples as R₂₁, and R₂₂ in the general formula (C). However, each of R₀ and R₀₀ does not represent the same group as L₀, except in the case where L₀ represents a hydrogen atom. RED₀ and R₀ may be mutually bonded to form a ring structure. Examples of such a ring structure are the same as the examples of the ring structure formed by bonding of RED₂ to R₂₁ in the general formula (C). And the preferable range of the ring structure formed by the bond between RED₀ and R₀ is also the same as that of the ring structure formed by the bond between RED₂ to R₂₁, in the general formula (C). Examples of the ring structure formed by mutual bonding of R₀ and R₀₀ include a cyclopentane ring and a tetrahydrofuran ring. In the general formula (G), L₀ has the same definition as L₂ in the general formula (C), and has the same range of preferable examples as L₂ in the general formula (C).

The compound represented by the general formula (G) preferably has an adsorbable group to silver halide, or a partial structure of a spectral sensitizing dye. However, in the case where L₀ represents a group other than a silyl group, the compound does not have two or more adsorbable groups at the same time within the molecule. However, two or more sulfide groups as adsorbable groups may be present in the compound regardless of L₀.

Examples of an adsorbable group to silver halide, in the compound represented by the general formula (G), include the adsorbable groups that can be included in the compound of the types 1 to 4 of the invention, and also include all compounds that is described as “adsorbable group to silver halide” in JP-A No. 11-95355, pages 4 to 7, and the preferable range is also the same.

A partial structure of a spectral sensitizing dye which may be included in the compound represented by the general formula (G) has the same definition as the partial structure of the spectral sensitizing dye which may be included in the compound of the types 1 to 4 of the invention. However examples of the partial structure of a spectral sensitizing dye in the compound represented by the general formula (G) also include all structures described as “light absorbing groups” in JP-A No. 11-95355, pages 7 to 14, and the preferable range is also the same.

In the following, specific examples of the compound of the types 1 to 5 of the invention are shown, but the invention is not limited to such examples.

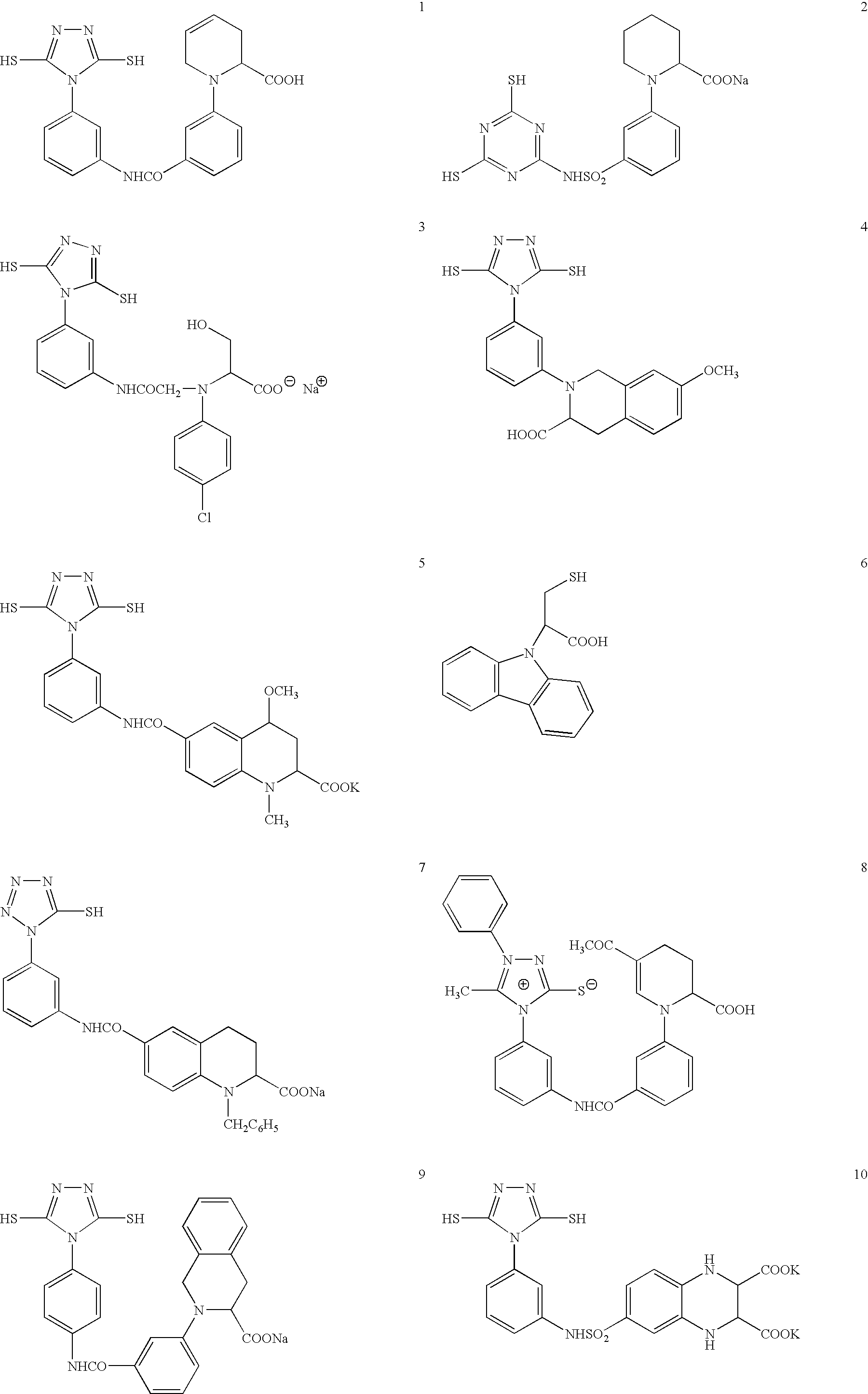

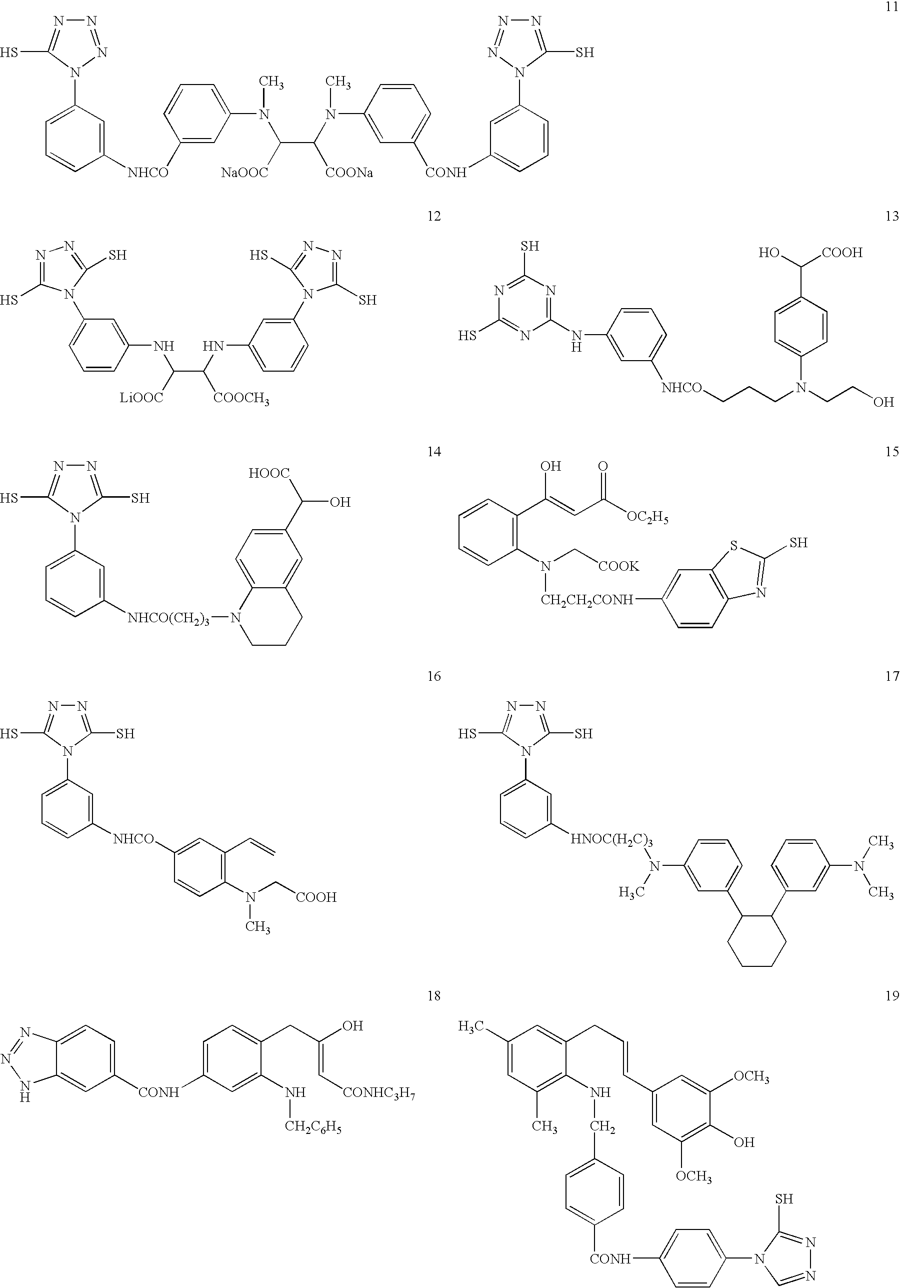

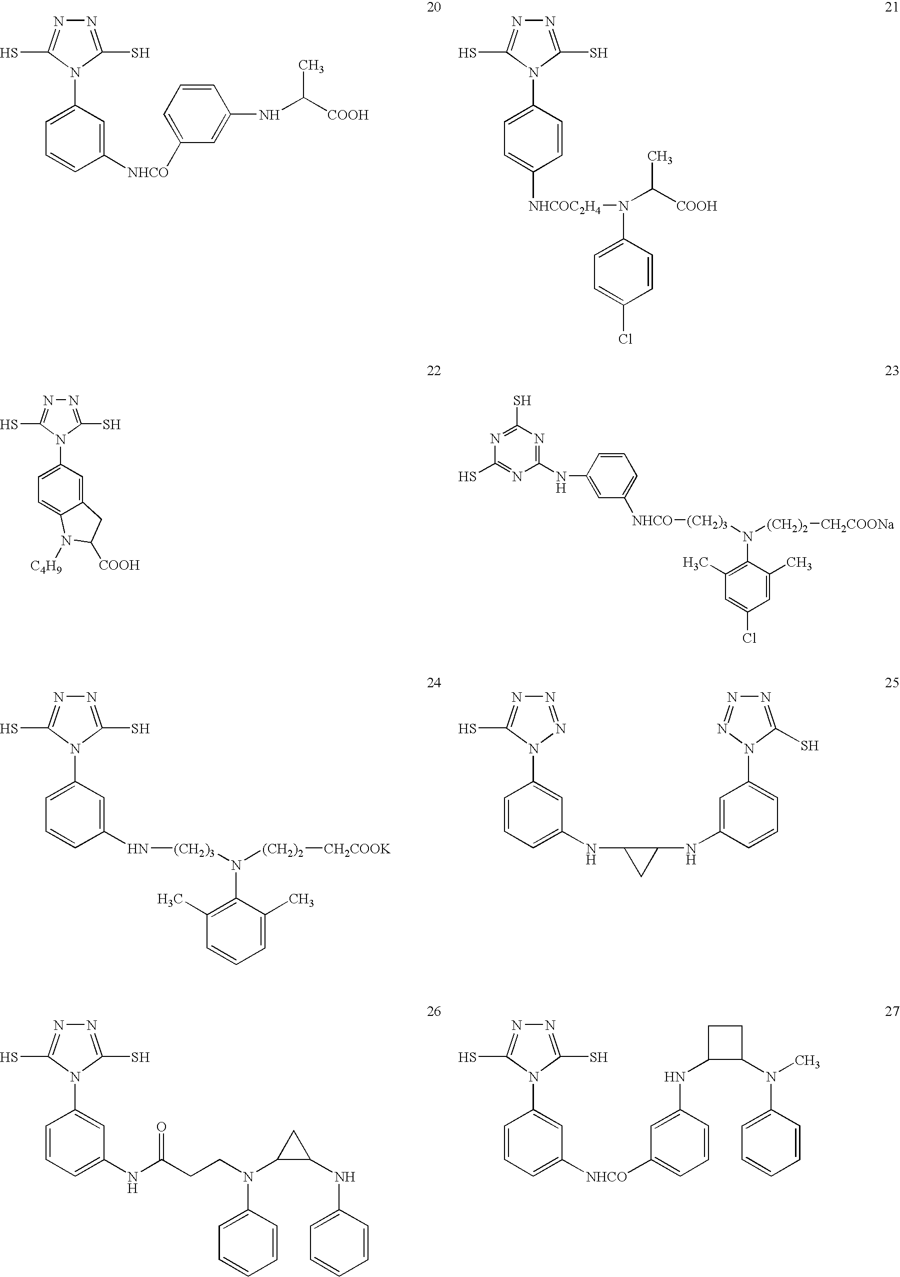

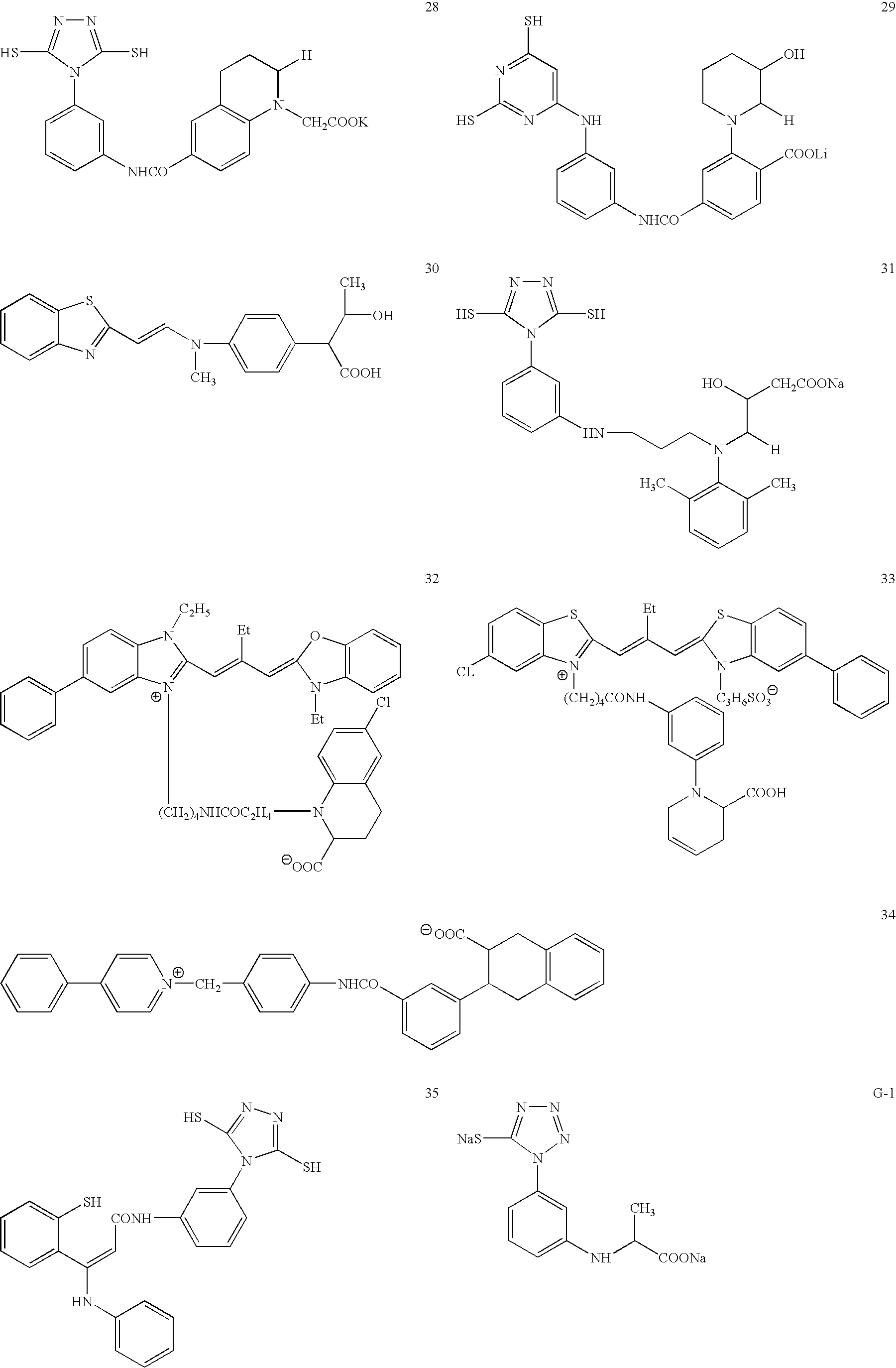

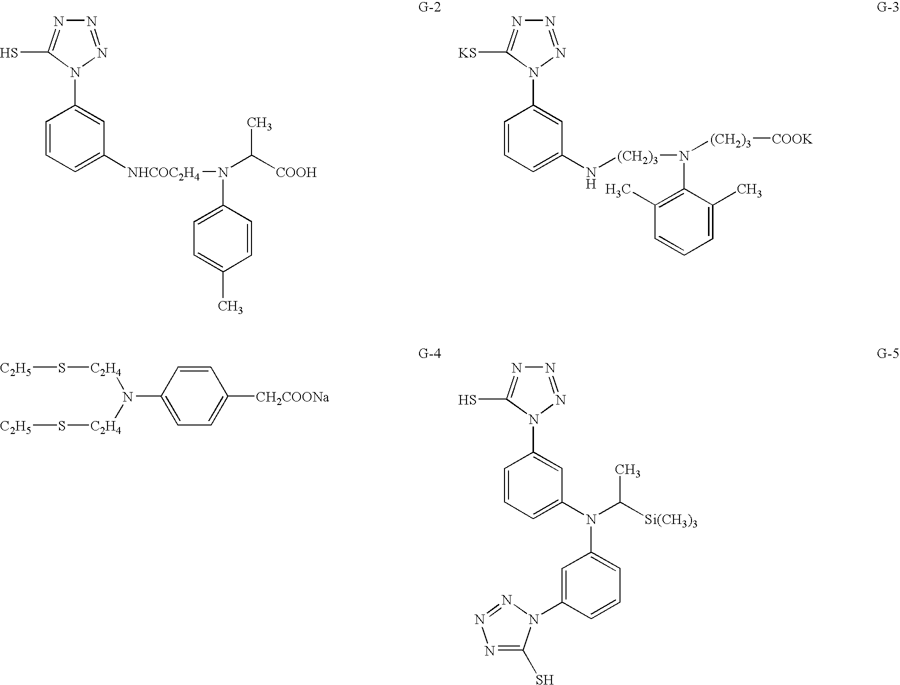

The compounds of the types 1 to 4 of the invention are the same as the compounds explained in detail in JP-A Nos. 2003-114487, 2003-114486, 2003-140287, 2003-075950, and 2003-114488. The specific examples of the compounds described in these patent applications can also be included in specific examples of the compounds of the types 1 to 4 of the invention. Also synthesis examples of the compounds of the types 1 to 4 of the invention are the same as those described in these patent applications.

Examples of the compound of the type 5 of the invention include compounds described as “1-photon 2-electron sensitizer” or “deprotonation electron donating sensitizer” in JP-A No. 9-211769 (compounds PMT-1 to S-37 described in Tables E and F on pages 28 to 32), JP-A No. 9-211774, JP-A No. 11-95355 (compounds INV1-36), WO99/05570 (compounds 1-74, 80-87, 92-122), U.S. Pat. Nos. 5,747,235 and 5,747,236, EP No. 786692A1 (compounds INV1-35), EP No. 893732A1, U.S. Pat. Nos. 6,054,260 and 5,994,051.

The compound of the types 1 to 5 of the invention may be used in any stage in the preparation of a photosensitive silver halide emulsion or in the production process of a photothermographic material. For example the compound may be used in a formation of photosensitive silver halide grains, in a desalting step, at a chemical sensitization or before coating. The compound may also be added plural times in such process. The timing of addition is preferably within a period from the completion of silver halide grain formation to a time just before the desalting step, or at the chemical sensitization (from immediately before the start of the chemical sensitization to immediately after the completion of the chemical sensitization), or at a step just before the coating, and more preferably within a period from the chemical sensitization to a time just before the mixing with a non-photosensitive organic silver halide.

The compound of the types 1 to 5 of the invention is added preferably after being dissolved in water, a water-soluble solvent such as methanol or ethanol, or a mixture thereof. In the case of dissolving the compound in water, a compound that changes its solubility depending on pH may be dissolved at a higher or lower pH to increase the solubility.

The compound of the types 1 to 5 of the invention is preferably used in an emulsion layer including a photosensitive silver halide and a non-photosensitive organic silver salt, however it may be added in a protective layer or an intermediate layer in addition to an emulsion layer which includes a photosensitive silver halide and a non-photosensitive organic silver salt, and may be diffused at the coating. In both cases where the compound of the invention is added before the addition of a sensitizing dye and where the compound of the invention is added after the addition of a sensitizing dye, the compound of the invention is included in the silver halide emulsion layer in an amount of 1×10⁻⁹ to 5×10⁻¹ moles per 1 mole of silver halide, more preferably 1×10⁻⁸ to 5×10⁻² moles.

10) Simultaneous Use of Silver Halides

A single type of photosensitive silver halide emulsion in the photothermographic material of the invention may be used. Also, two or more types of photosensitive silver halide emulsions (which differ from each other in, for example, average grain size, halogen composition, crystalline habit, or chemical sensitizing conditions) may be used. A gradation may be controlled by using plural kinds of photosensitive silver halides having different sensitivities. Technologies relating thereto are described for example in JP-A Nos. 57-119341, 53-106125, 47-3929, 48-55730, 46-5187, 50-73627 and 57-150841. As to the sensitivity difference, each emulsion has a sensitivity which is different from the other emulsions preferably by at least 0.2 logE.

11) Coating Amount

An addition amount of the photosensitive silver halide, in terms of a coated silver amount per 1 m² of the photosensitive material, is preferably 0.03 to 0.6 g/m², more preferably 0.05 to 0.4 g/m², and most preferably 0.07 to 0.3 g/m². With respect to 1 mole of organic silver salt, the photosensitive silver halide is preferably present in an amount within a range of 0.01 to 0.5 moles, more preferably 0.02 to 0.3 moles and further preferably 0.03 to 0.2 moles.

12) Mixing of Photosensitive Silver Halide and Organic Silver Salt

As to a method and conditions of mixing the photosensitive silver halide and the organic silver salt, prepared separately, there may be employed a method of mixing the photosensitive silver halide and the organic silver salt with a high-speed agitator, a ball mill, a sand mill, a colloid mill, a vibration mill or a homogenizer, or a method of mixing the already prepared photosensitive silver halide in the course of preparation of the organic silver salt and completing the preparation of the organic silver salt, however no particular limitation exists as long as the effect of the invention can be sufficiently exhibited. It is also preferred, for controlling the photographic characteristics, to mix two or more aqueous dispersions of organic silver salts and two or more aqueous dispersions of photosensitive silver salts.

13) Addition of Silver Halide to Coating Solution

The silver halide of the invention is added to a coating solution for image forming layer, in a period from 180 minutes before coating to immediately before coating, preferably from 60 minutes to 10 seconds before coating, however a mixing method and a mixing condition are not particularly restricted as long as the effect of the invention can be sufficiently exhibited. Specific examples of the mixing method include a mixing method in a tank, so as to obtain a desired average stay time calculated from a flow rate of addition and a liquid supply rate to a coater, and a method of using a static mixer described for example in N. Hamby, M. F. Edwards and A. W. Nienow, Ekitai Kongou Gijutsu (Liquid mixing technology), translated by Koji Takahashi and published by Nikkan Kogyo Shimbun, 1989, Chapter 8.

(Explanation of Antifoggant)

An antifoggant, a stabilizer and a stabilizer precursor employable in the invention can be compounds described in JP-A No. 10-62899, paragraph 0070, EP-A No. 0803764A1, page 20, line 57 to page 21, line 7, JP-A Nos. 9-281637 and 9-329864, U.S. Pat. No. 6,083,681, and European Patent No. 1048975. Also an antifoggant advantageously employed in the invention is an organic halogen compound, which can be compounds described in JP-A No. 11-65021, paragraphs 0111-0112. There are particularly preferred an organic halogen compound represented by the formula (P) in JP-A No. 2000-284399, an organic halogen compound represented by the general formula (II) in JP-A No. 10-339934, and an organic polyhalogen compound described in JP-A Nos. 2001-31644 and 2001-33911.

(Explanation of Polyhalogen Compound)

In the following, an organic polyhalogen compound preferred in the invention will be explained in detail. A polyhalogen compound preferred in the invention is represented by the following general formula (H).
Q-(Y)ₙ—C(Z₁)(Z₂)X General formula (H):

In the general formula (H), Q represents an alkyl group, an aryl group or a heterocyclic group; Y represents a divalent connecting group; n represents 0 or 1; Z₁ and Z₂ each independently represent a halogen atom; and X represents a hydrogen atom or an electron attracting group.

In the general formula (H), Q is preferably an aryl group or a heterocyclic group.

In the case where Q is a heterocyclic group in the general formula (H), Q is preferably a nitrogen-containing heterocyclic group including 1 or 2 nitrogen atoms, and particularly preferably a 2-pyridyl group or a 2-quinolyl group.

In the case Q is an aryl group in the general formula (H), Q preferably represents a phenyl group substituted by an electron attracting group which has a positive Hammett's substituent constant σp. As to the Hammett's substituent constant, reference may be made for example to Journal of Medicinal Chemistry, 1973, Vol. 16, No. 11, 1207-1216.

Such electron attracting group can be, for example, a halogen atom (such as fluorine atom (σp: 0.06), a chlorine atom (σp: 0.23), a bromine atom (σp: 0.23) or an iodine atom (σp: 0.18)), a trihalomethyl group (such as tribromomethyl (σp: 0.29), trichloromethyl (σp: 0.33) or trifluoromethyl (σp: 0.54)), a cyano group (σp: 0.66), a nitro group (σp: 0.78), an aliphatic, aryl or heterocyclic sulfonyl group (such as methanesulfonyl (σp: 0.72)), an aliphatic, aryl or heterocyclic acyl group (such as acetyl (σp: 0.50) or benzoyl (σp: 0.43)), an alkinyl group (such as C≡CH (σp: 0.23)), an aliphatic, aryl or heterocyclic oxycarbonyl group (such as methoxycarbonyl (σp: 0.45) or phenoxycarbonyl (σp: 0.44)), a carbamoyl group (σp: 0.36), a sulfamoyl group (σp: 0.57), a sulfoxide group, a heterocyclic group or a phosphoryl group. The σp value is preferably within a range of 0.2 to 2.0, more preferably 0.4 to 1.0. The electron attracting group is particularly preferably a carbamoyl group, an alkoxycarbonyl group, an alkylsulfonyl group, or an alkylphosphoryl group, and most preferably a carbamoyl group.

X is preferably an electron attracting group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group or a sulfamoyl group, and particularly preferably a halogen atom. The halogen atom is preferably a chlorine atom, a bromine atom or an iodine atom, further preferably a chlorine atom or a bromine atom and particularly preferably a bromine atom.

Y preferably represents —C(═O)—, —SO— or —SO₂—, more preferably —C(═O)— or —SO₂—, and particularly preferably —SO₂—, and n represents 0 or 1, preferably 1.

In the following, specific examples of the compound of the general formula (H) are shown.

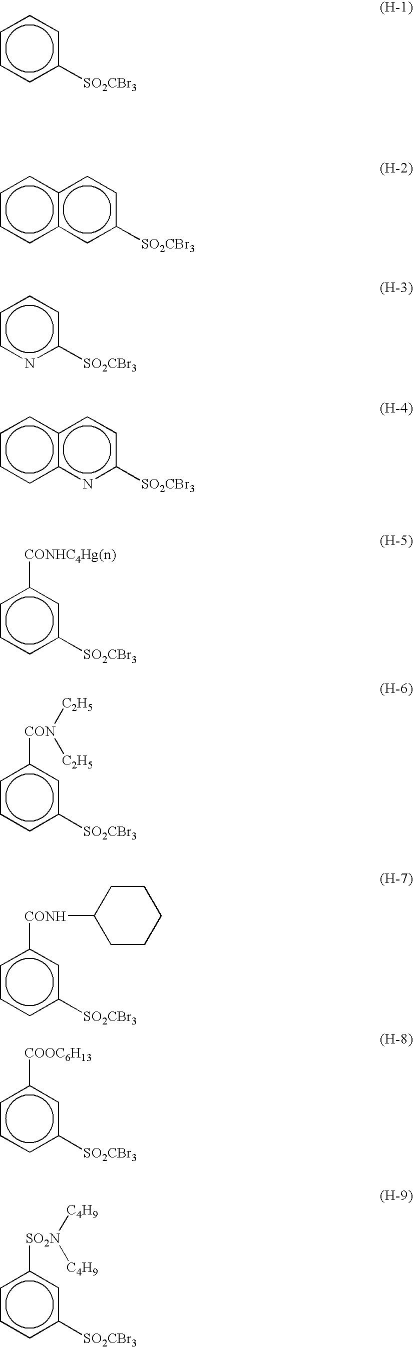

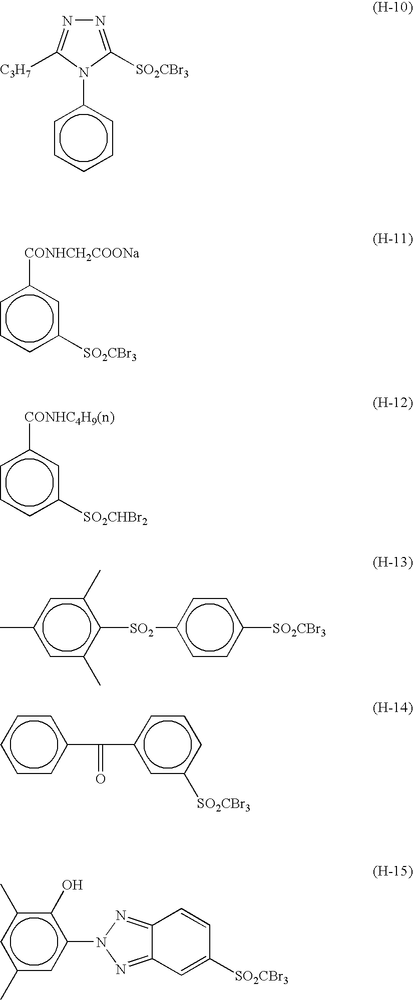

The polyhalogen compound preferable in the invention, other than those described above, can be the polyhalogen compounds described in JP-A Nos. 2001-31644, 2001-56526 and 2001-209145.

The compound of the general formula (H) of the invention is preferably used in an amount of 10⁻⁴ to 1 mole per 1 mole of the non-photosensitive silver salt in the image forming layer, more preferably 10⁻³ to 0.5 moles, and further preferably 1×10⁻² to 0.2 moles.

In the invention, the antifoggant can be added to the photosensitive material by the aforementioned method for adding the reducing agent to the photosensitive material, and it is also preferable to add the organic polyhalogen compound in a state of a solid particle dispersion.

2) Other Antifoggants

As another antifoggant, there may be employed a mercury (11) salt described in JP-A No. 11-65021, paragraph 0113, a benzoic acid described in paragraph 0114 therein, a salicylic acid derivative described in JP-A No. 2000-206642, a formalin scavenger compound represented by the formula (S) in JP-A No. 2000-221634, a triazine compound described in claim 9 of JP-A No. 11-352624, a compound represented by the general formula (III) in JP-A No. 6-11791, 4-hydroxy-6-methyl-1,3,3 a,7-tetrazaindene, or the like.

The photothermographic material of the invention may include an azolium salt for the purpose of fog prevention. The azolium salt can be a compound represented by the general formula (XI) in JP-A No. 59-193447, a compound described in JP-B No. 55-12581, or a compound represented by the general formula (II) in JP-A No. 60-153039. The azolium salt may be added to any part of the photosensitive material, but, as to a layer of addition, it is preferably added in a layer on the photosensitive layer side having and more preferably added to the organic silver salt containing layer. The azolium salt may be added in any step of preparation of the coating solution, and, in the case of an addition to the organic silver salt containing layer, in any step from the preparation of the organic silver salt to the preparation of the coating solution, but preferably within a period from after the preparation of the organic silver salt to immediately before the coating. The azolium salt may be added in any manner, such as powder, a solution or a dispersion of fine particles. Also it may be added as a mixed solution with another additive such as a sensitizing dye, a reducing agent or a toning agent. In the invention, the azolium salt may be added in any amount, but there is preferred an amount from 1×10⁻⁶ to 2 moles per 1 mole of silver, more preferably from 1×10⁻³ to 0.5 moles per 1 mole of silver.

(Other Additives)

1) Mercapto, Disulfide and Thion

In the invention, for the purposes of controlling development by suppression or acceleration, improving an efficiency of spectral sensitization, improving preservability before and after the development, etc., there may be included a mercapto compound, a disulfide compound and a thion compound such as the compounds described in JP-A No. 10-62899, paragraphs 0067-0069, the compounds represented by the general formula (I) in JP-A No. 10-186572 and specific example described in paragraphs 0033-0052 of JP-A No. 10-186572, and the compounds described in EP-A No. 0803764A1, page 20, lines 36-56. Among these, particularly preferred is a mercapto-substituted heteroaromatic compound described, for example, in JP-A Nos. 9-297367, 9-304875 and 2001-100358 and JP-A Nos. 2002-303954 and 2002-303951.

2) Toning Agent

In the photothermographic material of the invention, a toning agent is preferably added. The toning agent is described in JP-A No. 10-62899, paragraphs 0054-0055, EP-A No. 0803764A1, p. 21, lines 23 to 48, JP-A Nos. 2000-356317 and 2000-187298, and there is preferred a phthalazinone (phthalazinone, a phthalazinone derivative or a metal salt thereof, such as 4-(1-naphthyl)phthalazinone, 6-chlorophthalazinone, 5,7-dimethoxyphthazinone or 2,3-dihydro-1,4-phthalazindione); a combination of a phthalazinone and a phthalic acid (such as phthalic acid, 4-methylphthalic acid, 4-nitrophthalic acid, diammonium phthalate, sodium phthalate, potassium phthalate or tetrachlorophthalic anhydride); a phthalazine (phthalazine, a phthalazine derivative or a metal salt thereof, such as 4-(1-naphthyl)phthalazine, 6-isopropylphthalazine, 6-t-butylphthalazine, 6-chlorophthalazine, 5,7-dimethoxyphthalazine or 2,3-dihydrophthalazine); or a combination of a phthalazine and a phthalic acid, and, more preferred is a combination of a phthalazine and a phthalic acid. Among such combination, particularly preferred is a combination of 6-isopropylphthazine and phthalic acid or a combination of 6-isopropylphthazine and 4-methylphthalic acid.

3) Plasticizer, Lubricant

A plasticizer and a lubricant employable in the invention are described in JP-A No. 11-65021, paragraph 0117. The lubricant is described also in JP-ANos. 11-84573, paragraphs 0061-0064 and 2001-83679, paragraphs 0053-0065.

4) Dye, Pigment

In the photosensitive layer of the invention, for the purposes of color tone improvement, prevention of generation of interference fringes at the laser exposure and prevention of irradiation, there may be employed various dyes and pigments (for example C. I. Pigment Blue 60, C. I. Pigment Blue 64, or C. I. Pigment Blue 15:6). These are described in detail for example in WO98/36322, and JP-A Nos. 10-268465 and 11-338098.

5) Ultra-High Contrast Agent

For forming an ultra high contrast image suitable for printing platemaking, it is preferable to add an ultra-high contrast agent in the image forming layer. The ultra-high contrast agent, a method of addition thereof and an amount of addition thereof are described for example in JP-A No. 11-65021, paragraph 0118, JP-A No. 11-223898, paragraphs 0136-0193, JP-A No. 2000-284399, formulas (H), (1) to (3), (A) and (B), JP-A No. 2000-347345, general formulas (III) to (V) (specific compounds in formulas 21-24), while a high-contrast promoting agent is described in JP-A No. 11-65021, paragraph 0102 and JP-A No. 11-223898, paragraphs 0194-0195.

In order to employ formic acid or a formate salt as a strong fogging substance, such a compound is preferably added in a side having the image forming layer, which contains photosensitive silver halide, in an amount of 5 mmol or less per 1 mole of silver, more preferably 1 mmol or less per 1 mole of silver.

In the case of employing an ultra-high contrast agent in the photothermographic material of the invention, it is preferable to use, in combination, an acid formed by hydration of phosphorous pentoxide or a salt thereof. Examples of the acid formed by hydration of phosphorous pentoxide or the salt thereof include metaphosphoric acid (and salt thereof), pyrophosphoric acid (and salt thereof), orthophosphoric acid (and salt thereof), triphosphoric acid (and salt thereof), tetraphosphoric acid (and salt thereof), and hexametaphosphoric acid (and salt thereof). An acid formed by hydration of phosphorous pentoxide or a salt thereof, that can be particularly preferably employed, is orthophosphoric acid (or salt thereof), or hexametaphosphoric acid (or salt thereof). Specific examples of salt include sodium orthophosphate, sodium dihydrogen orthophosphate, sodium hexametaphosphate and ammonium hexametaphosphate.

The amount (coating amount per 1 m² of the photosensitive material) of the acid formed by hydration of phosphorous pentoxide or the salt thereof to be used may be suitably selected according to desired performances such as the sensitivity or the fog level, however is preferably 0.1 to 500 mg/m² and more preferably 0.5 to 100 mg/m².

The reducing agent, the hydrogen bonding compound, the development accelerator and the polyhalogen compound of the invention are preferably used in a form of a solid dispersion, and a preferable production method of such solid dispersion is described in JP-A No. 2002-55405.

(Preparation of Coating Solution and Coating)

A coating solution for the image forming layer of the invention is preferably prepared at a temperature from 30° C. to 65° C., more preferably at a temperature which is not less than 35° C. and less than 60° C., further preferably a temperature from 35° C. to 55° C. Also the coating solution for the image forming layer is preferably maintained, immediately after the addition of polymer latex, at a temperature from 30° C. to 65° C.

(Layer Configuration and Components)

According to the invention, at least one image forming layer is provided on a substrate. In the case where only one image forming layer is provided, the image forming layer comprises an organic silver salt, a photosensitive silver halide, a reducing agent and a binder, and optionally includes (a) desired additional material(s) such as a toning agent, an auxiliary coating agent, and other auxiliary agents, if necessary. In the case where multiple image forming layers are provided, a first image forming layer (usually adjacent to the substrate), a second image forming layer, and the other image forming layers each comprise at least an photosensitive silver salt and a binder, at least one of the image forming layers comprises an organic silver salt and a reducing agent, and a toning agent, a coating auxiliary, or another auxiliary may be included in at least one of the image forming layers in accordance with necessity. In a configuration of a multi-color photothermographic material, a combination of these two layers may be included for each color, or, as described in U.S. Pat. No. 4,708,928, all the components may be included within a single layer. In the case of a multi-dye, multi-color photothermographic material, emulsion layers are generally maintained in a separate state, as described in U.S. Pat. No. 4,460,681, by employing a functional or non-functional barrier layer between the photosensitive layers.

The photothermographic material of the invention may include a non-photosensitive layer in addition to the image forming layer. The non-photosensitive layer can be classified, based on a position thereof, into (a) a surface protective layer provided on the image forming layer (namely farther from the substrate), (b) an intermediate layer provided between plural image forming layers or between an image forming layer and a protective layer, (c) an undercoat layer formed between an image forming layer and the substrate, and (d) a back layer formed at a side opposite to the image forming layer.

There may also be provided a layer functioning as an optical filter, which is formed as a foregoing layer (a) or (b). Also an antihalation layer is provided as a foregoing layer (c) or (d) in the photosensitive material.

1) Surface Protective Layer

The photothermographic material of the invention may have a surface protective layer, for example for preventing sticking of the image forming layer. A single surface protective layer or multiple surface protective layers may be formed.

The surface protective layer is described in JP-A No. 11-65021, paragraphs 0119-0120, and JP-A No. 2000-171936.

As a binder for the surface protective layer of the invention, gelatin is preferred, but it is also preferable to use polyvinyl alcohol (PVA) singly or in combination with gelatin. For the gelatin, there can be employed inert gelatin (for example NITTA GELATIN 750) or phthalated gelatin (for example NITTA GELATIN 801). As PVA, there can be employed one described in JP-A No. 2000-171936, paragraphs 0009-0020, and there can be preferably employed a completely saponified product such as PVA-105, a partially saponified product such as PV-205, PVA-335, or a modified polyvinyl alcohol such as MP-203 (foregoing being trade names of Kuraray Co.). A coating amount of polyvinyl alcohol (per 1 m² of substrate) in the protective layer (per one layer) is preferably 0.3 to 4.0 g/m², more preferably 0.3 to 2.0 g/m².

The total coating amount (per 1 m² of substrate) of the binder (including amounts of water-soluble polymer and latex polymer) in the surface protective layer (per one layer) is preferably 0.3 to 5.0 g/m², more preferably 0.3 to 2.0 g/m².

2) Antihalation Layer

In the photothermographic material of the invention, an antihalation layer may be provided on a side of the photosensitive layer which side is farther from the exposure light source.

The antihalation layer is described in JP-A No. 11-65021, paragraphs 0123-0124, JP-ANos. 11-223898, 9-230531, 10-36695, 10-104779, 11-231457, 11-352625 and 11-352626.

The antihalation layer includes an antihalation dye having an absorption in the exposure wavelength. In the case the exposure wavelength is in an infrared region, an infrared-absorbing dye may be employed, and, in such case, there is preferred a dye which has no absorption in the visible region.

In the case of antihalation with a dye having an absorption in the visible region, it is preferred that the color of the dye does not substantially remain after the image formation. It is preferable to employ means for decolorizing the dye by the heat at the thermal development, and particularly preferable to add a thermally decolorable dye and a base precursor to the non-photosensitive layer thereby achieving a function as an antihalation layer. Such technology is described for example in JP-A No. 11-231457.

An amount of addition of the decolorable dye is determined according to the purpose of the dye. In general it is used in such an amount that the optical density (absorbance) measured at a target wavelength is higher than 0.1. The optical density is preferably within a range from 0.15 to 2, more preferably 0.2 to 1. An amount of the dye to be used for obtaining such optical density is generally within a range of about 0.001 to 1 g/m².

By decolorizing the dye, it is possible to reduce the optical density after thermal development to 0.1 or less. It is also possible to use two or more decolorable dyes in combination, in a thermally decolorable recording material or in a photothermographic material. Similarly, it is possible to use two or more base precursors in combination.

In such thermal decoloring utilizing a thermally decolorable dye and a base precursor, it is preferable, from the viewpoint of the thermal decoloring property, to further use a substance (such as diphenylsulfon, 4-chlorophenyl(phenyl)sulfon or 2-naphthyl benzoate) that can lower the melting point by 3° C. or more when mixed with the base precursor, as described in JP-A No. 11-352626.

3) Back Layer

A back layer that can be employed in the invention is described in JP-A No. 11-65021, paragraphs 0128-0130.

In the invention, a coloring agent having an absorption maximum at 300 to 450 nm may be added in order to improve a tone of silver image and a time-dependent change of the image. Such coloring agent is described for example in JP-A Nos. 62-210458, 63-104046, 63-103235, 63-208846, 63-306436, 63-314535, 01-61745 and 2001-100363.

Such coloring agent is added usually within a range of 0.1 mg/m² to 1 g/m², and preferably added in a back layer formed on the side of the support opposite to the photosensitive layer side.

Also for adjusting a base color tone, it is preferable to use a dye having an absorption peak at 580 to 680 nm. For the dye of such purpose, there is preferred a dye with a low absorption intensity at a shorter wavelength, such as an oil-soluble azomethine dye described in JP-A Nos. 4-359967 and 4-359968, or a water-soluble phthalocyanine dye described in Japanese Patent Application No. 2002-96797. The dye for such purpose may be added in any layer, but is preferably added in a non-photosensitive layer on the emulsion surface side, or in a layer on the back surface side.

The photothermographic material of the invention is preferably so-called one-side photosensitive material, having at least a photosensitive layer containing a silver halide emulsion on a side of a substrate, and a back layer on the other side.

4) Matting Agent

In the invention, it is preferable to add a matting agent for improving a transporting property. The matting agent is described in JP-A No. 11-65021, paragraphs 0126-0127. A coating amount of the matting agent per 1 m² of the photosensitive material is preferably 1 to 400 mg/m², more preferably 5 to 300 mg/m².

In the invention, the matting agent may have a fixed shape or an amorphous shape, however it is preferably of a fixed shape and a spherical shape is employed preferably. An average particle size is preferably 0.5 to 10 μm, more preferably 1.0 to 8.0 μm and further preferably 2.0 to 6.0 μm. Also a variation factor of the size distribution is preferably 50% or less, more preferably 40% or less and further preferably 30% or less. The variation factor is represented by (standard deviation of particle diameter)/(average of particle diameter)×100. It is also preferable to use, in combination, two matting agents having low variation factors and having a ratio of the average particle sizes larger than 3.

A matting degree of an emulsion surface may be arbitrarily selected as long as so-called stardust failure is not generated, but is preferably within a range of Beck's smoothness of 30 to 2000 seconds, particularly preferably 40 to 1500 seconds. The Beck's smoothness can be easily determined by JIS P8119 “Smoothness testing method with Beck's tester for paper and board”, and TAPPI standard method T479.

In the invention, a matting degree of the back layer is preferably within a range of Beck's smoothness of 1200 to 10 seconds, more preferably 800 to 20 seconds and further preferably 500 to 40 seconds.

In the invention, the matting agent is preferably included in the outermost surface layer of the photosensitive material, a layer functioning as the outermost surface layer, or a layer close to the external surface, and it is preferably included in a layer functioning as a protective layer.

5) Polymer Latex

A polymer latex can be preferably employed in a surface protective layer or in a back layer, in the case the photothermographic material of the invention is applied to a printing application, in which application, a dimensional change causes a problem. Such polymer latex is described for example in Gosei Jushi Emulsion (edited by Taira Okuda and Hiroshi Inagaki, published by Kobunshi Kankokai (1978)), Gosei Latex no Ouyou, (edited by Takaaki Sugimura, Yasuo Kataoka, Soichi Suzuki and Keiji Kasahara, published by Kobunshi Kankokai (1993)), and Gosei Latex no Kagaku (Soichi Muroi, published by Kobunshi Kankokai (1970)), and can more specifically be a latex of a methyl methacrylate (33.5 mass %)/ethyl acrylate (50 mass %)/methacrylic acid (16.5 mass %) copolymer, a latex of a methyl methacrylate (47.5 mass %)/butadiene (47.5 mass %)/itaconic acid (5 mass %) copolymer, a latex of an ethyl acrylate/methacrylic acid copolymer, a latex of a methyl methacrylate (58.9 mass %)/2-ethylhexyl acrylate (25.4 mass %)/styrene (8.6 mass %)/2-hydroxyethyl methacrylate (5.1 mass %)/acrylic acid (2.0 mass %) copolymer, a latex of a methyl methacrylate (64.0 mass %)/styrene (9.0 mass %)butyl acrylate (20.0 mass %)/2-hydroxyethyl methacrylate (5.0 mass %)/acrylic acid (2.0 mass %) copolymer, etc. Also as a binder for the surface protective layer, there may be applied a combination of polymer latexes described in JP-A No. 2000-267226, a technology described in JP-A No. 2000-267226, paragraphs 0021-0025, a technology described in JP-A No. 2000-267226, paragraphs 0027-0028, or a technology described in JP-A No. 2000-19678, paragraphs 0023-0041. A proportion of the polymer latex(es) in the surface protective layer is preferably 10 to 90 mass % with respect to the total amount of the binder, particularly preferably 20 to 80 mass %.

6) Film Surface pH

The photothermographic material of the invention preferably has a film surface pH of 7.0 or less before the thermal development, more preferably 6.6 or less. A lower limit of the film surface pH is not particularly restricted but is generally about 3. The most preferred pH range is from 4 to 6.2. For regulating the film surface pH, there can be preferably employed an organic acid such as a phthalic acid derivative, a non-volatile acid such as sulfuric acid, or a volatile base such as ammonia, in view of lowering the film surface pH. In particular, ammonia is preferable for attaining a low film surface pH, as it is easily volatilize and can be removed in the coating step or before the thermal development.

It is also preferable to employ a non-volatile base such as sodium hydroxide, potassium hydroxide or lithium hydroxide in combination with ammonia. A measuring method for the film surface pH is described in JP-A No. 2000-284399, paragraph 0123.

7) Hardening Agent

A hardening agent may be used in the photosensitive layer, the protective layer, or the back layer of the photothermographic material of the invention. Examples of the hardening agent are described in T. H. James, “The Theory of the Photographic Process Fourth Edition” (Macmillan Publishing Co. Inc., 1977) pp. 77-87, and there can be preferably employed chromium alum, sodium 2,4-dichloro-6-hydroxy-s-triazine, N,N-ethylenebis(vinylsulfonacetamide), N,N-propylenebis(vinylsulfonacetamide), a polyvalent metal ion described in p. 78 of the aforementioned reference, a polyisocyanate described in U.S. Pat. No. 4,281,060, JP-A No. 6-208193, etc., an epoxy compound described in U.S. Pat. No. 4,791,042, etc. and a vinylsulfone compound described in JP-A No. 62-89048, etc.

The hardening agent is added as a solution, and a timing of addition of such solution to the coating solution for the protective layer is within a period from 180 minutes before the coating operation to a time immediately before the coating operation, preferably within a period from 60 minutes before the coating operation to 10 seconds before the coating operation, but a mixing method and a mixing condition are not particularly restricted as long as the effect of the invention can be sufficiently exhibited. Specific examples of the mixing method include a mixing method in a tank for obtaining a desired average stay time based on a flow rate of addition and a liquid supply rate to a coater, and a method of utilizing a static mixer, as described in N. Hamby, M. F. Edwards, A. W. Nienow, Ekitai Kongou Gijutsu (Liquid Mixing Technologies) (translated by Koji Takahashi, Nikkan Kogyo Shimbunsha, 1989), chapter 8.

8) Surfactant

A surfactant employable in the invention is described in JP-A No. 11-65021, paragraph 0132. Also JP-A No. 11-65021 describes a solvent in paragraph 0133, a substrate in paragraph 0134, an antistatic agent or a conductive layer in paragraph 0135, and a method for obtaining a color image in paragraph 0136. Also a lubricant is described in JP-A No. 11-84573, paragraphs 0061-0064 and JP-A No. 2001-83679, paragraphs 0053-0065.

In the invention, it is preferred to employ a fluorine-type surfactant. Preferred specific examples of the fluorine-type surfactant include the fluorine-type surfactants described in JP-A Nos. 10-197985, 2000-19680 and 2000-214554. There can also be preferably employed the fluorine-type polymer surfactants described in JP-A No. 9-281636. In the photothermographic material of the invention, it is particularly preferable to employ the fluorine-type surfactants described in JP-A Nos. 2002-82411, 2003-057780, and 2003-149766. In particular, the fluorine-type surfactants described in JP-A Nos. 2003-057780 and 2003-149766 are preferable in charge controlling ability, stability of a coated surface and lubricating property in the case of executing a coating with an aqueous coating solution, and the fluorine-type surfactants described in JP-A No. 20013-149766 are most preferable because it has a high charge controlling ability, thus an amount of the fluorine-type surfactant to be used can be reduced.

In the invention, the fluorine-type surfactant can be employed in either of the emulsion face and the back face, and can be preferably employed in both surfaces. It is particularly preferable to employ it in combination with a conductive layer which includes the aforementioned metal oxide. In such a case, sufficient performance can be obtained even when the amount of a fluorine-type surfactant(s) on the side having the conductive layer is reduced or when a fluorine-type surfactant(s) is/are not used on the side having the conductive layer.

An amount of the fluorine-type surfactant to be used, in each of the emulsion face and the back face, is preferably within a range of 0.1 to 100 mg/m², more preferably 0.3 to 30 mg/m², and further preferably 1 to 10 mg/m². In particular, a fluorine-type surfactant described in JP-A No. 2003-149766 has a remarkable effect and is employed preferably within a range of 0.01 to 10 mg/m², more preferably 0.1 to 5 mg/m².

9) Antistatic Agent

In the invention, a conductive layer including a metal oxide or a conductive polymer is preferably provided. The antistatic layer may simultaneously be the undercoat layer, the back layer or the surface protective layer, or may be formed separately. The conductive material in the antistatic layer may preferably be a metal oxide whose conductivity has been improved by introducing an oxygen defect or a hetero-metal atom therein. Preferable examples of the metal oxide include ZnO, TiO₂ and SnO₂, and there is preferred an addition of Al or In to ZnO, an addition of Sb, Nb, P or a halogen element to SnO₂, or an addition of Nb, Ta, or the like to TiO₂. A metal oxide obtained by adding Sb to SnO₂ is particularly preferable. An amount of a hetero-atom to be added is preferably within a range of 0.01 to 30 mol. %, more preferably 0.1 to 10 mol. %. A shape of the metal oxide can be spherical, acicular or plate-shaped, but, in consideration of a conductivity imparting effect, there is preferred an acicular particle with a longer axis/shorter axis ratio of 2.0 or higher, preferably 3.0 to 50. An amount of the metal oxide to be used is preferably within a range of 1 to 1000 mg/m², more preferably 10 to 500 mg/m², and further preferably 20 to 200 mg/m². The antistatic layer of the invention may be provided on either of the emulsion side and the back side, but is preferably provided between the substrate and the back layer. Specific examples of the antistatic layer of the invention are described in JP-A No. 11-65021, paragraph 0135, JP-A Nos. 56-143430, 56-143431, 58-62646 and 56-120519, JP-A No. 11-84573, paragraphs 0040-0051, U.S. Pat. No. 5,575,957 and JP-A No. 11-223898, paragraphs 0078-0084.

10) Substrate

A transparent substrate may be preferably a polyester, particularly polyethylene terephthalate, which has been subjected to a heat treatment at a temperature of from 130 to 185° C. in order to relax an internal strain remaining in the film at a biaxial drawing and to eliminate a thermal shrinking strain generated at the thermal development. In a photothermographic material for medical use, the transparent substrate may be colored with a blue dye (for example a dye 1 described in examples of JP-A No. 8-240877), or may be colorless. It is preferable to apply, to the substrate, an undercoating process, for example, with a water-soluble polyester described in JP-A No. 11-84574, a styrene-butadiene copolymer described in JP-A No. 10-186565, a vinylidene chloride copolymer described in JP-A Nos. 2000-39684 and 2001-83679, paragraphs 0063-0080. At the coating of the emulsion layer or the back layer on the substrate, the substrate preferably has a moisture content of 0.5 wt. % or less.

11) Other Additives

In the photothermographic material, there may be further added an antioxidant, a stabilizer, a plasticizer, an ultraviolet absorber or an auxiliary coating agent. These additives are added either in the photosensitive layer or in the non-photosensitive layer. For these, for example, WO No. 98/36322, EP No. 803764A1, JP-A Nos. 10-186567 and 10-18568 can be referenced.

12) Coating Method

The photothermographic material of the invention may be coated by any coating method. More specifically, various coating methods are applicable, such as extrusion coating, slide coating, curtain coating, dip coating, knife coating, flow coating and extrusion coating utilizing a hopper of a kind described in U.S. Pat. No. 2,681,294. The extrusion coating described in Stephen F. Kistler and Petert M. Schweizer, “Liquid Film Coating” (Chapman & Hall, 1997), pp. 399-536, and slide coating can be preferably employed. And slide coating is particularly preferable. An example of a shape of a slide coater to be used in the slide coating is shown in FIG. 11b.1 in the above-mentioned reference, p. 427. Also, if desired, two or more layers can be simultaneously applied by a method described in the above-mentioned reference, pp. 399-536, or methods described in U.S. Pat. No. 2,761,791 and BP No. 837,095. A coating method which can be particularly preferably employed in the invention is a method described in JP-A Nos. 2001-194748, 2002-153808, 2002-153803, and 2002-182333.

The coating solution for the organic silver salt-containing layer of the invention is preferably so-called thixotropic fluid. With respect to such technology, JP-A No. 11-52509 can be referenced. The coating solution for the organic silver salt-containing layer of the invention preferably has a viscosity at a shear speed of 0.1 S⁻¹ within a range of from 400 to 100,000 mPa·s, and more preferably 500 to 20,000 mPa·s. Also a viscosity at a shear speed of 1000 S⁻¹ is preferably within a range of from 1 to 200 mPa·s, and more preferably 5 to 80 mPa·s.

In the preparation of the coating solution of the invention, when two solutions are mixed, a known in-line mixer or an in-plant mixer can be preferably used. An in-line mixer and an in-plant mixer preferred in the invention are described in JP-A Nos. 2002-85948 and 2002-90940, respectively.

The coating solution of the invention is preferably subjected to a defoaming process in order to maintain a excellent coated surface. A deforming process which can be preferably employed in the invention is described in JP-A No. 2002-66431.

In applying the coating solution of the invention, a charge elimination is preferably executed in order to prevent deposition of dusts and particles by charging of the substrate. An example of a charge eliminating method preferably employed in the invention is described in JP-A No. 2002-143747.

In the invention, in order to dry a non-setting-type coating solution for the image forming layer, it is important to precisely control drying air and drying temperature. A drying method preferred in the invention is described in detail in JP-A Nos. 2001-194749 and 2002-139814.

In the photothermographic material of the invention, a heat treatment is preferably applied immediately after coating-drying, in order to improve a film forming property. The heat treatment is executed at a film surface temperature preferably within a range of 60 to 100° C. and with a heating time of 1 to 60 seconds. More preferably, the film surface temperature is within a range of 70 to 90° C., and the heating time is within a range of 2 to 10 seconds. A method of heat treatment preferred in the invention is described in JP-A No. 2002-107872.

Also for continuous manufacture of the photothermographic material of the invention in stable manner, the producing methods described in JP-A Nos. 2002-156728 and 2002-182333 can be preferably employed.

The photothermographic material is preferably a mono-sheet type (capable of forming an image on the photothermographic material, without requiring another sheet such as an image receiving material).

13) Packaging Material

The photothermographic material of the invention is preferably packaged by a packaging material having a low oxygen permeation rate and/or a low moisture permeation rate, in order to avoid an alteration of the photographic performance during storage before use, or to suppress a curling or a bending. The oxygen permeation rate at 25° C. is preferably 50 ml/atm·m²·day or less, more preferably 10 ml/atm·m² day or less, and further preferably 1.0 ml/atm·m²·day or less. The moisture permeation rate is preferably 10 g/atm·m²·day or less, more preferably 5 g/atm·m² day or less, and further preferably 1 g/atm·m² day or less.

Specific examples of the packaging material having a low oxygen permeation rate and/or a low moisture permeation rate include the packaging materials described in JP-A Nos. 8-254793 and 2000-206653.

14) Other Applicable Technologies

In the photothermographic material of the invention, other technologies are also applicable, such as those described in EP No. 803764A1, EP No. 883022A1, WO No. 98/36322, JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064 and 2000-171936.

In a multi-color photothermographic material, the emulsion layers are mutually separated, as described in U.S. Pat. No. 4,460,681, by a functional or non-functional barrier layer between the photosensitive layers.

In a multi-color photothermographic material, a combination of these two layers may be included for each color, or all the components may be included in a single layer as described in U.S. Pat. No. 4,708,928.

(Image Forming Method)

1) Exposure

The exposure can be conducted with an He—Ne laser emitting red to infrared light, a semiconductor laser emitting red light, an Ar⁺, He—Ne or He—Cd laser emitting blue to green light, or a semiconductor laser emitting blue light. A semiconductor laser emitting red to infrared light is preferable, and a peak wavelength of the laser light is 600 to 900 nm, preferably 620 to 850 nm. On the other hand, a laser output apparatus of a short wavelength region is recently attracting particular attention, with the development of an integrated module of an SHG (second harmonic generator) element and a semiconductor laser, and of a blue light-emitting semiconductor laser. Demand for the blue light-emitting semiconductor laser is anticipated to increase hereafter, since such laser is capable of recording of a high-definition image, achieving an increase in the recording density and providing a stable output with a long service life. A peak wavelength of the blue laser light is 300 to 500 nm, preferably 400 to 500 nm.

A laser light oscillated in a vertical multi mode, for example, by a high frequency superposing method can also be employed advantageously.

2) Thermal Development

The photothermographic material of the invention may be developed by any method, and is usually developed by elevating the temperature of the photothermographic material which has been exposed imagewise. The developing temperature is 80 to 250° C., preferably 100 to 140° C., and more preferably 110 to 130° C. The developing time is preferably 1 to 60 seconds, more preferably 3 to 30 seconds and further preferably 5 to 25 seconds, particularly preferably 7 to 15 seconds.

For thermal development, a drum heater or a plate heater can be used, however a plate heater method is preferable. With respect to thermal development with a plate heater method, the method described in JP-A No. 11-133572 is preferable, employing a thermal development apparatus which brings a photothermographic material containing a latent image in contact with heating means in a thermal development unit thereby obtaining a visible image, wherein the heating means is a plate heater, while plural pressing rollers are positioned along a surface of the plate heater, and the photothermographic material is passed between the pressing rollers and the plate heater to execute thermal development. It is preferable to provide 2 to 6 stages of plate heaters and to lower the temperature of the leading end stage by 1 to 10° C. An example utilizes four sets of plate heaters which can be independently temperature controlled and which are respectively controlled at 112, 119, 121 and 120° C. Such method, described also in JP-A No. 54-30032, allows to eliminate moisture or organic solvent, contained in the photothermographic material, from the system, and to suppress a change in the shape of the substrate of the photothermographic material that can be caused by rapid heating of the photothermographic material.

For compactizing the thermal developing apparatus and reducing the thermal developing time, a stabler heater control is preferable, and it is also preferable to execute an exposure from the leading end of a photosensitive sheet and to initiate the thermal development before the trailing end of the photosensitive sheet is exposed. An imager capable of a rapid processing preferred in the invention is described, for example, in JP-A Nos. 2002-289804 and 2002-287668. Such imager allows to execute a thermal development in 14 seconds with 3-stage plate heaters controlled at 107′-121′-121° C., and to shorten an output time of a first sheet to about 60 seconds. For such rapid processing, a photothermographic material which has a high sensitivity and is scarcely influenced by the ambient temperature can be preferably used in combination.

3) System

An example of a laser imager system for medical use, having an exposure unit and a thermal development unit, is Fuji Medical Dry Imager FM-DPL. This system is described in Fuji Medical Review No. 8, p. 39-55, and such described technology is naturally applicable to the laser imager of the photothermographic material of the invention. Also the photothermographic material of the invention can be utilized as a photothermographic material for a laser imager in an AD NETWORK, proposed by Fuji Medical Co. as a network system meeting the DICOM standard.

(Application of Invention)

The photothermographic material of the invention forms a black-and-white image by a silver image, and is preferably utilized as a photothermographic material for medical diagnosis, a photothermographic material for industrial photography, a photothermographic material for printing and a photothermographic material for COM.

### EXAMPLES

In the following, the present invention will be further explained by utilizing examples thereof, but the invention is not limited by such examples.

### Example 1

(Preparation of PET Substrate)

1) Film Formation

Terephthalic acid and ethylene glycol were employed in an ordinary method to obtain a PET having an intrinsic viscosity IV=0.66 (measured at 25° C. in phenol/tetrachloroethane=6/4 (weight ratio)). It was pelletized, then dried for 4 hours at 130° C., and fused at 300° C. Then it was extruded from a T-die and cooled rapidly to obtain such an undrawn film that the film thickness after thermal fixation became 175 μm.

The film was then stretched by 3.3 times in the longitudinal direction with rollers having different peripheral velocities, and stretched by 4.5 times in the transversal direction with a tenter. The temperatures were 110° C. and 130° C., respectively. Then, after a thermal fixation for 20 seconds at 240° C., a 4% relaxation in the transversal direction was executed at the same temperature. Then, after portions chucked by the tenter were slit off, knurling was applied to both sides, and the film was wound under a tension of 4 kg/cm² to obtain a roll of a film with a thickness of 175 μm.

2) Surface Treatment with Corona Discharge

A solid-state corona discharge treating apparatus model 6KVA, manufactured by Pillar Inc., was employed to treat both sides of the substrate at a velocity of 20 m/min. Based on current and voltage values read in this operation, it was identified that the substrate was treated under a condition of 0.375 kV·A·min/m². In this treatment, a frequency was 9.6 kHz and a gap clearance between an electrode and a dielectric roll was 1.6 mm.

3) Undercoating

1) Preparation of Coating Solution for Undercoat Layer

| Formulaion (1) (for undercoat layer on the | | |
|---|---|---|
| photosensitive layer side) | | |
| PESRESIN A-520 (30 mass % solution) | 59 | g |
| (manufactured by Takamatsu Yushi Co.) | | |
| polyethylene glycol monononylphenyl ether (average | 5.4 | g |
| number of ethylene oxide = 8.5), 10 mass % solution | | |
| MP-1000 (polymer particles, average particle size | 0.91 | g |
| 0.4 μm) (manufactured by Soken Chemical Co. Ltd.) | | |
| distilled water | 935 | ml |
| Formulation (2) (for first layer on back side) | | |
| styrene-butadiene copolymer latex (solid 40 | 158 | g |
| mass %, styrene/butadiene weight ratio = 68/32) | | |
| 2,4-dichloro-6-hydroxy-S-triazine sodium salt, | 20 | g |
| 8 mass % aqueous solution | | |
| sodium laurylbenzenesulfonate, 1 mass % | 10 | ml |
| aqueous solution | | |
| distilled water | 854 | ml |
| Formulation (3) (for second layer on back side) | | |
| SnO₂/SbO (mass ratio 9/1, average particle size | 84 | g |
| 0.038 μm, 17 mass % dispersion) | | |
| gelatin (10 mass % aqueous solution) | 89.2 | g |
| Metolose TC-5 (2 mass % aqueous solution) | 8.6 | g |
| (manufactured by Shin-etsu Chemical Ltd.) | | |
| MP-1000 (manufactured by Soken Chemical and | 0.01 | g |
| Engneering Co. Ltd.) | | |
| sodium dodecylbenzenesulfonate, | 10 | ml |
| 1 mass % aqueous solution | | |
| NaOH (1 mass %) | 6 | ml |
| Proxel (manufactured by ICI Ltd.) | 1 | ml |
| distilled water | 805 | ml |

2) Undercoating

After conducting the aforementioned corona discharge treatment on both sides of the aforementioned biaxially oriented polyethylene terephthalate substrate having a thickness of 175 μm, the aforementioned undercoating formulation (1) was applied to a side (the photosensitive layer side) by a wire bar with a wet coating amount of 6.6 ml/m² (per one side) and dried for 5 minutes at 180° C. Then the aforementioned undercoating formulation (2) was applied to the rear side (back surface) by a wire bar with a wet coating amount of 5.7 ml/m² and dried for 5 minutes at 180° C., and the aforementioned undercoating formulation (3) was applied to the rear side (back surface) by a wire bar with a wet coating amount of 7.7 ml/m² and dried for 6 minutes at 180° C. to obtain an undercoated substrate.

(Back Layer)

1) Preparation of Coating Solutions for Back Layer

(Preparation of Dispersion (a) of Base Precursor Solid Fine Particles)

2.5 kg of base precursor compound 1, 300 g of a surfactant (trade name: DEMOL N, manufactured by Kao Corp.), 800 g of diphenylsulfone, 1.0 g of benzoisothiazolinone sodium salt, and distilled water for increasing the total amount to 8.0 kg, were mixed, and the mixture was subjected to a bead dispersion by a horizontal sand mill (trade name: UVM-2, Imex Co.). The dispersion was conducted by feeding the mixture by a diaphragm pump to the UVM-2 sand mill filled with zirconia beads having an average diameter of 0.5 mm and continuing dispersion at an internal pressure of 50 hPa or higher until a desired average diameter of the particles was obtained.

The dispersion was conducted until a ratio of absorbances at 450 nm and 650 nm (D450/D650) became 3.0, which absorbances were measured spectroscopically. The obtained dispersion was diluted with distilled water so as to obtain a concentration of the base precursor of 25 wt. % and was filtered (with a polypropylene filter having an average pore size of 3 μm) for dust elimination.

2) Preparation of Dispersion of Dye Solid Fine Particles

6.0 kg of a cyanine dye compound-1, 3.0 kg of sodium p-dodecylbenzenesulfonate, 0.6 kg of surfactant DEMOL SNB (trade name, manufactured by Kao Corp.), 0.15 kg of a defoamer (trade name: SURFINOL 104E, manufactured by Nisshin Kagaku Co.) and distilled water were mixed to obtain a total amount of 60 kg. The mixture was dispersed in a horizontal sand mill UVM-2 manufactured by Imex Co. with zirconia beads having an average diameter of 0.5 mm.

The dispersion was conducted until the absorbance ratio (D650/D750) of an absorbance at 650 nm and an absorbance at 750 nm reached 5.0 or higher, which absorbance was measured spectroscopically. After the dispersion, the dispersion was diluted with distilled water so as to obtain a concentration of the cyanine dye of 6 wt. % and was filtered with a filter (average pore size: 1 μm) for dust elimination.

3) Preparation of Coating Solution for Antihalation Layer

A container was maintained at 40° C., and 40 g of gelatin, 20 g of mono-dispersed polymethyl methacrylate particles (average particle size: 8 μm, a standard deviation of particle size: 0.4), 0.1 g of benzoisothiazolinone, and 490 ml of water were added to the container and the gelatin was dissolved. Then 2.3 ml of a 1 mol/l aqueous solution of sodium hydroxide, 40 g of the aforementioned dispersion of dye solid fine particles, 90 g of the aforementioned dispersion (a) of base precursor solid fine particles, 12 ml of a 3% aqueous solution of sodium polystyrenesulfonate, and 180 g of a 10% solution of SBR latex were mixed with the gelatin solution. 80 ml of a 4% aqueous solution of N,N-ethylenebis(vinylsulfonacetamide) was mixed with the solution immediately before coating to obtain a coating solution for antihalation layer.

4) Preparation of Coating Solution for Back Protective Layer

A container was maintained at 40° C., and 40 g of gelatin, 35 mg of benzoisothiazolinone, and 840 ml of water were added to the container and the gelatin was dissolved. Then 5.8 ml of a 1 mol/l aqueous solution of sodium hydroxide, a liquid paraffin emulsion containing 1.5 g of liquid paraffin, 10 ml of a 5% aqueous solution of sodium di(2-ethylhexyl)sulfosuccinate, 20 ml of a 3% aqueous solution of sodium polystyrenesulfonate, 2.4 ml of a 2% solution of a fluorine-type surfactant (F-1), 2.4 ml of a 2% solution of a fluorine-type surfactant (F-2) and 32 g of a 19 mass % latex of a methyl methacrylate/styrene/butyl acrylate/hydroxyethyl methacrylate/acrylic acid copolymer (copolymerization weight ratio: 57/8/28/5/2) were mixed. 25 ml of a 4% aqueous solution of N,N-ethylenebis(vinylsulfonacetamide) were mixed with the gelatin solution immediately before coating to obtain a coating solution for back protective layer.

4) Coating of Back Layer

On the back surface of the aforementioned undercoated substrate, the coating solution for antihalation layer and the coating solution for back protective layer were simultaneously multi-layer coated in such amounts that the amounts of coated gelatin became 0.52 g/m² (in the case of the coating solution for antihalation layer) and 1.7 g/m² (in the case of the coating solution for back protective layer), respectively, and dried to obtain a back layer.

(Image Forming Layer, Intermediate Layer and Surface Protective Layer)

1. Preparation of Coating Materials

1) Silver Halide Emulsion

<<Preparation of Silver Halide Emulsion 1>>

A solution, obtained by adding 3.1 ml of a 1 mass % solution of potassium bromide, 3.5 ml of sulfuric acid of a concentration of 0.5 mol/L and 31.7 g of phthalated gelatin to 1421 ml of distilled water, was maintained at 30° C. under agitation in a stainless steel reaction vessel. Then, a solution A formed by dissolving 22.22 g of silver nitrate in distilled water to give the total amount of 95.4 ml and a solution B formed by dissolving 15.3 g of potassium bromide and 0.8 g of potassium iodide in distilled water to give the total amount of 97.4 ml, were added under constant flow rates and over a period of 45 seconds. Then 10 ml of a 3.5 mass % aqueous solution of hydrogen peroxide was added to the solution, and 10.8 ml of a 10 mass % aqueous solution of benzimidazole was added to the solution. Then, a solution C formed by diluting 51.86 g of silver nitrate with distilled water to 317.5 ml and a solution D formed by diluting 44.2 g of potassium bromide and 2.2 g of potassium iodide with distilled water to 400 ml, were added to the solution in the reaction vessel, wherein the whole solution C was added under a constant flow rate and over a period of 20 minutes, and the solution D was added by a controlled double jet method at a constant pAg value of 8.1. At 10 minutes after the start of the addition of the solutions C and D, potassium hexachloroiridate (III) was added in an amount of 1×10⁻⁴ mole per 1 mole of silver. Also at 5 seconds after the completion of the addition of the solution C, an aqueous solution of potassium hexacyanoferrate (II) was added in an amount of 3×10⁻⁴ moles per 1 mole of silver.

Then pH value was adjusted to 3.8 with sulfuric acid of a concentration of 0.5 mol/L. Then the agitation was terminated and precipitation/desalting/rinsing steps were executed. The pH value was adjusted to 5.9 with sodium hydroxide of a concentration of 1 mol/L, thereby obtaining a silver halide dispersion having a pAg value of 8.0.

The aforementioned silver halide dispersion was maintained at 38° C. under agitation. Thereto, 5 ml of a 0.34 mass % methanol solution of 1,2-benzoisothiazolin-3-one was added. 40 minutes later, the dispersion was heated to 47° C. At 20 minutes after the temperature elevation, sodium benzenethiosulfonate in methanol was added in an amount of 7.6×10⁻⁵ mole per 1 mole of silver. Then after further 5 minutes, a tellurium sensitizer C in methanol was further added in an amount of 2.9×10⁻⁴ mole per 1 mole of silver, and a ripening was executed for 91 minutes. Thereafter, a spectral sensitizing dye A and a sensitizing dye B with a molar ratio of 3:1 in methanol were added in an amount of 1.2×10⁻³ mole per 1 mole of silver in terms of the sum of the amounts of the sensitizing dyes A and B. 1 minute later, 1.3 ml of a 0.8 mass % methanol solution of N,N′-dihydroxy-N″-diethylmelamine was added. After further 4 minutes, 5-methyl-2-mercaptobenzimidazole in methanol in an amount of 4.8×10⁻³ mole per 1 mole of silver, 1-phenyl-2-heptyl-5-mercapto-1,3,4-triazole in methanol in an mount of 5.4×10⁻³ mole per 1 mole of silver, and sodium 1-(3-methylureide)-5-mercaptotetrazole in water in an amount of 8.5×10⁻³ mole per 1 mole of silver, were added to prepare a silver halide emulsion 1.

Thus prepared silver halide emulsion included silver iodobromide grains having an average sphere-corresponding diameter of 0.042 μm and a variation factor of the sphere-corresponding diameter of 20% and uniformly containing iodine in 3.5 mol. %. The grain size, etc. were determined from the average for 1000 grains, utilizing an electron microscope. The grains had a [100] plane ratio of 80%, as determined by a Kubelka-Munk method.

<<Preparation of Silver Halide Emulsion 2>>

A silver halide emulsion 2 was prepared in the same manner as the silver halide emulsion 1, except that the solution temperature at grain formation was changed from 30° C. to 47° C., that the solution B was prepared by diluting 15.9 g of potassium bromide with distilled water to 97.4 ml, that the solution D was prepared by diluting 45.8 g of potassium bromide with distilled water to 400 ml, that the solution C was added over 30 minutes, and that potassium hexacyanoferrate (II) was not used. The precipitation/desalting/rinsing steps were executed in the same manner as in the preparation of the silver halide emulsion 1. Thereafter the spectral sensitization, chemical sensitization and additions of 5-methyl-2-mercaptobenzimidazole and 1-phenyl-2-heptyl-5-mercapto-1,3,4-triazole were conducted in the same manner as in the silver halide emulsion 1 except that the addition amount of the tellurium sensitizer C was changed to an amount of 1.1×10⁻⁴ moles per 1 mole of silver, that the spectral sensitizing dye A and the spectral sensitizing dye B with a molar ratio of 3:1 in methanol were added in an amount of 7.0×10⁻⁴ mole per 1 mole of silver in terms of the sum of the amounts of the sensitizing dyes A and B, that the addition amount of 1-phenyl-2-heptyl-5-mercapto-1,3,4-triazole was changed to 3.3×10⁻³ moles per 1 mole of silver, and that the addition amount of sodium 1-(3-methylureide)-5-mercaptotetrazole was changed to 4.7×10⁻³ mole per 1 mole of silver, thereby obtaining a silver halide emulsion 2. The silver halide emulsion 2 included pure silver bromide cubic grains having an average sphere-corresponding diameter of 0.080 μm and a variation factor of the sphere-corresponding diameter of 20%.

<<Preparation of Silver Halide Emulsion 3>>

A silver halide emulsion 3 was prepared in the same manner as the emulsion 1, except that the solution temperature at grain formation was changed from 30° C. to 27° C. The precipitation/desalting/rinsing steps were executed in the same manner as in the preparation of the silver halide emulsion 1. A silver halide emulsion 3 was obtained in the same manner as that in the case of the silver halide emulsion 1, except that the spectral sensitizing dye A and the sensitizing dye B in a molar ratio of 1:1 were added as a solid dispersion (in aqueous gelatin solution) in an amount of 6×10⁻³ mole per 1 mole of silver in terms of the sum of the sensitizing dyes A and B, that the addition amount of the tellurium sensitizer C was changed to 5.2×10⁴ mole per 1 mole of silver, and that bromoauric acid in an amount of 5×10⁻⁴ mole per 1 mole of silver and potassium thiocyanate in an amount of 2×10⁻³ mole per 1 mole of silver were added at 3 minutes after the addition of the tellurium sensitizer. The silver halide emulsion 3 included silver iodobromide grains having an average sphere-corresponding diameter of 0.034 μm and a variation factor of the sphere-corresponding diameter of 20%, uniformly containing 3.5 mol. % of iodine.

<<Preparation of Mixed Emulsion A for Coating Solution>>

The silver halide emulsion 1 by 70 mass %, the silver halide emulsion 2 by 15 mass % and the silver halide emulsion 3 by 15 mass % were dissolved, and benzothiazolium iodide in a form of a 1 mass % aqueous solution was added in an amount of 7×10⁻³ mole per 1 mole of silver. Then water was added so as to obtain a silver halide content corresponding to 38.2 g of silver per 1 kg of the mixed emulsion for coating solution, and 1-(3-methylureide)-5-mercaptotetrazole sodium salt was added in an amount of 0.34 g per 1 kg of the mixed emulsion for coating solution.

Also as “a compound whose a 1-electron oxidized form, formed by a 1-electron oxidation, is capable of releasing 1 or more electrons”, compounds 1, 20 and 26 were added respectively in an amount of 2×10⁻³ moles per 1 mole of silver of the silver halide.

2) Preparation of Fatty Acid Silver Salt Dispersion

Preparation of a Fatty Acid Silver Salt Dispersion B

(Preparation of Recrystallized Behenic Acid)

100 kg of behenic acid (trade name: EDENOR C22-85R, manufactured by Henkel Co.) were mixed with 1200 kg of isopropyl alcohol, dissolved at 50° C., then filtered with a 10 μm filter and cooled to 30° C. to execute recrystallization. A cooling speed at the recrystallization was controlled at 3° C./hr. Obtained crystals were separated by centrifugation, then washed by pouring 100 kg of isopropyl alcohol and dried. A GC-FID measurement on an ester of the obtained crystals proved that the crystal had the behenic acid content of 96%, lignoseric acid content of 2%, arachidic acid content of 2% and erucic acid content of 0.001%.

(Preparation of Fatty Acid Silver Salt Dispersion B)

88 kg of recrystallized behenic acid, 422 l of distilled water, 49.2 l of a 5 mol/l aqueous solution of NaOH, and 120 l of t-butyl alcohol were mixed and reacted under agitation for 1 hour at 75° C. to obtain a sodium behenate solution B. Separately, 206.2 l of an aqueous solution (pH 4.0) of 40.4 kg of silver nitrate were prepared and maintained at 10° C. A reaction vessel containing 635 l of distilled water and 30 l of t-butyl alcohol was maintained at 30° C., and the entire amount of the sodium behenate solution B and the entire amount of the silver nitrate solution were added under sufficient agitation with constant flow rates, over 93 minutes and 15 seconds and over 90 minutes, respectively. In this operation, during 11 minutes from the start of the addition of the silver nitrate solution, the silver nitrate solution alone was added, then the addition of the sodium behenate solution B was started, and, during 14 minutes and 15 seconds after the completion of the addition of the silver nitrate solution, the sodium behenate solution B alone was added. In this operation, the temperature in the reaction vessel was maintained at 30° C., and the external temperature was controlled such that the solution temperature was kept constant. Also a piping for adding the sodium behenate solution B was temperature controlled by circulating warm water in the inter-tube space of the double tubes, thereby adjusting the solution temperature at an exit end of the addition nozzle at 75° C. Also a piping for adding the silver nitrate solution was temperature controlled by circulating cold water in the space inside the double tube, i.e. the space in between the outer tube and the inner tube. A position of addition of the sodium behenate solution B and a position of addition of the silver nitrate solution were symmetrically positioned with respect to an agitating shaft, and were adjusted at such a height not touching the reaction solution.

After the end of addition of the sodium behenate solution B, the reaction solution was let to stand for 20 minutes at a same temperature and under agitation, then heated to 35° C. over a period of 30 minutes, and was thereafter ripened for 210 minutes. Immediately after the completion of the ripening, solid was separated by a centrifuging filtration and was washed with water until the conductivity of the water which had passed the filter became 30 μS/cm. A fatty acid silver salt was obtained in this manner. The obtained solid was not dried but stored in a wet cake.

The shape of the obtained silver behanate grains was evaluated by electron photomicrographs. The crystal had the average values of a=0.21 μm, b=0.4 μm and c=0.4 μm, the average aspect ratio of 2.1, and the variation factor of the sphere-corresponding diameter of 11% (a, b and c being defined in the present specification).

To the wet cake corresponding to 260 kg of dry solid, 19.3 kg of polyvinyl alcohol (trade name: PVA-217) and water were added to give the total amount of 1000 kg. The mixture was converted to a slurry by dissolver blades and pre-dispersed by a pipeline mixer (model PM-10; manufactured by Mizuho Kogyo Co.).

Then the pre-dispersed liquid was treated three times with a disperser (trade name: MICROFLUIDIZER M-610, manufactured by Microfluidics International Corporation;

2 with a Z-type interaction chamber) at a pressure of 1150 kg/cm², thereby obtaining a silver behenate dispersion. The dispersion temperature of 18° C. was obtained by mounting spiral-piped heat exchangers in front of and behind the interaction chamber and regulating the temperature of a coolant.

3) Preparation of Reducing Agent Dispersion

<<Preparation of Reducing Agent-1 Dispersion>>

10 kg of a reducing agent-1 (2,2′-methylenebis-(4-ethyl-6-tert-butylphenol)), 16 kg of a 10 mass % aqueous solution of modified polyvinyl alcohol (POVAL MP203, manufactured by Kuraray Co.), and 10 kg of water were added and mixed well to obtain a slurry. The slurry was fed by a diaphragm pump, then dispersed for 3 hours by a horizontal sand mill (UVM-2; manufactured by Imex Co.) filled with zirconia beads having an average diameter of 0.5 mm, and 0.2 g of sodium benzoisothiazolinone and water were added to obtain a concentration of the reducing agent of 25 mass %. The dispersion was kept at 60° C. for 5 hours to obtain a reducing agent-1 dispersion. The reducing agent particles contained in thus obtained reducing agent dispersion had a median diameter of 0.40 μm and a maximum particle diameter of 1.4 μm or less. The obtained reducing agent dispersion was stored after a filtration with a polypropylene filter having a pore size of 3.0 μm for eliminating foreign substances such as dusts.

<<Preparation of Reducing Agent-2 Dispersion>>

10 kg of a reducing agent-2 (6,6′-di-t-butyl-4,4′-dimethyl-2,2′-butylidenediphenol), 16 kg of a 10 mass % aqueous solution of modified polyvinyl alcohol (POVAL MP203, manufactured by Kuraray Co.), and 10 kg of water were mixed well to obtain a slurry. The slurry was fed by a diaphragm pump, then dispersed for 3 hours and 30 minutes by a horizontal sand mill (UVM-2; manufactured by Imex Co.) filled with zirconia beads of an average diameter of 0.5 mm, and 0.2 g of sodium benzoisothiazolinone and water were added to obtain a concentration of the reducing agent of 25 mass %. The dispersion was kept at 40° C. for 1 hour and subsequently at 80° C. for 1 hour to obtain a reducing agent-2 dispersion. The reducing agent particles contained in thus obtained reducing agent dispersion had a median diameter of 0.50 μm and a maximum particle diameter of 1.6 μm or less. The obtained reducing agent dispersion was stored after a filtration with a polypropylene filter having a pore size of 3.0 μm for eliminating foreign substances such as dusts.

4) Preparation of Hydrogen Bonding Compound-1 Dispersion

10 kg of a hydrogen bonding compound-1 (tri(4-t-butylphenyl)phosphinoxide), 16 kg of a 10 mass % aqueous solution of modified polyvinyl alcohol (POVAL MP203, manufactured by Kuraray Co.), and 10 kg of water were mixed well to obtain a slurry. The slurry was fed by a diaphragm pump, then dispersed for 4 hours in a horizontal sand mill (UVM-2; manufactured by Imex Co.) filled with zirconia beads having an average diameter of 0.5 mm, and 0.2 g of sodium benzoisothiazolinone and water were added thereto to obtain a concentration of the hydrogen bonding compound of 25 mass %. The dispersion was kept at 40° C. for 1 hour and subsequently at 80° C. for 1 hour to obtain a hydrogen bonding compound-1 dispersion. The particles of the hydrogen bonding compound contained in thus obtained hydrogen bonding compound dispersion had a median diameter of 0.45 μm and a maximum particle diameter of 1.3 μm or less. The obtained hydrogen bonding compound dispersion was stored after a filtration with a polypropylene filter having a pore size of 3.0 μm for eliminating foreign substances such as dusts.

5) Preparation of Development Accelerator-1 Dispersion

10 kg of a development accelerator-1, 20 kg of a 10 mass % aqueous solution of modified polyvinyl alcohol (POVAL MP203, manufactured by Kuraray Co.), and 10 kg of water were mixed well to obtain a slurry. The slurry was fed by a diaphragm pump, then dispersed for 3 hours and 30 minutes in a horizontal sand mill (UVM-2; manufactured by Imex Co.) filled with zirconia beads having an average diameter of 0.5 mm, and 0.2 g of sodium benzoisothiazolinone and water were added thereto to obtain a concentration of the development accelerator of 20 mass % thereby obtaining a development accelerator-1 dispersion. The particles of the development accelerator contained in thus obtained development accelerator dispersion had a median diameter of 0.48 μm and a maximum particle diameter of 1.4 μm or less. The obtained development accelerator dispersion was stored after a filtration with a polypropylene filter having a pore size of 3.0 μm for eliminating foreign substances such as dusts.

6) Preparation of Dispersions of Development Accelerator-2 and Color Tone Controlling Agent-1

Solid dispersions of a development accelerator-2 and a color tone controlling agent-1 were also prepared by a process similar to that for the development accelerator-1, thereby obtaining 20 mass % dispersion of the development accelerator-2 and 15 mass % dispersion of the color tone controlling agent-1, respectively.

7) Preparation of Polyhalogen Compound

<<Preparation of Organic Polyhalogen Compound-1 Dispersion>>

10 kg of an organic polyhalogen compound-1 (tribromomethanesulfonylbenzene), 10 kg of a 20 mass % aqueous solution of modified polyvinyl alcohol (POVAL MP203, manufactured by Kuraray Co.), 0.4 kg of a 20 mass % aqueous solution of sodium triisopropylnaphthalene-sulfonate and 14 kg of water were mixed well to obtain a slurry. The slurry was fed by a diaphragm pump, then dispersed for 5 hours by a horizontal sand mill (UVM-2; manufactured by Imex Co.) filled with zirconia beads having an average diameter of 0.5 mm, and 0.2 g of sodium benzoisothiazolinone and water were added thereto to obtain a concentration of the organic polyhalogen compound of 26 mass % thereby obtaining an organic polyhalogen compound-1 dispersion. The particles of the organic polyhalogen compound contained in thus obtained organic polyhalogen compound dispersion had a median diameter of 0.41 μm and a maximum particle diameter of 2.0 μm or less. The obtained organic polyhalogen compound dispersion was stored after a filtration with a polypropylene filter having a pore size of 10.0 μm for eliminating foreign substances such as dusts.

<<Preparation of Organic Polyhalogen Compound-2 Dispersion>>

10 kg of an organic polyhalogen compound-2 (N-butyl-3-tribromomethanesulfonylbenzamide), 20 kg of a 10 mass % aqueous solution of modified polyvinyl alcohol (POVAL MP203, manufactured by Kuraray Co.) and 0.4 kg of a 20 mass % aqueous solution of sodium triisopropylnaphthalenesulfonate were mixed well to obtain a slurry. The slurry was fed by a diaphragm pump, then dispersed for 5 hours by a horizontal sand mill (UVM-2; manufactured by Imex Co.) filled with zirconia beads having an average diameter of 0.5 mm, and 0.2 g of sodium benzoisothiazolinone and water were added thereto to obtain a concentration of the organic polyhalogen compound of 30 mass %. The dispersion was kept at 40° C. for 5 hours to obtain an organic polyhalogen compound-2 dispersion. The particles of the organic polyhalogen compound contained in thus obtained organic polyhalogen compound dispersion had a median diameter of 0.40 μm and a maximum particle size of 1.3 μm or less. The obtained organic polyhalogen compound dispersion was stored after a filtration with a polypropylene filter having a pore size of 3.0 μm for eliminating foreign substances such as dusts.

8) Preparation of Phthalazine Compound-1 Solution

8 kg of modified polyvinyl alcohol (MP203, manufactured by Kuraray Co.) was dissolved in 174.57 kg of water, and 3.15 kg of a 20 mass % aqueous solution of sodium triisopropylnaphthalenesulfonate and 14.28 kg of a 70 mass % aqueous solution of a phthalazine compound-1 (6-isopropylphthalazine) were added thereto to obtain a 5 mass % solution of the phthalazine compound-1.

9) Preparation of Mercapto Compound

<<Preparation of Aqueous Solution of Mercapto Compound-1>>

7 g of a mercapto compound-(1-(3-sulfophenyl)-5-mercaptotetrazole sodium salt) were dissolved in 993 g of water to obtain a 0.7 mass % aqueous solution.

<<Preparation of Aqueous Solution of Mercapto Compound-2>>

20 g of a mercapto compound-2 (1-(3-methylureido)-5-mercaptotetrazole sodium salt) were dissolved in 980 g of water to obtain a 2.0 mass % aqueous solution.

10) Preparation of Pigment-1 Dispersion

64 g of C.I. Pigment Blue 60, 6.4 g of DEMOL N (manufactured by Kao Corp.) and 250 g of water were added and mixed well to obtain a slurry. The slurry was put in a vessel together with 800 g of zirconia beads having an average diameter of 0.5 mm, then dispersed for 25 hours by a disperser (1/4G sand grinder mill, manufactured by Imex Co.) and water was added to give a concentration of the pigment of 5 mass %, thereby obtaining a pigment-1 dispersion. The pigment particles contained in thus obtained pigment dispersion had an average particle size of 0.21 μm.

11) Preparation of Binder Solution

(Binder of the Present Invention)

As the binder, each of polymer latexes of the aforementioned example compounds (P-1), (P-12) and (P-25) was used by adjusting pH to 8.35 with 25% NH₄OH. Thereafter, a binder solution having a solid concentration of 44 mass % was obtained by a filtration with a polypropylene filter having a pore size of 1.0 μm for eliminating foreign substances such as dusts.

(Comparative Binder RP-1) (SBR)

As a binder for a comparative sample, an example compound (P-1) described in JP-A No. 2002-229149 was synthesized and processed in the same manner as explained above to obtain a comparative binder RP-1 (styrene/butadiene/acrylic acid=68/29/3 mass %, Tg=17° C., solid content 44 mass %, particle size 80 nm).

(Comparative Binder RP-2)

A binder was synthesized in the same manner as in the synthesis example 1 except that the amount of styrene was changed to 496.8 g, the amount of isoprene was changed to 27 g and the amount of acrylic acid was changed to 16.2 g and processed in the same manner as explained above to obtain a comparative binder RP-2 (styrene/isoprene/acrylic acid=92/5/3 mass %, Tg=86° C., solid content 44 mass %, particle size 115 nm).

(Comparative Binder RP-3)

A binder was synthesized in the same manner as in the synthesis example 2 except that the amount of styrene was changed to 118.8 g, the amount of isoprene was changed to 405 g and the amount of acrylic acid was changed to 16.2 g and processed in the same manner as explained above to obtain a comparative binder RP-3 (styrene/isoprene/acrylic acid=22/75/3 mass %, Tg=−40° C., solid content 44 mass %, particle size 108 nm).

2. Preparation of Coating Solution

1) Preparation of Coating Solution for Image Forming Layer

(Preparation of Coating Solution-1a for Image Forming Layer)

1000 g of the aforementioned fatty acid silver salt dispersion B, 135 ml of water, 36 g of the pigment-1 dispersion, 14.3 g of the organic polyhalogen compound-1 dispersion, 22.3 g of the organic polyhalogen compound-2 dispersion, 171 g of the phthalazine compound-1 solution, 1060 g of the binder solution (example compound (P-1), latex concentration: 44 mass %), 76 g of the reducing agent-1 dispersion, 77 g of the reducing agent-2 dispersion, 55 g of the hydrogen bonding compound-1 dispersion, 4.8 g of the development accelerator-1 dispersion, 5.2 g of the development accelerator-2 dispersion, 2.1 g of the color tone controlling agent-1 dispersion, and 8 ml of the mercapto compound-2 aqueous solution were mixed in succession, and 140 g of the silver halide mixed emulsion A was added thereto and mixed well immediately before coating, and thus obtained coating solution A1 for image forming layer was directly fed to a coating die and applied.

The coating solution A1 for image forming layer showed a viscosity, when measured by a BROOKFIELD viscosimeter (manufactured by Tokyo Keiki Co.), of 38 [mPa·s] at 40° C. (No. 1 roter, 60 rpm).

The coating solution showed viscosities at 38° C., when measured with a RHEOSTRESS RS150 (manufactured by Haake Inc.), of 31, 42, 40, 26 and 19 [mPa·s], respectively at shear speeds of 0.1, 1, 10, 100 and 1000 [I/sec].

The amount of zirconium in the coating solution was 0.30 mg per 1 g of silver.

(Preparation of Coating Solutions-1B, 1C for Image Forming Layer)

A coating solution-1B for image forming layer was prepared in the same manner as the coating solution-1A for image forming layer except that the development accelerator-2 dispersion was not used.

A coating solution-1C for image forming layer was prepared in the same manner as the coating solution-1A for image forming layer except that the development accelerator-1 dispersion was not used.

(Preparation of Coating Solutions-2(a, B, C) to 6(a, B, C) for Image Forming Layer)

Image forming layer coating solutions 2(A, B, C) to 6(A, B, C) were prepared in a similar manner, with a change in the binder as shown in Table 1.

TABLE 1

| Sample | Image forming layer | | Development | Development | |
|---|---|---|---|---|---|
| No. | coating solution No. | Binder | accele-rator-1 | accele-rator-2 | Remarks |
| 1 | 1A | RP-1 | present | present | comp. ex. |
| 2 | 1B | RP-1 | present | absent | comp. ex. |
| 3 | 1C | RP-1 | absent | present | comp. ex. |
| 4 | 2A | RP-2 | present | present | comp. ex. |
| 5 | 2B | RP-2 | present | absent | comp. ex. |
| 6 | 2C | RP-2 | absent | present | comp. ex. |
| 7 | 3A | RP-3 | present | present | comp. ex. |
| 8 | 3B | RP-3 | present | absent | comp. ex. |
| 9 | 3C | RP-3 | absent | present | comp. ex. |
| 10 | 4A | P-1 | present | present | invention |
| 11 | 4B | P-1 | present | absent | invention |
| 12 | 4C | P-1 | absent | present | invention |
| 13 | 5A | P-12 | present | present | invention |
| 14 | 5B | P-12 | present | absent | invention |
| 15 | 5C | P-12 | absent | present | invention |
| 16 | 6A | P-25 | present | present | invention |
| 17 | 6B | P-25 | present | absent | invention |
| 18 | 6C | P-25 | absent | present | invention |

2) Preparation of Intermediate Layer Coating Solution

1000 g of polyvinyl alcohol PVA-205 (manufactured by Kuraray Co.), 163 g of the pigment-1 dispersion, 33 g of an aqueous solution of a blue dye compound-1 (KAYAFECT TURQUOISE RN LIQUID 150, manufactured by Nippon Kayaku Co.), 27 ml of a 5% aqueous solution of sodium di(2-ethylhexyl)sulfosuccinate, 4200 ml of a 19 mass % latex of methyl methacrylate/styrene/butyl acrylate/hydroxyethyl methacrylate/acrylic acid copolymer (copolymerizing weight ratio: 57/8/28/5/2), 27 ml of a 5 mass % aqueous solution of AEROSOL 0T (manufactured by American Cyanamide Inc.), 135 ml of a 20 mass % aqueous solution of diammonium phthalate, and water to give the total amount of 10000 g were mixed and the pH was adjusted to 7.5 with NaOH to obtain an intermediate layer coating solution, which was supplied to a coating die at such a rate that the coated amount became 8.9 ml/m².

The coating solution showed a viscosity of 58 [mPa·s] when measured with a BROOKFIELD viscosimeter (rotor No. 1, 60 rpm) at 40° C.

3) Preparation of Coating Solution for First Surface Protective Layer

100 g of inert gelatin and 10 mg of benzoisothiazolinone were dissolved in 840 ml of water, then 180 g of a 19 mass % latex of methyl methacrylate/styrene/butyl acrylate/hydroxyethyl methacrylate/acrylic acid copolymer (copolymerizing weight ratio: 57/8/28/5/2), 46 ml of a 15 mass % methanol solution of phthalic acid, and 5.4 ml of a 5 mass % aqueous solution of sodium di(2-ethylhexyl)sulfosuccinate were mixed with the gelatin solution to obtain a coating solution, which, after addition of 40 ml of a 4 mass % solution of chromium alum and mixing by a static mixer immediately before coating, was supplied to a coating die at such a rate that the coated amount became 26.1 ml/m².

The coating solution showed a viscosity of 20 [mPa·s] when measured a BROOKFIELD viscosimeter (rotor No. 1, 60 rpm) at 40° C.

4) Preparation of Coating Solution for Second Surface Protective Layer

100 g of inert gelatin and 10 mg of benzoisothiazolinone were dissolved in 800 ml of water, then 180 g of a 19 mass % latex of methyl methacrylate/styrene/butyl acrylate/hydroxyethyl methacrylate/acrylic acid copolymer (copolymerizing weight ratio: 57/8/28/5/2), 40 ml of a 15 mass % methanol solution of phthalic acid, 5.5 ml of a 1 mass % solution of a fluorine-type surfactant (F-1), 5.5 ml of a 1 mass % solution of a fluorine-type surfactant (F-2), 28 ml of a 5 mass % aqueous solution of sodium di(2-ethylhexyl) sulfosuccinate, 4 g of polymethyl methacrylate fine particles (average particle size 0.7 μm), and 21 g of polymethyl methacrylate fine particles (average particle size 4.5 μm) were mixed with the gelatin solution to obtain a coating solution for the surface protective layer, which was supplied to a coating die with at such a rate that the coated amount became 8.3 ml/m².

The coating solution showed a viscosity of 19 [mPa·s] when measured with a BROOKFIELD viscosimeter (rotor No. 1, 60 rpm) at 40° C.

3. Preparation of Photothermographic Material

Samples 1 to 18 were prepared by simultaneous multi-layer coatings by a slide bead coating method on a side opposite to the back side, in an order, from the undercoated surface, of an image forming layer (image forming layer coating solutions-2(A, B, C)-6(A, B, C)), an intermediate layer, a first surface protective layer, and a second surface protective layer. In this operation, the temperature of the coating solution for image forming layer and the temperature of the coating solution for intermediate layer were controlled at 31° C., the temperature of the coating solution for first surface protective layer was controlled at 36° C., and the temperature of the coating solution for second surface protective layer was 37° C.

In the image forming layer, each compound therein had the following coating amount (g/m²):

| | |
|---|---|
| silver behenate | 5.27 |
| pigment (C.I. Pigment Blue 60) | 0.036 |
| polyhalogen compound-1 | 0.14 |
| polyhalogen compound-2 | 0.28 |
| phthalazine compound-1 | 0.18 |
| binder | 9.43 |
| reducing agent-1 | 0.38 |
| reducing agent-2 | 0.39 |
| hydrogen bonding compound-1 | 0.28 |
| development accelerator-1 | (0.019)* |
| development accelerator-2 | (0.016)* |
| color tone controlling agent-1 | 0.006 |
| mercapto compound-2 | 0.003 |
| silver halide (in terms of silver amount) | 0.13 |

*Development accelerator-1 and -2: sample A contained both the development accelerator-1 and -2; sample B contained the development accelerator-1 and did not contain the development accelerator-2; and sample C contained neither the development accelerator-1 nor the development accelerator-2.

Coating and drying conditions were as follows.

The coating was executed at a speed of 160 m/min, with a gap between a front end of the coating die and the substrate maintained at 0.10 to 0.30 mm, and with a pressure in a reduced-pressure chamber maintained lower than the atmospheric pressure by 196 to 882 Pa. The substrate was subjected, before the coating, to a charge elimination by an ionized air flow.

The coated solutions were cooled in a succeeding chilling zone with an air flow having a dry bulb temperature of 10 to 20° C., then transported in a non-contact manner and dried by a non-contact spiral drying apparatus with a drying air flow having a dry bulb temperature of 23 to 45° C. and a wet bulb temperature of 15 to 21° C.

After the drying, a humidity adjustment was executed at a temperature of 25° C. and in a humidity of 40 to 60% RH, and the film surface was heated to 65 to 85° C. After the heating, the film surface was cooled to 25° C.

The photothermographic material thus prepared had a matting degree, represented by Beck's smoothness, of 520 seconds on the photosensitive layer side and 130 seconds on the back side. Also the side of the photosensitive layer had a film pH of 6.1.

In the following, there are shown chemical structures of compounds employed in the examples of the invention.

Spectral Sensitizing dye A

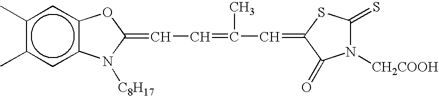

Spectral Sensitizing dye B

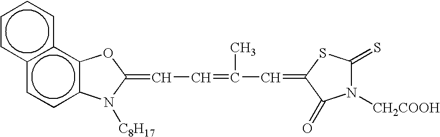

Tellurium Sensitizer C

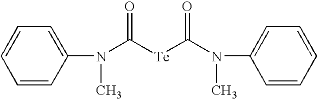

Base Precursor Compound-1

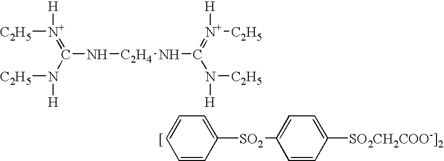

Cyanine Dye Compound-1

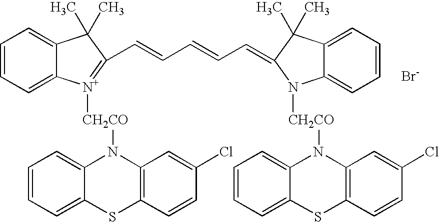

Blue Dye Compound-1

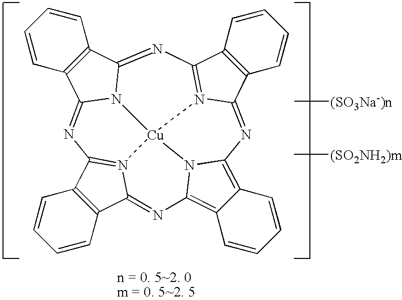

(Reducing Agent-1) (Reducing Agent-2)

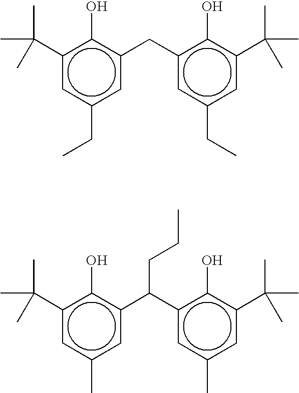

(Hydrogen Bonding Compound-1)

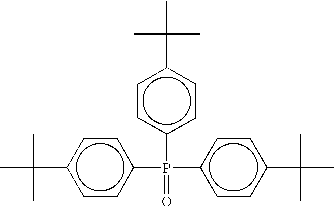

(Polyhalogen Compound-1) (Polyhalogen Compound-2)

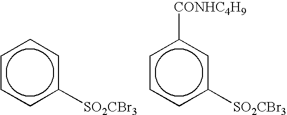

(Mercapto Compound-1) (Mercapto Compound-2)

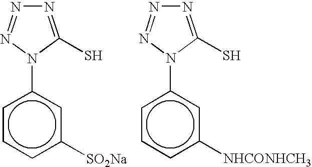

(Phthalazine Compound-1) (Development

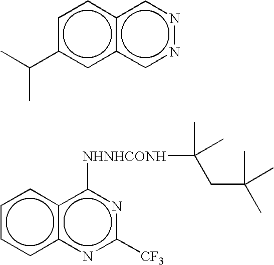

(Development (Color Tone Controlling Agent-1)

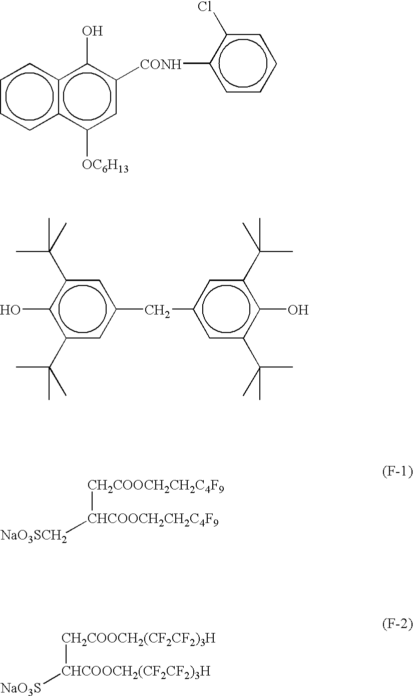

4. Evaluation of Performance

1) Preparation

An obtained sample was cut into a half size (about 30 cm×about 50 cm), then packed in the following packaging material in an environment of 25° C. and 50% RH, and, after a storage for 2 weeks at a normal temperature, subjected to the following evaluations.

2) Packaging Material

A sheet of PET 10 μm/PE 12 μm/aluminum foil 9 μm/nylon 15 μm/polyethylene 50 μm containing 3 mass % of carbon;

oxygen permeation rate: 0.02 ml/atm·m²·25° C. day, moisture permeation rate: 0.10 g/atm·m²·25° C.·day.

3) Exposure and Development of Photosensitive Material

Each sample was exposed by a laser imager described in Japanese Patent Applications Nos. 2002-088832 and 2002-091114 (equipped with a 660 nm semiconductor laser having a maximum output of 50 mW (IIIB) and subjected to a thermal development (for 14 seconds in total with three panels set at 107′-121′-121° C.), and the obtained image was evaluated with a densitometer.

4) Items and Methods of Performance Evaluation

(1) Evaluation of Image Storability

The thermally developed sample was let to stand for 10 days in an environment of 60° C., 40% RH, and the image storability was evaluated by a density change (ΔDmin) in the white background portion between the sample before the standing and the sample after the standing. Results are shown in relative values, taking sample No. 1 as 100.

(2) Evaluation of Sensitivity

A logarithmic value of a reciprocal of a laser output which provided a density of 1.0 was determined, and is represented by a relative value relative to that of the photothermographic material No. 1.

5) Results of Evaluation

The obtained results are shown in Table 2.

As is clear from the table, the samples of the present invention, which utilizes specific polymers as the binder of the image forming layer, had a higher sensitivity and a significantly improved image storability.

Samples 4 to 6 could not be evaluated because of film forming defect.

TABLE 2

| Sample | | Image storability | |
|---|---|---|---|
| No. | Sensitivity | ΔD min after storage | Remarks |
| 1 | 0 | 100 | comp. ex. |
| 2 | −0.05 | 95 | comp. ex. |
| 3 | −0.23 | 81 | comp. ex. |
| 4 | film formation defect | — | comp. ex. |
| 5 | film formation defect | — | comp. ex. |
| 6 | film formation defect | — | comp. ex. |
| 7 | 0.02 | 350 | comp. ex. |
| 8 | −0.05 | 320 | comp. ex. |
| 9 | −0.25 | 280 | comp. ex. |
| 10 | −0.01 | 43 | invention |
| 11 | −0.04 | 31 | invention |
| 12 | −0.35 | 30 | invention |
| 13 | 0 | 35 | invention |
| 14 | −0.03 | 30 | invention |
| 15 | −0.41 | 28 | invention |
| 16 | 0.01 | 41 | invention |
| 17 | −0.02 | 38 | invention |
| 18 | −0.39 | 32 | invention |

### Example 2

Samples 21 to 26 were prepared in the same manner as the sample 10 of the example 1 except that the binder was changed as shown in Table 3.

Table 3 shows the results of the evaluation of the performance of the samples 21-26, evaluated in the same manner as in the example 1.

TABLE 3

| Sample | | | Image storability | |
|---|---|---|---|---|
| No. | Binder | Sensitivity | ΔD min after storage | Remarks |
| 21 | P-2 | 0.01 | 35 | invention |
| 22 | P-8 | −0.01 | 31 | invention |
| 23 | P-9 | −0.01 | 33 | invention |
| 24 | P-16 | −0.01 | 31 | invention |
| 25 | P-19 | 0.02 | 29 | invention |
| 26 | P-28 | 0 | 31 | invention |

### Example 3

A comparative experiment was executed in order to more clearly indicate the effect of the binder and the development accelerator in the invention. What were investigated were the effects of the presence and the absence of the development accelerator in the comparative binder RP-1 on the sensitivity and the image storability and the effects of the presence and the absence of the development accelerator in the binder P-1 of the invention on the sensitivity and the image storability. Samples were prepared according to the example 1, with compositions shown in Table 4. The amounts of the added polyhalogen compound were indicated by relative values, taking the sum of the amount of the polyhalogen compound-1 and the amount of the polyhalogen compound-2 in the example 1 as 1.

TABLE 4

| | | | Addition | | | |
|---|---|---|---|---|---|---|
| | | Development | amount of | | Image | |
| | | accelerator-1 | polyhalogen | | storability | |
| Sample | | and development | compound | | ΔD min after | |
| No. | Binder | accelerator-2 | (relative value) | Sensi-tivity | storage | Remarks |
| 21 | RP-1 | absent | 1 | −0.23 | 81 | comp. ex. |
| 22 | RP-1 | present | 1 | 0 | 100 | comp. ex. |
| 23 | P-1 | absent | 1 | −0.35 | 30 | invention |
| 24 | P-1 | present | 1 | −0.01 | 43 | invention |
| 25 | P-1 | present | 0.75 | 0.11 | 79 | invention |
| 26 | P-1 | present | 0.5 | 0.25 | 101 | invention |

The results shown in Table 4 indicate that the samples of the invention were characterized by an excellent image storability. However a decrease of the polyhalogen compound to about the half amount resulted in an image storability comparable to that in the comparative samples, and provided a sensitivity higher than in the comparative sample, whereby a sample superior in the sensitivity could be obtained.

### Example 4

Preparation of Binder Solution

(Binder of the Invention)

As the binder, each of polymer latexes of the aforementioned example compounds (P-1), (P-2) and (P-4) in the synthesis examples was used by adjusting pH to 8.35 with 25% NH₄OH. Thereafter, a binder solution having a solid concentration of 44 mass % was obtained by a filtration with a polypropylene filter having a pore size of 1.0 μm for eliminating foreign substances such as dusts.

(Comparative Binder RP-4)

A synthesis was conducted under the conditions shown in the foregoing synthesis example of (P-1) with a change of the surfactant to SANDED BL (manufactured by Sanyo Chemical Industries Ltd.) thereby obtaining a latex RP-4 of the following composition and physical properties (composition, Tg, and solid concentration being the same as in P-1, particle size: 107 nm, degree of monodispersion: 1.21, halogen ion concentration: 1500 ppm).

(Comparative Binder RP-5)

A synthesis was conducted under the conditions shown in the foregoing synthesis example of (P-1) with a change of the amount of surfactant (PIONIN A-43-S) to 3.2 g thereby obtaining a latex RP-5 of the following composition and physical properties (composition, Tg, and solid concentration being the same as in P-1, particle size: 550 nm, degree of monodispersion: 1.33, halogen ion concentration: 15 ppm).

(Comparative Binder RP-6)

A synthesis was conducted in the same manner as in RP-4 with a change of the amount of ammonium persulfate to 1.4 g thereby obtaining a latex RP-6 of the following composition and physical properties (composition, Tg, and solid concentration being the same as in P-1, particle size: 115 nm, degree of monodispersion: 1.15, halogen ion concentration: 25 ppm).

2. Preparation of Coating Solution

1) Preparation of Image Forming Layer Coating Solutions-11 to 16

1000 g of the fatty acid silver salt dispersion B of the example 1, 135 ml of water, 36 g of the pigment-1 dispersion of the example 1, 14.3 g of the organic polyhalogen compound-1 dispersion of the example 1, 22.3 g of the organic polyhalogen compound-2 dispersion of the example 1, 171 g of the phthalazine compound-1 solution of the example 1, 1060 g of a binder solution of the invention or the comparative example (described in Table 5), 76 g of the reducing agent-1 dispersion of the example 1, 77 g of the reducing agent-2 dispersion of the example 1, 55 g of the hydrogen bonding compound-1 dispersion of the example 1, 4.8 g of the development accelerator-3 dispersion, 5.2 g of the development accelerator-4 dispersion, 2.1 g of the color tone controlling agent-1 dispersion of the example 1, and 8 ml of the mercapto compound-2 aqueous solution of the example 1 were added in succession, and 140 g of the silver halide mixed emulsion A1 of the example 1 was added and mixed well immediately before coating, and thus obtained coating solution B1 for the image forming layer was directly fed to a coating die and applied.

TABLE 5

| | Binder | | | | |
|---|---|---|---|---|---|
| | | | | Halogen ion | |
| Coating | Latex | Particle size | Degree of | concent-ration | |
| solution No. | No. | (nm) | mono-dispersion | (ppm) | Remarks |
| 31 | RP-4 | 107 | 1.21 | 1500 | comp. ex. |
| 32 | RP-5 | 550 | 1.53 | 15 | comp. ex. |
| 33 | RP-6 | 115 | 1.15 | 25 | comp. ex. |
| 34 | P-1 | 112 | 1.04 | 20 | invention |
| 35 | P-2 | 121 | 1.05 | 9 | invention |
| 36 | P-4 | 105 | 1.03 | 15 | invention |

3. Preparation of Photothermographic Material

1) Preparation of Photothermographic Materials 31-36

Samples 31 to 36 were prepared by simultaneous multi-layer coatings by a slide bead coating method on a side opposite to the back side, in an order, from the undercoated surface, of an image forming layer (image forming layer coating solutions 11-16), an intermediate layer of the example 1, a first surface protective layer of the example 1, and a second surface protective layer of the example 1. In this operation, the temperature of the coating solutions for image forming layer and the temperature of the coating solution for intermediate layer were controlled at 31° C., the temperature of the coating solution for first surface protective layer was controlled at 36° C., and the temperature of the coating solution for second surface protective layer was controlled at 37° C.

In the image forming layer, each compound therein had the following coating amount (g/m²):

| | |
|---|---|
| silver behenate | 5.27 |
| pigment (C.I. PIGMENT BLUE 60) | 0.036 |
| polyhalogen compound-1 | 0.14 |
| polyhalogen compound-2 | 0.28 |
| phthalazine compound-1 | 0.18 |
| binder | 9.43 |
| reducing agent-1 | 0.38 |
| reducing agent-2 | 0.39 |
| hydrogen bonding compound-1 | 0.28 |
| development accelerator-1 | 0.019 |
| development accelerator-2 | 0.016 |
| color tone controlling agent-1 | 0.006 |
| mercapto compound-2 | 0.003 |
| silver halide (in terms of silver amount) | 0.13 |

Coating and drying conditions were the same as those in the example 1.

In the following, there are shown chemical structures of the compounds employed in the examples of the invention.

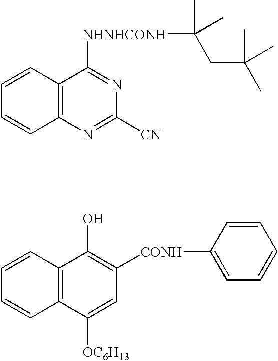

4. Evaluation of Performance

1) Preparation

An obtained sample was cut into a half size (about 30 cm×about 50 cm), then packed in the following packaging material in an environment of 25° C. and 50% RH, and, after a storage for 2 weeks at a normal temperature, subjected to the following evaluations.

2) Packaging Material

A sheet of PET 10 mm/PE 12 μm/aluminum foil 91 μm/nylon 15 μm/polyethylene 50 μm containing 3 mass % of carbon;

oxygen permeation rate: 0.02 ml/atm·m²·25° C.·day, moisture permeation rate: 0.10 g/atm·m²·25° C.·day

3) Exposure and Development of Photosensitive Material

Each sample was exposed by a laser imager described in Japanese Patent Applications Nos. 2002-088832 and 2002-091114 (equipped with a 660 nr semiconductor laser having a maximum output of 50 mW (IIIB) and subjected to a thermal development (for 14 seconds in total with three panels set at 107′-121′-121° C.), and the obtained image was evaluated with a densitometer.

4) Items and Methods of Performance Evaluation

(1) Evaluation of Image Storability

A thermally developed sample was let to stand for 10 days in an environment of 60° C., 40% RH, and the image storability was evaluated by a density change (ΔDmin) in the white background portion between before and after the standing. Results are shown in relative values, taking the sample No. 1 as 100.

(2) Evaluation of Sensitivity

A logarithmic value of a reciprocal of a laser output which provided a density of 1.0 was determined, and is represented by the difference from the sample No. 1.

(3) Evaluation of Coated Surface State

Each sample was exposed and thermally developed so as to obtain a density of 1.5, and a coated surface state was evaluated by the number of coating streaks per unit coating width (coating property being better for a smaller number of coating streaks). Criteria of evaluation are as follows:

++: scarce coating streaks

+: slight coating streaks of low density

±: slight coating streaks of high density

−: coating streaks present on entire surface

(++ and + being permitted practically).

5) Results of Evaluation

The obtained results are shown in Table 6.

As is clear from the Table 6, the samples of the present invention had a higher sensitivity and a significantly improved image storability.

TABLE 6

| | Coated | | | |
|---|---|---|---|---|
| Sample | surface | | Image storability | |
| No. | state | Sensitivity | ΔD min after storage | Remarks |
| 31 | + | 0 | 100 | comp. ex. |
| 32 | − | −0.17 | 75 | comp. ex. |
| 33 | ± | 0.05 | 230 | comp. ex. |
| 34 | ++ | 0.1 | 72 | invention |
| 35 | ++ | 0.11 | 70 | invention |
| 36 | ++ | 0.09 | 71 | invention |

### Example 5

This example is to clarify the influence of halogen ion concentration.

In the sample 34 of the example 4, the polymer latex P-1 solution was replaced by a latex solution obtained by adding sodium hydroxide to the polymer latex P-1 solution to increase the chlorine ion concentration as shown in Table 7, thereby obtaining samples 51 to 55.

TABLE 7

| | | Chlorine ion | | Image storability | |
|---|---|---|---|---|---|
| Sample | Polymer | con-centration | | ΔD min after | |
| No. | type | (ppm) | Sensitivity | storage | Remarks |
| 51 | P-1 | 20 | 0 | 100 | preferable example |
| | | | | | of the invention |
| 52 | P-1 | 50 | 0 | 100 | preferable example |
| | | | | | of the invention |
| 53 | P-1 | 100 | −0.01 | 103 | preferable example |
| | | | | | of the invention |
| 54 | P-1 | 700 | −0.02 | 115 | invention |
| 55 | P-1 | 1500 | −0.04 | 131 | invention |

The sensitivity and the image storability are represented by a difference and a relative value, taking the sample 51 as reference.

Results of performance evaluation conducted in the same manner as in the example 4 are shown in Table 7. A more preferable result was obtained at a lower chlorine ion concentration.

### Example 6

This example shows a more preferable embodiment of the polymer latex of the invention.

(Preparation of Samples)

Samples 61 to 64 were prepared in the same manner as in the preparation of the sample 34 of the example 4, except that the amount of the added organic polyhalogen compound was changed as shown in Table 8.

TABLE 8

| | Addition amount of | | | |
|---|---|---|---|---|
| Sample | polyhalogen compound | | Image storability | |
| No. | (relative value) | Sensi-tivity | ΔD min after storage | Remarks |
| 61 | 1 | 0 | 100 | invention |
| 62 | 0.8 | 0.09 | 102 | invention |
| 63 | 0.6 | 0.14 | 105 | invention |
| 64 | 0.5 | 0.23 | 110 | invention |

In the invention, the sensitivity increases with a decrease in the relative amount of the added polyhalogen compound, and the image storability is satisfactory even when the amount of the added polyhalogen compound is decreased to a value which is no less than 0.5. Therefore, in the system of the invention, it is more preferable to design the system with a smaller amount of the added polyhalogen compound.

The present invention allows to provide a photothermographic material having higher sensitivity and excellent image storability.

1. A photothermographic material comprising, on a same surface of a substrate, a photosensitive silver halide, a non-photosensitive organic silver salt, a reducing agent, a development accelerator, and a binder, wherein said binder is dispersed as a latex and the material comprises, as said binder, a polymer formed by copolymerizing a monomer represented by the following general formula (M) in an amount from 10 to 70 mass %:
CH₂═CR⁰¹—CR⁰²═CH₂ General formula (M)
wherein in general formula (M), R⁰¹ represents a hydrogen atom, an alkyl group having 1 to 6 carbon atoms, or a halogen atom; and R⁰² represents an alkyl group having 1 to 6 carbon atoms, or a halogen atom.

2. A photothermographic material according to claim 1, wherein said development accelerator is a compound selected from compounds represented by the following general formula (A-1):
Q₁-NHNH-Q₂ General formula (A-1):
wherein in general formula (A-1), Q₁ represents an aromatic group or a heterocyclic group bonded by a carbon atom thereof to —NHNH-Q₂; and Q₂ represents a carbamoyl group, an acyl group, an alkoxycarbonyl group, an aryloxycarbonyl group, a sulfonyl group or a sulfamoyl group.

3. A photothermographic material according to claim 1, wherein said development accelerator is a compound selected from compounds represented by the following general formula (A-2): 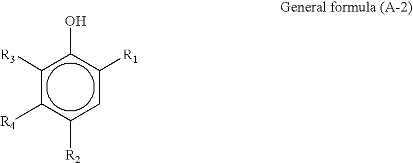
wherein in general formula (A-2), R₁ represents an alkyl group, an acyl group, an acylamino group, a sulfonamide group, an alkoxycarbonyl group, or a carbamoyl group; R₂ represents a hydrogen atom, a halogen atom, an alkyl group, an alkoxy group, an aryloxy group, an alkylthio group, an arylthio group, an acyloxy group or a carbonate ester group; and R₃ and R₄ each independently represent a group that can substitute the benzene ring and may be mutually bonded to form a condensed ring.

4. A photothermographic material according to claim 1, wherein said non-photosensitive organic silver salt is an organic acid silver salt with a content of silver behenate equal to or higher than 90 mol. %.

5. A photothermographic material according to claim 1, wherein said non-photosensitive organic silver salt is an organic acid silver salt with a content of silver behenate equal to or higher than 95 mol. %.

6. A photothermographic material according to claim 1, wherein said polymer has a glass transition temperature within a range from −30° to 70° C.

7. A photothermographic material according to claim 1, wherein said polymer has a glass transition temperature within a range from −10° to 35° C.

8. A photothermographic material according to claim 1, wherein said reducing agent is a compound represented by the following general formula (R): 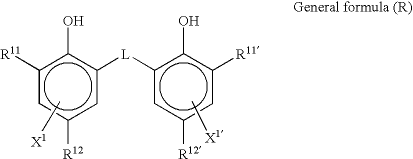
wherein in general formula (R), R¹¹ and R^{11′} each independently represent an alkyl group having 1 to 20 carbon atoms; R¹² and R^{12′} each independently represent a hydrogen atom or a substituent that can substitute the benzene ring; L represents an —S— group or a —CHR¹³— group; R¹³ represents a hydrogen atom or an alkyl group having 1 to 20 carbon atoms; and X¹ and X^{1′} each independently represent a hydrogen atom or a group that can substitute the benzene ring.

9. A photothermographic material according to claim 8, wherein, in the reducing agent represented by general formula (R), R¹¹ and R^{11′} each independently represent a secondary or tertiary alkyl group having 3 to 15 carbon atoms.

10. A photothermographic material according to claim 1, further comprising a phthalocyanine dye.

11. A photothermographic material according to claim 1, wherein in general formula (M), R⁰¹ is a hydrogen atom and R⁰² is a methyl group.

12. A photothermographic material according to claim 1, wherein said polymer is formed by copolymerizing a monomer having an acid group in an amount from 1 to 20 mass %.

13. A photothermographic material comprising, on a same surface of a substrate, a photosensitive silver halide, a non-photosensitive organic silver salt, a reducing agent and a binder, wherein said binder is dispersed as a latex and the material comprises as said binder, a polymer latex formed by copolymerizing a monomer represented by the following general formula (M) in an amount from 10 to 70 mass % and having a number-averaged particle size (dn) from 30 to 500 nm:
CH₂═CR⁰¹—CR⁰²═CH₂ General formula (M)
wherein in general formula (M), R⁰¹ represents a hydrogen atom, an alkyl group having 1 to 6 carbon atoms, or a halogen atom; and R⁰² represents an alkyl group having 1 to 6 carbon atoms, or a halogen atom.

14. A photothermographic material according to claim 13, wherein the polymer latex has a ratio (dv/dn) of a volume-weighted average particle size (dv) to a number-averaged particle size (dn) within a range from 1.00 to 1.10.

15. A photothermographic material according to claim 13, wherein the polymer latex contains halogen ions in an amount of 500 ppm or less with respect to the latex.

16. A photothermographic material comprising, on a same surface of a substrate, a photosensitive silver halide, a non-photosensitive organic silver salt, a reducing agent and a binder, wherein said binder is dispersed as a latex and the material comprises, as said binder, a polymer latex formed by copolymerizing a monomer represented by the following general formula (M) in an amount from 10 to 70 mass %, and emulsion polymerized with a peroxide as a polymerization initiator in an amount of 0.3 to 2 mass % with respect to the monomer:
CH₂═CR⁰¹—CR¹²═CH₂ General formula (M)
wherein in general formula (M), R⁰¹ represents a hydrogen atom, an alkyl group having 1 to 6 carbon atoms, or a halogen atom; and R⁰² represents an alkyl group having 1 to 6 carbon atoms, or a halogen atom.

17. A photothermographic material according to claim 16, wherein said polymer latex includes halogen ions in an amount of 500 ppm or less with respect to the latex.

18. A photothermographic material according to claim 13, wherein said polymer latex has a glass transition temperature within a range from −30° to 70° C.

19. A photothermographic material according to claim 13, wherein, in said general formula (M), R⁰¹ is a hydrogen atom and R⁰² is a methyl group.

20. A photothermographic material according to claim 13, wherein said polymer is formed by copolymerizing a monomer having an acid group in an amount from 1 to 20 mass %.

21. A photothermographic material according to claim 13, comprising halogen ions in an amount of 1000 ppm or less with respect to the organic silver salt.

22. A photothermographic material according to claim 1, wherein R⁰¹ is selected from a hydrogen atom or an alkyl group having 1 to 6 carbon atoms, and R⁰² is an alkyl group having 1 to 6 carbon atoms.

23. A photothermographic material according to claim 1, wherein R⁰¹ is selected from a hydrogen atom or a methyl group, and R⁰² is a methyl group.

24. A photothermographic material according to claim 13, wherein R⁰¹ is selected from a hydrogen atom or an alkyl group having 1 to 6 carbon atoms, and R⁰² is an alkyl group having 1 to 6 carbon atoms.

25. A photothermographic material according to claim 13, wherein R⁰¹ is selected from a hydrogen atom or a methyl group, and R⁰² is a methyl group.

26. A photothermographic material according to claim 16, wherein R⁰¹ is selected from a hydrogen atom or an alkyl group having 1 to 6 carbon atoms, and R⁰² is an alkyl group having 1 to 6 carbon atoms.

27. A photothermographic material according to claim 16, wherein R⁰¹ is selected from a hydrogen atom or a methyl group, and R⁰² is a methyl group.
